(19) United States
(12) Patent Application Publication
(10) Pub. No.: US 2003/0004299 A1
(43) Pub. Date: Jan. 2, 2003

(54) Production of polyhydroxyalkanoates

(75) Inventors: Friedrich Srienc, Lake Elmo, MN (US); Ross P. Carlson, St. Paul, MN (US)

Correspondence Address: MUETING, RAASCH & GEBHARDT, P.A., P.O. BOX 581415, MINNEAPOLIS, MN, 55458, US

(73) Assignee: Regents of the University of Minnesota, Minneapolis, MN (US)

(21) Appl. No.: 10/090,965

(22) Filed: Mar. 4, 2002

Related U.S. Application Data
(60) Provisional application No. 60/294,729, filed on May 31, 2001.
(60) Provisional application No. 60/272,935, filed on Mar. 2, 2001.

(51) Int. Cl. C08G 63/02

(52) U.S. Cl. 528/272

(57) ABSTRACT

Novel transgenic microorganisms capable of biosynthesis of polyhydroxyalkanoate (PHA). Heterologous enzymes involved in PHA biosynthesis, particularly PHA polymerase and acetoacetyl-CoA reductase, are expressed in transgenic prokaryotic and eukaryotic microorganisms. PHA biosynthesis can occur either anaerobically or aerobically.

This application claims the benefit of U.S. Provisional Application Serial No. 60/294,729, filed May 31, 2001, and Ser. No. 60/272,935, filed Mar. 2, 2001, both of which are incorporated herein in their entirety by reference.

This invention was made with government support under a grant from the Consortium for Plant Biotechnology Research #OR22072-77 (DOE Prime #DE-FC05-920R22072). The U.S. Government has certain rights in this invention.

### TECHNICAL FIELD

The invention relates to biological production of polymers and, more particularly, biological production of polyhydroxyalkanoates.

### BACKGROUND

The production of plastics in the United States exceeded 22 billion kilograms in 1986, topped 27 billion kilograms in 1991, and reached 35 billion kilograms in 1997. Nearly one third of these plastics were produced for short-term disposable applications such as packaging. As a result, municipal solid waste may contain 7% plastic by weight or 18% by volume.

Most of these synthetic polymeric materials are not susceptible to biodegradation because microbes generally do not contain the enzymes needed to digest structures not occurring in nature, including most monomers in plastics and chiral monomers with the left-handed or “L” conformation. Indeed, most polymers have traditionally been designed for maximum stability.

Massive environmental and disposal problems are associated with this large scale production of plastic wastes. Landfill space is increasingly scarce, with many cities, particularly in the United States, rapidly exhausting their capacity. Potentially, hundreds of thousands of marine animals are killed annually by the estimated one million tons of plastic debris dumped into the world's oceans each year. In addition, the litter is always an aesthetic, as well as an environmental, problem. Recycling of these plastics is hindered by a limited field of applications for recycled plastics and processing difficulties, including sorting of the various types of plastics.

These problems have spurred the development of short-lived plastics for short-term uses. Biological polymers are, by nature, biodegradable, so a viable approach to degradable plastic technology is to find and develop natural polymers that can be produced and processed in place of synthetic equivalents. The biopolymer poly(3-hydroxybutyrate) (PHB) was discovered in 1925 by Maurice Lemoigne of France. PHB and other members of the larger group of polyhydroxyalkanoates (PHAs) are formed naturally in at least 260 species of bacteria. It is believed that these polymers function as the bacterium's source of energy and carbon during periods of starvation.

PHB is a commercially useful polymer that can be completely biodegraded to carbon dioxide and water. Its properties are similar to those of polypropylene, which represented 11% of US polymer production in 1986. In addition, it is human biocompatible, which makes it a useful material for medical implants.

In the late 1980s, the British company, Imperial Chemical Industries (ICI), began small-scale production of a poly(3-hydroxybutyrate-co-3-hydroxyvalerate) (PHBV) copolymer synthesized in a glucose-utilizing mutant of the bacterium Ralstonia eutropha (until recently, known as Alcaligenes eutrophus). This biopolymer, available under the trade name BIOPOL, was used in shampoo bottles marketed in Germany by the Wella Corporation. However, the expensive feedstocks needed to support bacterial growth, the difficult product extraction, and the limited scale of production limits the commercial production of PHBV.

PHAs are known to accumulate natively in some prokaryotes. Through genetic engineering techniques, PHA biosynthesis pathways have been expressed in foreign hosts. Cloning and expression of one or more R. eutropha-derived genes involved in the biosynthesis of polyhydroxybutyrate (namely, phbA, encoding β-ketothiolase, phbB encoding NADPH-dependent acetoacetyl-CoA reductase, and phbC encoding PHB polymerase) in E. coli have been described in several United States patents, including U.S. Pat. Nos. 5,245,023; 5,250,430; and 5,534,432 (all to Peoples et al.). Production of PHA (both short chain length and medium chain length polymers) has also been demonstrated in transgenic plant cells (U.S. Pat. No. 6,103,956 to Srienc et al). Transgenic expression of a modified PHA is taught in U.S. Pat. No. 6,143,952 to Jackson et al.

Production of PHAs in microbial hosts avoids the problems associated with chemical synthesis, permits the use of inexpensive substrates and has the potential for producing novel PHAs from defined or unique metabolic intermediates. Methods for enhanced production of PHAs in microbial hosts are therefore highly desirable.

### SUMMARY

The present invention provides a system for producing polyhydroxyalkanoate (PHA) in transgenic microorganisms. Formation of PHA in the microorganism occurs by way of polymerization of one or more hydroxyalkanoates and is catalyzed by a heterologous polyhydroxyalkanoate (PHA) polymerase. Preferably, the microorganism in which the PHA is synthesized is a yeast cell or a bacterial cell. Preferred yeast cells include cells of the genera Saccharomyces and Kluyveromyces, more preferably from S. cerevisiae. Preferred bacterial cells include cells from the genera Escherichia, Zooglea and Lactobacillus, more preferably from E. coli. The microorganism can be cultured under aerobic or anaerobic conditions. Biologically synthesized PHA typically accumulates in the microorganism and can be isolated using any convenient method.

Optionally, a commercially useful co-product is also produced by the microorganism. The co-product is preferably a compound that acts as an electron acceptor (an electron “sink”) during anaerobic fermentation, and is typically secreted into the culture medium. Particular preferred co-products are ethanol and lactic acid. PHA can be isolated from the microorganisms before, during, or after isolation of the co-product. Preferably, culture conditions are first selected for the production and isolation of the co-product. After isolation of the co-product, the culture conditions are optionally shifted, for example by providing an additional substrate, to allow increased production of PHA.

Production of PHA in yeast according to the invention is preferably anaerobic and utilizes a transgenic yeast cell that contains a first nucleic acid fragment comprising a heterologous nucleotide sequence encoding a PHA polymerase and at least one second nucleic acid fragment comprising a heterologous nucleotide sequence selected from the group consisting of a heterologous nucleotide sequence encoding an acetoacetyl-CoA reductase and a heterologous nucleotide sequence encoding a β-ketothiolase. The PHA polymerase can be a short chain length PHA (PHA_{SCL}) polymerase or a medium length chain PHA (PHA_{MCL}) polymerase; preferably, it is a PHA_{SCL} polymerase. Where the PHA polymerase is a PHA_{MCL} polymerase, the method of the invention includes aerobically culturing the yeast cell as well as anaerobically culturing the yeast cell.

Optionally, the method further includes making the transgenic yeast cell by introducing at least one nucleic acid fragment into the yeast cell to yield the yeast cell.

Optionally the transgenic yeast cell used in the method of the invention overexpresses citrate lyase. To that end, the yeast cells can contain a nucleic acid fragment containing a heterologous nucleotide sequence encoding a citrate lyase. Optionally, the yeast cell possesses transhydrogenase activity, which is preferably attributable to the overexpression of malic enzyme or glutamate dehydrogenase.

Production of PHA in bacteria according to the invention is preferably anaerobic and utilizes a transgenic bacterial cell that contains a first nucleic acid fragment comprising a heterologous nucleotide sequence encoding a PHA polymerase and at least one second nucleic acid fragment comprising a heterologous nucleotide sequence selected from the group consisting of a heterologous nucleotide sequence encoding an acetoacetyl-CoA reductase and a heterologous nucleotide sequence encoding a β-ketothiolase, as described above for yeast cells.

It should be understood that the microorganism can contain multiple first and/or second nucleic acid fragments. For example, the microorganism optionally contains a nucleic acid fragment comprising a heterologous nucleotide sequence encoding an acetoacetyl-CoA reductase as well as a nucleic acid fragment comprising a heterologous nucleotide sequence encoding a β-ketothiolase (i.e., two “second” nucleic acid fragments).

Furthermore, two or more nucleic acid fragments can, optionally, constitute the same, i.e., a single, nucleic acid fragment. For example, a “first” nucleic acid fragment containing a coding sequence for a PHA polymerase and a “second” nucleic acid fragment containing a coding sequence for an acetoacetyl-CoA reductase can be present on the same nucleic acid vector. That is, they constitute the same nucleic acid fragment. They may, for example, be under the control of (i.e., operably linked to) a single divergent promoter; alternatively they may be under the control of different promoters but still present on the same vector.

When ethanol or lactic acid are co-produced with PHA, the cells are first cultured under conditions to cause the production of ethanol or lactic acid (preferably anaerobic conditions); ethanol or lactic acid is isolated from the cell culture; the cells are then cultured under conditions to cause the production of PHA; and PHA is isolated from the cells. During the ethanol or lactic acid production phase, the cells are preferably supplied with a feed containing acetate, propionate and/or valerate (for the production of short chain length PHAs) or with longer chain, e.g., C6-C12, fatty acids such as oleic acid (for the production of medium chain length PHAs). Optionally, the cells are first cultured in a first fermentation chamber under conditions to cause the production of ethanol or lactic acid, then cultured in a second fermentation chamber under conditions to cause the production of PHA.

The invention further provides a transgenic yeast cell, preferably a S. cerevisiae cell, that includes a heterologous PHA_{MCL} polymerase as well as a heterologous acetoacetyl-CoA reductase and/or a heterologous β-ketothiolase. The invention also provides a transgenic yeast cell containing a heterologous PHA polymerase, and a heterologous citrate lyase. Optionally the transgenic yeast cell of the invention exhibits transhydrogenase activity.

### BRIEF DESCRIPTION OF THE DRAWINGS

FIG. 1 shows the general structure of polyhydroxyalkanoate, and representatives of the two distinct classes, PHA_{SCL} and PHA_{MCL}.

FIG. 2 shows the R. eutropha polyhydroxybutyric acid (PHB) biosynthetic pathway.

FIG. 3 shows representative pathways for production of PHA, PHV and P(HB-co-HV) from acetyl-CoA and/or propionyl-CoA in R. eutropha. The upper pathway shows production of PHB (R═CH₃) from acetyl-CoA, and the lower pathway shows production of PHV (R═CH₂CH₃) from propionyl-CoA. When acetyl-CoA and propionyl-CoA are both provided as substrates, co-polymer P(HB-co-HV) (R═CH₃, R═CH₂CH₃) is expected to be produced.

FIG. 4 is a schematic representation of coupled PHB and fuel ethanol production.

FIG. 5 is a schematic representation of plasmid p2DPT RS.

FIG. 6 is a schematic representation of plasmid p2DPT S.

FIG. 7 is a schematic representation of plasmid p2DPT RK.

FIG. 8 is a schematic representation of plasmid p2DP S(H).

FIG. 9 is a bar graph showing the effect of gene dosage on the production of PHB in transgenic yeast.

FIG. 10 is a schematic representation of plasmid pIDP GS.

FIG. 11 is a schematic representation of plasmid pIDP RG.

FIG. 12 is a schematic representation of plasmid p2-GDH2.

FIG. 13 is a graph of bioreactor time profiles for anaerobic production of PHB in transgenic S. cerevisiae as a function of culture time.

FIG. 14 show yeast cells stained with nile red to visualize accumulated PHB. Label “A” indicates cells with greater than or equal to 50% volume of PHB. Label “B” indicates cells with less than 50% volume of PHB.

FIG. 15 is a graph of production of PHB and biomass in transgenic E. coli as a function of culture time.

FIG. 16 is a schematic representation of a constitutive promoter based on S. cerevisiae PHB plasmids. The various construct features listed in the diagram correspond to the lettered table headings.

FIG. 17 is a schematic representation of plasmid p2-TG1 SK(H). Bar diagram illustrates Tef/Gal 1 promoter gene configuration.

### DETAILED DESCRIPTION OF THE INVENTION

The present invention includes microorganisms, a method for using microorganisms for the production of PHA and the production of PHA along with co-produced products, and methods for constructing microorganisms capable of performing the method of the present invention.

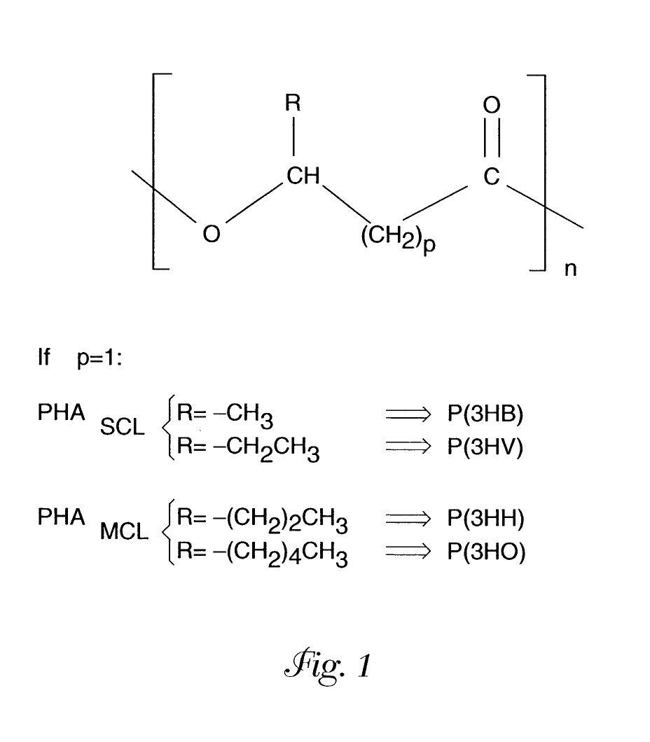

Polyhydroxyalkanoates (PHAs) are polyesters of hydroxyalkanoates conforming to the general structure illustrated in FIG. 1. Each monomer contains a carboxyl and a hydroxyl functional group. Unless the R group is hydrogen, the adjacent carbon is a chiral center. The R groups and p values for several PHAs are listed in Table I (adapted from adapted Brandl et al., Adv. Biochem. Eng. Biotechnol., 41, 77-93 (1990); Steinbuchel, Biomaterials: Novel Materials from Biological Sources, pp. 123-213, Stockton Press: New York (1991)). The value of n is typically 100 to 30,000. More complex PHAs can contain olefin, branched, halogenated, phenyl, hydroxyl, cyclohexyl, ester, or nitrile R groups (R. Lenz et al., Polymer Preprints, 31, 408-409 (1990); Y. B. Kim, “Preparation, Characterization, and Modification of Poly-beta-hydroxyalkanoates from Pseudomonas Oleovorans,” Ph.D. Thesis, University of Massachusetts, Amherst (1991); Y. B. Kim et al., Macromolecules, 25, 1852-1857 (1992)).

TABLE 1
Selected Bacterial Polyhydroxyalkanoates

| | R | p |
|---|---|---|
| Poly-3-hydroxypropionate* | —H | 1 |
| Poly-3-hydroxybutyrate* | —CH₃ | 1 |
| Poly-3-hydroxyvalerate* | —CH₂CH₃ | 1 |
| Poly-3-hydroxyhexanoate | —CH₂CH₂CH₃ | 1 |
| (or hydroxycaproate) | | |
| Poly-3-hydroxyheptanoate | —CH₂CH₂CH₂CH₃ | 1 |
| Poly-3-hydroxyoctanoate | —(CH₂)₄CH₃ | 1 |
| Poly-3-hydroxynonanoate | —(CH₂)₅CH₃ | 1 |
| Poly-3-hydroxydecanoate | —(CH₂)₆CH₃ | 1 |
| Poly-3-hydroxyundecanoate | —(CH₂)₇CH₃ | 1 |
| Poly-3-hydroxydodecanoate | —(CH₂)₈CH₃ | 1 |
| Poly-4-hydroxybutyrate* | —H | 2 |
| Poly-4-hydroxyvalerate* | —CH₃ | 2 |
| Poly-5-hydroxybutyrate* | —H | 3 |
| Poly-3-hydroxy-4-pentenoate* | —CH═CH₂ | 1 |
| Poly-3-hydroxy-2-butenoate | —CH₃ | 1 |
| (unsaturated chain)* | | |

*These polymers are short chain length monomer polyhydroxyalkanoates, PHA_{SCL}.

PHAs can be in the form of homopolymers, random copolymers, block copolymers, or blends of any of these forms. Examples of PHAs include, but are not limited to, poly-3-hydroxypropionate, poly-3-hydroxybutyrate (PHB), poly-3-hydroxyvalerate, poly-3-hydroxyhexanoate (or hydroxycaproate), poly-3-hydroxyheptanoate, poly-3-hydroxyoctanoate, poly-3-hydroxynonanoate, poly-3-hydroxydecanoate, poly-3-hydroxyundecanoate, poly-3-hydroxydodecanoate, poly-4-hydroxybutyrate, poly-4-hydroxyvalerate, poly-5-hydroxybutyrate, poly-3-hydroxy-4-pentenoate, and poly-3-hydroxy-2-butenoate (unsaturated chain).

Polyhydroxyalkanoates can be divided into two classes: polymers formed from short chain length carbon monomers (referred to herein as PHA_{SCL}) and polymers formed from medium chain length carbon monomers (referred to herein as PHA_{MCL} ) (S. Y. Lee, Biotechnol. Bioeng., 49, 1-14 (1996); see FIG. 1). A “short chain length carbon monomer” is a carbon monomer having 3 carbon atoms (a C3 monomer) to about 5 carbon atoms (a C5 monomer). Examples of short chain length carbon monomers include 3-hydroxybutyrate and 3-hydroxyvalerate, which are formed from glucose and glucose as substrates, respectively, for the polymerase. A “medium chain length carbon monomer” is a carbon monomer having about 6 carbon atoms (a C6 monomer) to about 14 carbon atoms (a C14 monomer). Examples of medium chain length carbon monomers include straight-chain 3-hydroxyalkanoic acids with about 6 to about 12 carbon atoms, which are formed from the respective alkanoic monomer as substrate for the polymerase. At least ninety-one PHA monomer units have been discovered to date (R. H. Marchessault, TRIP, 4, 163-168 (1996)).

A PHA polymerase is an enzyme that is capable of catalyzing the polymerization of constituent monomers to yield PHA, and is also referred to in scientific literature as a PHA synthase or a PHA synthetase. The term “PHA_{SCL} polymerase,” as used herein, refers to a PHA polymerase that is capable of catalyzing the polymerization of monomers or precursors that include 3 to about 5 carbon atoms, to yield PHA_{SCL} homopolymers or copolymers. PHB polymerase is a PHA_{SCL} polymerase. Biopolymers that can be synthesized with PHA_{SCL} polymerases include PHAs such as poly(3-hydroxybutyrate) and poly(3-hydroxybutyrate-co-3-hydroxyvalerate), for example.

As used herein, “PHA_{MCL} polymerase” refers to a PHA polymerase that is capable of catalyzing the polymerization of monomers or precursors that include about 6 to about 14 carbon atoms, to yield PHA_{MCL} homopolymers or copolymers. Biopolymers synthesized with PHA_{MCL} polymerases include poly(3-hydroxyoctanoate) (PHO), poly(3-hydroxyhexanoate) (PHH), and poly(3-hydroxydecaonoate), for example.

PHA polymerases may be naturally occurring or non-naturally occurring. A non-naturally occurring PHA polymerase includes a naturally occurring polymerase that has been modified using any technique that results in addition, deletion, modification, or mutation of one or more amino acids in the enzyme polypeptide sequence, such as by way of genetic engineering, as long the catalytic activity of the enzyme is not eliminated. For example, a polymerase according to the present invention can include an N-terminal or C-terminal amino acid sequence that directs or targets the enzyme. The PHA polymerase activity can be part of a bifunctional or multifunctional enzyme or enzyme complex; thus the term PHA polymerase is intended to include such bifunctional or multifunctional enzymes that possess PHA polymerase activity. Examples of modified polymerases and methods for making them are found in U.S. Pat. No. 6,143,952 (Nov. 7, 2000).

The present invention relates to the expression of heterologous genes involved in the synthesis pathway of polyhydroxyalkanoate biopolymers in microorganisms. A “heterologous” nucleic acid fragment, or gene, is one containing a nucleotide sequence that is not normally present in the cell, for example a prokaryotic nucleotide sequence that is present in a eukaryotic cell. A heterologous gene is also referred to herein as a transgene. As used herein, “transgenic” refers to an organism in which a nucleic acid fragment containing a heterologous nucleotide sequence has been introduced. The transgenes in the transgenic organism are preferably stable and inheritable. The heterologous nucleic acid fragment may or may not be integrated into the host genome.

The transgenic microorganism of the invention is preferably a facultative microbe such as yeast or E. coli, however anaerobic microbes are also included. The term “microorganism” is used herein to refer to any one-celled organism such as a bacterium, an archaebacterium, a fungus or a protozoan; a microorganism can thus be prokaryotic or eukaryotic. The term “microbe” is used herein interchangeably with the term “microorganism.” “Microbial production of PHA” and “biological production of PHA” as those terms are used herein mean production of PHA by a microorganism of the invention. Yeast and bacteria are preferred examples of microorganisms that can genetically transformed according to the present invention. Preferred yeast cells include cells of the genera Saccharomyces and Kluyveromyces, more preferably cells from S. cerevisiae. Preferred bacterial cells include cells from the genera Escherichia, Zooglea and Lactobacillus, more preferably from E. coli.

The transgenic microorganism can be cultured in any convenient matter, for example in a suspension or on a solid matrix. Microbial cultures are typically grown in a nutrient-rich culture medium. The transgenic cells of the invention can be grown under either aerobic or anaerobic conditions, or in cultures with one or more aerobic or anaerobic phases. Cells are cultured under anaerobic conditions when they are cultured in an environment where there is no detectable oxygen, or where the dissolved oxygen levels are so low that they fail to induce an aerobic cellular metabolism (i.e., to induce oxidative phosphorylation). What constitutes “anaerobic conditions” (i.e., conditions with oxygen levels so low that they fail to induce oxidative phosphorylation) can vary from organism to organism and also can depend on parameters like growth rate, media composition, and other culturing conditions. Anaerobic conditions are typically present when, for example, the dissolved oxygen level in the culture medium is at most about ten percent of air saturation. Preferably, the dissolved oxygen level in the culture medium is at most about five percent of air saturation, more preferably it is at most about one percent of air saturation.

During anaerobic growth, PHA can act as an electron sink or fermentation product, and it is possible to couple PHA production with the production of one or more additional electron acceptor compounds (“electron sinks” or “redox sinks”) such as ethanol or lactic acid, as described in more detail below.

Microorganisms of the invention are transformed with a nucleic acid fragment comprising a heterologous nucleotide sequence and, preferably, but not necessarily, regulatory sequences operably linked thereto. The nucleic acid fragment can be circular or linear, single-stranded or double stranded, and can be DNA, RNA, or any modification or combination thereof. Typically a vector comprising the heterologous nucleotide sequence is used for transformation. The vector can be a plasmid (integrative or autonomous), a viral vector or a cosmid. Selection of a vector backbone depends upon a variety of desired characteristics in the resulting construct, such as a selection marker, plasmid reproduction rate, and the like.

Microorganisms of the invention are transformed with a heterologous nucleotide sequence that encodes a functional PHA polymerase and may, in some embodiments of the invention, optionally be transformed with one or more additional heterologous nucleotide sequences that encode at least one other functional enzyme utilized in the biosynthesis of PHA such as β-ketothiolase and/or acetoacetyl-CoA reductase. Yeast that are transformed to produce PHA can be further transformed to express or overexpress citrate lyase or a transhydrogenase enzyme such as glutamate dehydrogenase or malic enzyme. Different combinations of genes can be expressed.

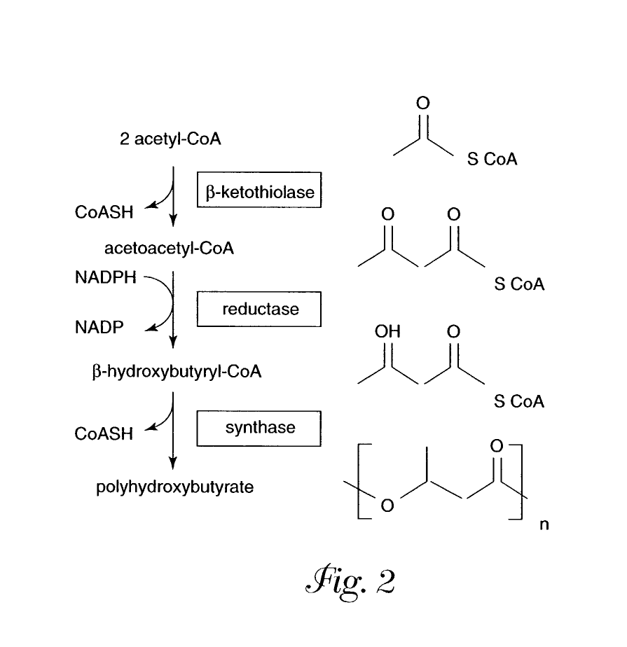

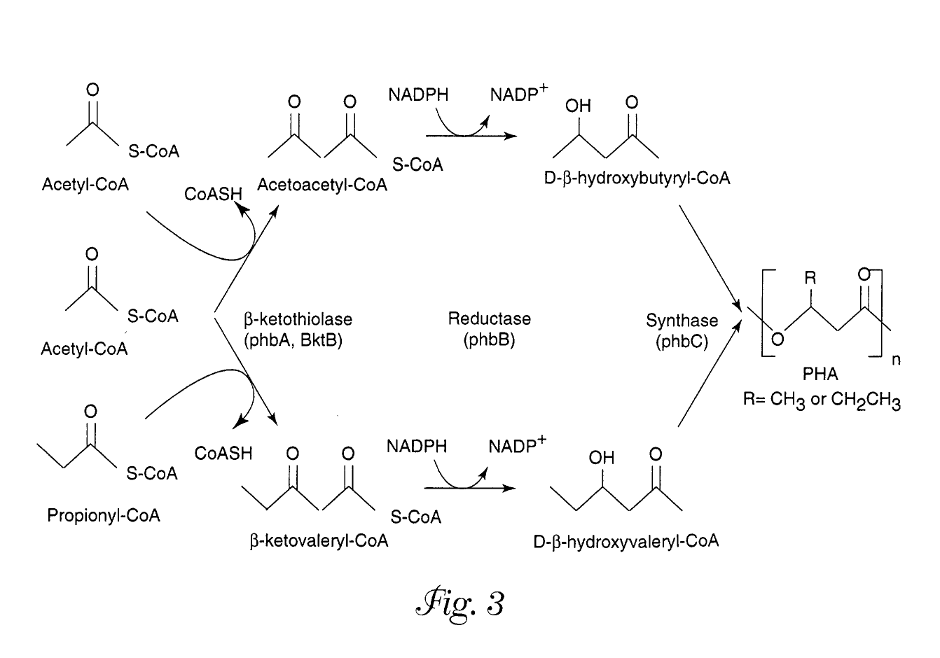

One or more nucleic acid fragments can be used to transform a host cell; for example, the microorganism can be transformed with one vector comprising a heterologous nucleic acid that encodes a PHA polymerase, and a second vector comprising a heterologous nucleic acid that encodes a acetoacetyl-CoA reductase. Alternatively, two or more heterologous nucleic acids can be present on the same nucleic acid fragment used to transform the host cell, as is the case, for example, when a divergent promoter is used. The PHA polymerase can be a PHA_{SCL} polymerase or a PHA_{MCL} polymerase. Preferably, nucleic acid sequences encoding β-ketothiolase, acetoacetyl-CoA reductase, and PHA_{SCL} polymerase are derived from R. eutropha. (0. Peoples et al., J. Biol. Chem., 264,15298-15303 (1989)). A schematic representation of the R. eutropha polyhydroxybutyric acid biosynthetic pathway is shown in FIG. 2. FIG. 3 shows a pathway for production of P(HB-co-HV) from acetyl-CoA and propionyl-CoA in R. eutropha, where β-ketothiolase catalyzes the condensation reaction to generate either acetoacetyl-CoA or β-ketovaleryl-CoA. These metabolites are reduced by reductase (phbB) and polymerized by synthase (phbC). Nucleic acid sequences encoding PHA_{MCL} polymerase are preferably derived from Pseudomonas oleovorans. Nucleotide sequences for these and other suitable genes are readily available to one of skill in the art from protein and nucleic acid databases such as GENBANK.

The nucleic acid fragment used to transform the microorganism according to the invention can optionally include a promoter sequence operably linked to the nucleotide sequence encoding the enzyme to be expressed in the host. A promoter is a DNA fragment that can cause transcription of genetic material. Transcription is the formation of an RNA chain in accordance with the genetic information contained in the DNA. The invention is not limited by the use of any particular promoter, and a wide variety are known. Promoters act as regulatory signals that bind RNA polymerase in a cell to initiate transcription of a downstream (3′ direction) coding sequence. A promoter is “operably linked” to a nucleotide sequence if it is does, or can be used to, control or regulate transcription of that nucleotide sequence. The promoter used in the invention can be a constitutive or an inducible promoter. It can be, but need not be, heterologous with respect to the host.

A divergent promoter can also be used to introduce and regulate multiple genes. These promoters permit the co-regulation of two separate genes from a single, centrally located sequence. Examples of divergent promoters include the GAL1-10 promoter. Galactose inducible promoters GAL1, GAL7, and GAL10 are useful for high-level expression of both homologous and heterologous genes. The galactose metabolic pathway, from which the GAL1, GAL7, and GAL10 promoters originate, can be regulated at the gene expression level by the regulatory proteins GAL4 and GAL80.

The heterologous nucleotide sequence can, optionally, include a start site (e.g., the codon ATG) to initiate translation of nucleic acid to produce the enzyme. It can, also optionally, include a termination sequence to end translation. A termination sequence is typically a codon for which there exists no corresponding aminoacetyl-tRNA, thus ending polypeptide synthesis. The heterologous nucleotide sequence can optionally further include a transcription termination sequence.

The nucleic acid fragment used to transform a microorganism of the invention may optionally include one or more marker sequences, which typically encode a gene product, usually an enzyme, which inactivates or otherwise detects or is detected by a compound in the growth medium. For example, the inclusion of a marker sequence can render the transgenic cell resistant to an antibiotic, or it can confer compound-specific metabolism on the transgenic cell. Examples are marker sequences that confer kanamycin, ampicillin or paromomycin sulfate resistance; the URA3 selection marker and HIS3 selection markers described in the following examples, or, for yeast, various other genes that complement auxotrophic mutations such as G418.

A transgenic microorganism of the invention can include a first heterologous nucleotide sequence encoding a PHA polymerase, and, optionally, either or both of a second heterologous nucleotide sequence encoding a β-ketothiolase and a third heterologous nucleotide sequence encoding an acetoacetyl-CoA reductase. One strategy for introducing multiple genes is to clone multiple promoters and genes on a single plasmid. Multiple genes can also be introduced using multiple distinct plasmids. In order to maintain the recombinant DNA, a different selection marker would be required for each plasmid. Integration or autonomous vectors can be used in introducing multiple genes into a host. Another system for expressing multiple genes in cells uses viral internal ribosomal entry sites (IRES) and cap-independent translation enhancers (CITE).

In yeast, the heterologous nucleotide sequence can be targeted to a peroxisome, the site of PHA precursors. Peroxisomal targeting sequences have been found on the C-terminal of several peroxisomal proteins, and examples can be round in T. B. Wallace et al., “Plant Organellular Targeting Sequences,” in Plant Molecular Biology, Ed. R. Croy, BIOS Scientific Publishers Limited (1993), pp. 287-288. Peroxisomal targeting sequences having the so-called “SKL motif” have been found to be an evolutionarily-conserved transit peptide targeting expression to the peroxisomes of mammals, insects, plants and yeast. The SKL motif comprises serine, alanine or cysteine at the first position; lysine, histidine or arginine at the second position; and leucine at the third position. This sequence has been found to be effective even with folded or multiunit proteins. A detailed review of peroxisomal targeting sequences can be found in U.S. Pat. No. 6,103,956 (Srienc et al.).

The heterologous nucleotide sequence described above can be introduced into the microorganism using a variety of techniques. Transformation is preferably accomplished using electroporation or chemical methods such as those that utilize a surfactant and/or a divalent cationic salt such as CaCl₂ or LiCl₂.

PHA is produced according the method of the invention in an amount of preferably at least about 2.5% of cell dry weight (CDW); more preferably at least about 5% of cell dry weight; and most preferably at least about 10% of cell dry weight.

Anaerobic production of PHA in microorganisms is surprising because PHA is typically considered an aerobic storage material in microorganism cells. Moreover, β-oxidation of fatty acids is an aerobic process, and removing oxygen from the system might have been expected to reduce the precursor pool and thereby inhibit PHA production. Anaerobic production is advantageous because, among other things, the use of glucose can be decoupled from the generation of PHA. That is, while glucose is still utilized to provide reducing equivalents, the carbon source for PHA production can come from other defined carbon sources in the feed, such as acetate, propionate, and/or valerate (for the production of short chain length PHAs) or longer chain, e.g., C6-C12, fatty acids such as oleic acid (for the production of medium chain length PHAs). This allows more control over the nature of PHAs produced and can also result in a less expensive and more efficient production process. It should nonetheless be understood, however, that PHA production is possible even if only glucose is the feed, as the endogenous acetate produced by the microorganism cell can be utilized as the carbon source for PHA synthesis.

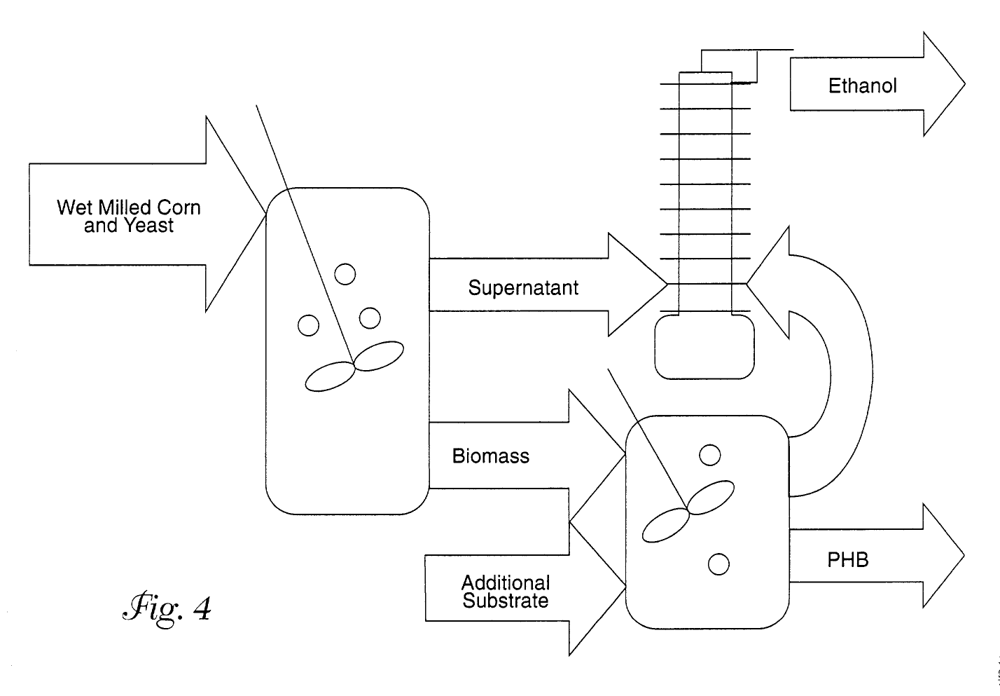

Biological co-production of products in addition to PHA is also encompassed by the invention. Preferably, these co-products are produced during anaerobic fermentation and serve as electron receptors or “electron sinks”. For example, microorganisms can co-produce ethanol or lactic acid along with PHA (FIG. 4). Under aerobic conditions, the accumulation of PHB typically correlates with a reduction in ethanol concentration. However, we discovered that under anaerobic conditions, ethanol production is linked to PHA accumulation.

Optionally, bacterial cells, particularly E. coli cells, are engineered to inactivate, or knock-out, the acetate pathway. This may allow for the increased co-production of ethanol, particularly when medium chain length PHAs are produced as acetate is not a precursor for the MCL pathway. Bacterial cells can also be used to produce lactic acid through a mixed acid fermentation pathway. Lactobacillus cells, especially L. delbrueckii, are useful in the co-production of lactic acid along with PHA. Yeast cells can also co-produce lactic acid.

Co-production of ethanol or lactic acid can take place in either a batch or continuous process that utilize either a free or immobilized microorganism system. Batch cultures can include fed-batch cultures and perfusion cultures. Free cell systems can utilize one or more continuously stirred-tank bioreactors. Cell immobilization techniques include the use of dialysis membranes, cells covalently bonded to a solid support, and entrapment of cells within natural or synthetic polymers.

Separation of the co-products can be accomplished through any number of known separation techniques. Examples include, but are not limited to, distillation, including flash distillation, filtration (including membrane filtration) and electrodialysis using bipolar membranes.

It should be understood that, notwithstanding any of the foregoing, the invention is not intended to be limited by any particular scientific theory or hypothesis.

The present invention is illustrated by the following examples. It is to be understood that the particular examples, materials, amounts, and procedures are to be interpreted broadly in accordance with the scope and spirit of the invention as set forth herein.

### EXAMPLES

### Example 1

### General Methodologies Relating to Expression of PHAs in Yeast

S. cerevisiae Expression Systems

Recombinant DNA is typically introduced into a host using either an integrative or an autonomous plasmid. Integrative plasmids are DNA sequences that incorporate into a host's chromosome, typically through a homologous recombination event. This event occurs between a targeting sequence on the plasmid and a homologous, host chromosomal sequence. The homologous sequence used to target the integration can be a unique or a nonunique sequence. A unique targeting sequence permits only a single copy of the transforming DNA to be integrated. This approach has been used to introduce recombinant genes as well as create mutants by interrupting certain genes. Integrative plasmids can also be targeted for non-unique sequences. Such plasmids have multiple potential integration sites and a single transformation can result in numerous copies being incorporated into the chromosome.

Examples of repeated S. cerevisiae sequences used to target multiple integrations include the Ty1 element, the ribosomal DNA cluster, and the δ sequence. These sequences can be found in hundreds of locations through out the host genome. Integrated plasmid DNA replicates and segregates with the host chromosome.

In addition to integrative plasmids, autonomously replicating plasmids are routinely used to deliver recombinant DNA. These sequences that replicate independently of the chromosome are normally relatively small, circular pieces of DNA, however linear plasmids have also been developed. Unlike integrated plasmids, autonomous plasmids must direct their own replication and their own segregation. These functions are necessary to ensure that the mother and daughter cell both retain the plasmid after cell division. In addition to using autonomous plasmids and integrated genes separately, the two systems can be combined.

DNA replication sequences used in plasmid expression systems in yeast can be divided into two categories: those that are based on yeast chromosomal DNA sequences and those that are based on the endogenous 2-micron circle.

Autonomously replicating sequences (ARS) are based on chromosomal DNA fragments. These sequences through a complex process initiate plasmid DNA replication and have been used to achieve high frequencies of transformation in yeast. Plasmids have been constructed which combine the ARS sequence with a centromeric DNA sequence (CEN). The CEN sequence is believed to serve as an attachment point for spindle fibers during cell division.

The 2 μm origin of replication is the most popular means of maintaining a fairly stable, high copy number plasmid. This origin of replication is derived from the endogenous S. cerevisiae 2 μm circle (Sutton et al., Molec. Cell. Biol. 5(10): 2770-2780, 1985). This native yeast plasmid is found in numerous laboratory yeast strains. The 6.3 kb plasmid, which confers no selective advantage to its host, seems to serve no purpose other than self propagation. Different pieces of the 2 μm circle have been used to regulate the replication and segregation of expression vectors. A common piece is the 2.2 kb EcoRi fragment that in [cir+] strains of S. cerevisiae maintains between 10 and 40 plasmid copies per cell (Rose et al., Meth. Enzymol. 185: 234-279, 1990). Although 2 μm based plasmids are not as stable as CEN based plasmids, the high copy number makes these plasmids useful when high expression levels are desired.

DNA transformation systems usually employ selection markers for two purposes. First, selection markers permit the isolation of recombinant organisms after a transformation and secondly selection markers help ensure the recombinant population maintains the transforming DNA during culturing. Typical yeast selection markers are designed to complement auxotrophic host mutations. Common selection markers include genes that complement mutations involved in the synthesis of metabolites like adenine, histidine, leucine, lysine, tryptophan, or uracil. Although not as common, some yeast selection markers impart resistance to broad spectrum antibiotics such as G418.

S. cerevisiae promoters can be placed under one of two broad classifications, either constitutive or inducible. Constitutive promoters continuously direct gene expression and are typically found regulating widely utilized genes like those from glycolysis. When a gene is only required under certain environmental conditions, its expression is usually regulated by an inducible promoter. For example, the S. cerevisiae genes involved in the metabolism of galactose are regulated by a well-studied inducible promoter system.

For effective high-level expression in S. cerevisiae, mRNA termination sequences are often required. mRNA stability is thought to be a function of its nucleotide sequence, so it is advantageous to keep the mRNA molecule as small as possible to avoid any unnecessary destabilizing sequences.

Strategies for Introducing Multiple Genes into Yeast

Metabolic pathway engineering often requires the introduction of multiple recombinant genes. Unlike prokaryotes, most eukaryotes do not typically express polycistronic messages. Each gene usually requires its own promoter and its own termination sequence. This makes the introduction of multiple genes more difficult.

Multiple promoters and multiple genes per plasmid; multiple distinct plasmids. One strategy for introducing multiple genes is to clone multiple promoters and genes on a single plasmid. Multiple genes can also be introduced using multiple distinct plasmids. In order to maintain the recombinant DNA, a different selection marker would be required for each plasmid.

Divergent promoters. A divergent promoter can also be used to introduce and regulate multiple genes. These promoters permit the co-regulation of two separate genes from a single, centrally located sequence. The single sequence helps reduce plasmid size and does not introduce the possibility of recombination between identical promoters. The divergent GAL1-10 promoter has been used to enhance β-galactosidase expression in the organism Candida maltosa (Park et al., Yeast 13: 21-29,1996). This was accomplished by regulating two copies of β-galactosidase from a single bi-directional promoter.

Over 60 different divergent promoters have been described in organisms ranging from bacteriophage to humans (Beck et al., Microbiol. Rev. 52: 318-326, 1988). A number of divergent promoters have been identified in S. cerevisiae, including GAL1-10, MAL6T-MAL6S, SPS18-19, SPO12, SPO16, SPO13, ARD1, DID1, DIT2, MATα1-MATα2, MATa1-MATa2, H2A-H2B, ALD2-SIP18, and DDR48-PAI3.

Fusion proteins. It is possible to introduce multiple enzyme activities from a single fusion protein. Fusion proteins are in-frame fusions of two or more genes that produce a multifunctional product. Cases have been reported where two and even three multimeric enzymes have been fused without any one enzyme losing its catalytic activity (Ljungcrantz et al., FEBS Letters. 275(1-2): 91-4, 1990). A possible fusion protein could combine acetyl-CoA synthetase and PHB β-ketothiolase. This arrangement would localize the formation of acetyl-CoA with the production of PHB precursors.

Other approaches. Other systems for expressing multiple genes in eukaryotes are possible. A system developed in tobacco plants allows the expression three genes from a single promoter. The system was created from an in-frame fusion of cDNA from three genes. During the fusion, a short DNA sequence encoding a specific peptide sequence was ligated between each gene. After the fusion sequence was transcribed and translated as a single message/protein, a protease was introduced which recognized and cleaved the short linker peptide sequence freeing the three separate proteins (von Bodman et al., Bio/Tech. 13(6):587-591, 1995).

Galactose Inducible Promoters

The S. cerevisiae galactose inducible promoters GAL1, GAL7, and GAL10 have been used extensively for high-level expression of both homologous and heterologous genes. The tightly regulated sequence allows only minimal expression under non-inducing conditions, however when galactose is present and glucose is absent, gene expression is increased approximately 1000 fold.

Redox Balance in Yeast

Maintaining a favorable redox balance plays a critical role in an organism's metabolism. The over expression of a metabolite or the expression of a heterologous protein can have a significant effect on a host's redox balance.

NADH and NADPH are the two major nicotinic cofactors used to shuttle reducing equivalents between enzymes. NADH is produced primarily from the catabolism of energy sources and from the biosynthesis of some amino acids. During oxidative growth, the reducing equivalents carried by NADH can be transferred to the electron transport chain where O₂ is reduced to H₂O in a process that generates ATP. Anaerobic conditions pose a redox challenge because the electron transport system is not available to accept electrons. Instead, the reducing equivalents are transferred to a metabolite that acts as an electron acceptor (i.e., an “electron sink”). The reduced metabolites are then typically exported from the cell. The reduction of acetaldehyde to ethanol is a common example.

NADPH is the second major nicotinic coenzyme involved in redox balances. This coenzyme is used in anabolic reactions and in S. cerevisiae, is produced primarily by the hexose monophosphate pathway. Other enzymes like cytosolic isocitrate dehydrogenase and cytosolic acetaldehyde dehydrogenase also produce NADPH.

Due to the absence of a transhydrogenase system (NADH+NADP⁺⇄NAD⁺+NADPH), NADPH and NADH are not equivalent in S. cerevisiae. The two cofactors must be synthesized and consumed in separate reactions.

Transhydrogenase Systems

Perturbations in the concentrations of the NAD(P)H/NAD(P)+, such as those caused by the introduction of a catabolic or anabolic pathway can often lead to an unfavorable redox balance. In S. cerevisiae, the cell must regulate a delicate balance between the production and consumption of NADPH and NADH in order to maintain a favorable redox balance. Many bacterial and animal cells possess a transhydrogenase activity that permits the conversion of NADH to NADPH or vice versa, however S. cerevisiae does not possess this activity. The lack of a transhydrogenase system has implications on the expression of foreign proteins and on the yields of such products as ethanol. For instance, glycerol is produced during anaerobic growth in order to reoxidize the NADH formed during biomass production. Glycerol formation can significantly affect the economics of processes like ethanol production by lowering yields. A couple of different transhydrogenase systems have been investigated in S. cerevisiae.

Our elementary mode analyses suggested that engineering S. cerevisiae to provide a transhydrogenase system could enhance production of PHA. One potential S. cerevisiae transhydrogenase system involves increased expression of the glutamate dehydrogenases, GDH1 and GDH2. The present invention includes cloning the bacterial poly-beta-hydroxybutyric acid (PHB) pathway into S. cerevisiae, resulting in a significant accumulation of PHB during physiological states when an excess of NADH is expected. Because PHB synthesis consumes NADPH, the glutamate dehydrogenase gene GDH2 was over expressed in S. cerevisiae from a high copy number vector (Example 6). This gene when expressed with the native GDH1 gene is capable of transferring electrons from NADH produced during catabolic processes like glycolysis to NADPH that can be used for anabolic processes like the production of PHB. GDH2 acts with the normally high levels of GDHU1 to cycle reducing equivalents between α-ketoglutarate and glutamate and between NADH and NADPH.

A second potential transhydrogenase system involves increased expression of malic enzyme I (MAEI). The cyclic system involves pyruvate carboxylase, NAD⁺-dependent malate dehydrogenase, a mitochondrial dicarboxylate carrier and MAEI. Pyruvate is first converted to oxaloacetate by CO₂ dependent pyruvate carboxylase. Oxaloacetate is then reduced by NAD⁺-dependent malate dehydrogenase to form malate. A dicarboxylate carrier transports the cytosolic malate into the mitochondria where MAEI converts it into pyruvate, CO₂ and NADPH. The pyruvate can then travel back to the cytosol where it can once again be converted into oxaloacetate. A drawback to this system is the mitochondrial location of the generated NADPH. For cytosolic biosynthetic reactions like fatty acid synthesis, the NADPH would be inaccessible. NADPH cannot diffuse cross the mitochondrial membrane.

The rate of product formation can be limited by a host's ability to dissipate reducing equivalents generated during product synthesis. Sometimes the redox state can favor a certain desirable reaction. For instance, S. cerevisiae was used to produce lactic acid by expressing a mammalian lactate dehydrogenase gene (Porro et al., Biotechnol. Prog. 11: 294-298,1995). Since lactate is produced from the reduction of pyruvate, NAD⁺ was regenerated during lactate production reducing the need for ethanol formation.

Production of Ethanol in Yeast

S. cerevisiae is classified as a Crabtree-positive facultatively fermentative yeast (van Dijken et al., FEMS Microbiol. Rev. 32: 199-224, 1986). When aerobically cultured with high levels of fermentable sugars like glucose, galactose or maltose, S. cerevisiae shifts to a physiological state that favors the fermentation of glycolysis products. This physiological trait known as the “Crabtree effect” is activated by glucose (or galactose) concentrations as low as 50-130 mg L⁻¹. Under these conditions, respiration accounts for only 3-5% of the catabolized glucose (29% of catabolized galactose) with the remainder of the sugar being fermented. Since the electron transport chain receives only a small percentage of the generated reducing equivalents, the cells rely on a high flux of fermentation products to maintain a favorable redox balance. The primary fermentation by-product of S. cerevisiae is ethanol. Under a fermentative metabolism, glucose can be converted into 2 molecules of ethanol, 2 molecules of CO₂ and 2 molecules of ATP. The ATP can be used to meet energy requirements while CO₂ and ethanol diffuse out of the cell.

Ethanol was originally produced by batch processes however more recently, the production of industrial ethanol has moved toward continuous processes. It is believed most new industrial ethanol production facilities will focus on the more efficient, less capital intensive continuous processes. Continuous ethanol production processes typically utilize either a free or an immobilized cell system. Free cell systems usually involve a series of continuously stiffed-tank bioreactors (CSTBR).

Ethanol is a redox neutral compound. It does not consume additional reducing equivalents (NADH) formed during processes like biomass formation. Under fermentative conditions, glycerol serves as the primary electron sink. The formation of glycerol consumes two ATP and two reducing equivalents:

1 glucose+2 ATP+2 NADH+2H⁺→2 glycerol+2 ADP+2 Pᵢ+2 NAD⁺.

Like ethanol, glycerol is capable of diffusing across the cell membrane. To a lesser extent, the dicarboxylic acid succinate also serves as an electron acceptor and is commonly found as a fermentation by-product.

Bacterial Polyhydroxyalkanoate (PHA) Biosynthesis

Bacteria often synthesize PHAs as a carbon and energy storage material. The biopolymer is typically produced when growth is limited by some nutrient like nitrogen or phosphorous and when excess carbon source is available. PHA accumulates within the cell as insoluble granules that can be metabolized when environmental conditions improve. Production of PHA requires the consumption of reducing equivalents. During anaerobic growth, PHA can act as an electron sink or fermentation product permitting continued growth.

A number of different PHA pathways exist. The different pathways are exemplified by the pathways found in the following organisms: Ralstonia eutropha, Pseudomonas aeruginosa, Pseudomonas oleovorans, and Rhodospirillum rubrum (Jackson et al., New York Academy of Sciences 745: 134-148, 1994). But in every case, the final step of incorporating a monomer into the polymer chain is catalyzed by a PHA polymerase. The substrate specificities of the different bacterial polymerases can vary from organism to organism. For example, the polymerase enzyme utilized by Ralstonia eutropha (formally known as Alcaligenes eutrophus) is specific for short-chain-length (C₃-C₅) hydroxyacyl-CoA monomers while the polymerase enzyme utilized by Pseudomonas oleovorans is specific for medium-chain-length (C₆-C₁₂) hydroxyacyl-CoA monomers. The different pathways and their different substrate specificities can result in the production of very different PHAs. For instance, Ralstonia eutropha grown on fructose will produce primarily polyhydroxybutyric acid (PHB) while Pseudomonas oleovorans fed octanoic acid will produce primarily polyhydroxyoctanoic acid (PHO). In fact the P. oleovorans polymerase is even active with unsaturated, branched, aromatic, and halogenated C₆-C₁₂ hydroxyacyl-CoAs (Brandl et al., Appl. Environ. Microbiol. 54(8): 1977-1982,1988; Lageveen et al., Appl. Environ. Microbiol. 54(12): 2924-2932, 1988).

Different bacteria produce polymers of different molecular weights. R. eutropha typically produces PHB with molecular weights of 6×10⁵ to more than 1×10⁶ Da while other PHB accumulating bacteria produce polymers ranging from 5×10⁴ to 2×10⁶ Da (Anderson et al., Appl. Environ. Micro. 56: 3354-3359, 1990).

Enzymology for R. eutropha

The first step in the synthesis of PHB in Ralstonia eutropha is the β-ketothiolase catalyzed condensation of two acetyl-CoA molecules. The keto group of the resulting molecule, acetoacetyl-CoA, is then reduced in an NADPH dependent reaction catalyzed by PHB reductase. This step results in the formation of the monomer 3-hydroxybutyryl-CoA. The monomer is added to the polymer in a reaction catalyzed by the PHB synthase enzyme.

β-Ketothiolase. Ralstonia eutropha constitutively expresses at least three different β-ketothiolases. Each enzyme is believed to play a different role in either production or degradation of PHA's. β-ketothiolase, phbA, is believed the primary ketothiolase involved in PHB production. This enzyme is composed of four identical 40.5 kDa subunits and catalyses the condensation of two acetyl-CoA molecules forming acetoacetyl-CoA. The reaction is inhibited by free coenzyme A. PhbA also catalyzes the condensation of propionyl-CoA with acetyl-CoA to form the polyhydroxyvalerate (PHV) precursor β-ketovaleryl-CoA. However, phbA has a very low specific activity for this reaction.

A second β-ketothiolase, BktB, is more efficient at catalyzing the formation of β-ketovaleryl-CoA and is thought to play a central role in the production of the copolymer poly(β-hydroxybutyrate-co-β-hydroxyvalerate) (P(HB-co-HV)). In addition to C₅ substrates, BktB has enzymatic activity toward both C₄ and C₆ substrates. BktB is a tetramer comprised of 40.9 kDa subunits.

The third β-ketothiolase from R. eutropha, BktC, is believed to play a role in PHA degradation and possibly in β-oxidation of fatty acids.

NADPH-dependent acetoacetyl-CoA reductase. R. eutropha possesses at least two different acetoacetyl-CoA reductases. One is NADH-dependent while the other is NADPH-dependent. The NADH-dependent reductase is believed to play a role in β-oxidation. The NADPH-dependent reductase, phbB, is stereospecific reacting only with C₄ to C₆ D-3-hydroxyacyl-CoA's. During PHB synthesis, the tetrameric enzyme comprised of identical 26.3 kDA subunits catalyzes the reduction of acetoacetyl-CoA's 3-keto group to form D-3-hydroxybutyryl-CoA. NADPH reductase is about 20% active with the cofactor NADH.

PHA synthase. R. eutropha expresses one, stereospecific PHA synthase, phbC, which catalyzes the formation of the ester bond between D-3-hydroxyacyl-CoA and the polymer chain. This enzyme has shown activity with C₃ to C₅ D-3-hydroxyacyl-CoA's and exists both as a 63.9 kDa monomer and as a dimer. The dimeric form is catalytically more active and is typically associated with the hydrophobic PHA granule.

Although PHB is the best studied PHA, brittle material properties and poor thermal stability limit its applications. A copolymer of PHB and poly-D-3-hydroxyvalerate acid (PHV) known as poly(hydroxybutyrate-co-hydroxyvalerate (P(HB-co-HV) has more desirable physical properties.

Eukaryotic Production of PHAs (Native and Recombinant)

PHAs have been found to occur natively in eukaryotic cell membranes where they are believed to play roles in membrane transport channels (Reusch, Proc. Soc. Exp. Biol. Med. 191: 377-381, 1989: Reusch, FEMS Microbiol. Rev. 103: 119-130, 1992). In addition to producing native PHAs, a number of eukaryotes have been used as hosts to produce recombinant PHA. The list includes Arabidopsis thaliana, cotton, maize, S. cerevisiae, and insect culture cells.

Eukaryotic production of PHAs requires some of the same precursors as bacterial production. Acetyl-CoA and long chain D-3-hydroxyacyl-CoAs are examples of PHA precursors found in the eukaryote S. cerevisiae.

The catabolic β-oxidation system, which can be induced in S. cerevisiae by long chain fatty acids like oleic acid (Veenhuis et al., Yeast 3: 77-84 ,1987), metabolizes fatty acids into acetyl-CoA. β-oxidation of fatty acids occurs in peroxisomes and can lead to the production of acetyl-CoA. The peroxisomally located acetyl-CoA can then be transported into the cytosol by camitine acyltransferase.

β-oxidation can also produce other precursors that could potentially be used in the production of PHAs. During fatty acid catabolism, a D-3-hydroxyacyl-CoA intermediate is formed. This is unusual since most organisms go through an L-3-hydroxyacyl-CoA intermediate. PHA polymerases are stereospecific for D-enantiomers making the S. cerevisiae intermediate a potential substrate for PHA production. Based on the original fatty acid and based on the extent of catabolism, β-oxidation could provide a wide range of different sized D-3-hydroxyacyl-CoAs. Compartmentalization of these metabolites is an important issue since they cannot freely diffuse across an organelle membrane. Peroxisomal peptide targeting sequences have been identified and have been used successfully to target R. eutropha PHB genes to maize peroxisomes (Hahn, Introduction and Characterization of the Poly(3-Hydroxybutyrate) Biosynthetic Pathway in Plant Cell Cultures. Ph.D. Dissertation, University of Minnesota, St. Paul, Minn., 1998). These sequences could be used with a long chain PHA polymerase like the one found in P. oleovorans to target enzymatic activity to the peroxisome. The P. oleovorans polymerase is active with C₆ to C₁₂ D-3-hydroxyacly-CoA's so depending on which fatty acids are fed a wide variety of different monomers could be incorporated into PHA. Since β-oxidation provides the precursors, only a targeted polymerase gene should be needed to produce peroxisomal PHA.

### Example 2

### General Materials and Methods for Production of PHA in S. cerevisiae

Unless otherwise noted, all chemicals were purchased from Sigma (St. Louis, Mo.) or Fisher (Fair Lawn, N.J.).

Strains

Common maintenance of DNA plasmids was conducted in E. coli strains DH5α (Life Technologies) and MC1061 (ATCC 53338). When a required restriction site was sensitive to methylation, DAM methylase negative E. coli strain GM34 was used.

S. cerevisiae strain D603 (MATa/MATα ura3-52 lys2-801 met his3 ade2-101 reg1-501 [cir+])(Srienc et al., Cytometry 7, 132-141, 1986) was used in all described yeast studies. The reg1-501 mutation at least partially released the glucose repression of the GAL1-10 promoter. This mutation permits the induction of the GAL1-10 promoter in the presence of glucose with galactose concentrations as low as 0.2 g/L. For construction of plasmids containing constitutive promoters, strain YPH399 (MATa, ade2-101, leu2Δ1, lys2-80, his3D200, trpID63, ura3-52) was used. This strain was obtained from Dr. James Bodley (Department of Biochemistry, University of Minnesota Medical School).

Bacterial Growth Media

Bacterial liquid cultures for maintenance of DNA plasmids were typically grown in terrific broth (TB) media (12 g/L Bacto tryptone (Difco, Detroit, Mich.), 24 g/L Bacto yeast extract (Difco), 4 ml/L glycerol, 0.017 M KH₂PO₄, 0.072 M K₂HPO₄)(Sambrook et al., Molecular Cloning: A Laboratory Manual, Cold Spring Harbor Laboratory Press, New York, 1989). Agar plates were made of Luria-Bertanini (LB) broth (5 g/L Bacto yeast extract (Difco), 10 g/L Bacto tryptone (Difco), 10 g/L NaCl (Fisher), and 15 g/L Bacto agar (Difco)(Sambrook et al., Molecular Cloning: A Laboratory Manual, Cold Spring Harbor Laboratory Press, New York, 1989). When appropriate, either ampicillin (100 μg/ml) or kanamycin (100 μg/ml) was added. E. coli cultures were normally incubated at 30° or 37° C.

S. cerevisiae Growth Media

Wild type S. cerevisiae cultures were grown on YPD media (1% (wt/v) Bacto-yeast extract (Difco, Detroit, Mich.), 2% (wt/v) Bacto-peptone (Difco), 2% (wt/v) dextrose) (Sherman et al., In Methods in Yeast Genetics. Cold Spring Harbor Laboratory, Cold Spring Harbor, N.Y., 1979). Transgenic yeast strains were grown on SD minimal media (1.6 g/L Bacto Yeast Nitrogen Base w/o Amino Acids and Ammonium Sulfate (Difco), 5 g/L ammonium sulfate, and 20 g/L D-glucose). The following additions were made to complement the auxotrophic mutations of S. cerevisiae D603: 20 mg/L adenine, 20 mg/L methionine, 30 mg/L lysine, and in some cases 20 mg/L histidine depending on what plasmids were maintained by the strain (Sherman et al., In Methods in Yeast Genetics. Cold Spring Harbor Laboratory, Cold Spring Harbor, N.Y., 1979). To avoid problems associated with the heat stability of some species, all media components were filter sterilized (Supor-200 filter disc, pore size 0.2 μm, Gelman Sciences, Ann Arbor, Mich.). Agar plates were made by adding 15 g/L of Bacto agar (Difco) to the previously described media.

For shake flask and bioreactor examples, an enriched form of the SD minimum media was used (Da Silva, Ph.D. Dissertation, California Institute of Technology, Pasadena, Calif., 1988). This media resulted in a higher final biomass than the standard SD media. Modifications to previously described media include:, 100 mg/L adenine, 100 mg/L methionine, 150 mg/L lysine, and when needed 80 mg/L histidine. Glucose and galactose concentrations varied with example.

S. cerevisiae cultures were typically incubated at 30° C.

Shake Flask Cultures

During shake flask studies, all conditions were performed in triplicate. The cultures were grown in 250 ml Erlenmeyer flasks containing 50 ml of filter sterilized enriched SD media. Sugar compositions and concentrations varied with experiment. The shaker was operated at 200 rpm and 30° C. All reported data is an average of the three separate flask cultures.

Bioreactor Cultures

Bioreactor studies were typically conducted in a 5.0 L reactor (Biostat B, B. Braun Biotech International, Melsunngen, Germany) that was batched with 3.0 liters of filter sterilized enriched SD media containing 1% (wt/v) glucose and 1% (wt/v) galactose. The pH control loops were set at 4.5 and maintained with a 0.25 N solution of NaOH and a 1% (v/v) solution of H₃PO₄. The dissolved oxygen levels were monitored but were not controlled. The rpm was set at 300, and the temperature was maintained at 30° C. with a circulating water jacket. The reactor was sparged with 3 liters air/ min (1VVM). The exhaust gas passed through a water-cooled condenser. The bioreactors were inoculated with 60 ml of the appropriate culture that had been grown overnight on enriched SD media (1% (wt/v) glucose and 1% (wt/v) galactose).

During operation, 40 ml culture samples were collected in sterile tubes from the reactor's sampling port. Sampling intervals ranged from three hours during the early stages of growth to twelve hours toward the end of the run. Collected samples were stored on ice prior to being processed.

In an additional example, bioreactor studies were conducted in a two 2.0 L bioreactor (LH Fermentation, Hayward, Calif., Model 502D) that was batched with 1.5 liters of filter sterilized enriched SD media containing 5% (wt/v) glucose and 1% (wt/v) galactose. The initial ammonium sulfate concentration was 1 g/L instead of the usual 5 g/L used in shake flask experiments. The pH control loops were set at 4.5 and maintained with a 0.25 N solution of NaOH and a 1% (v/v) solution of H₃PO₄. The dissolved oxygen levels were monitored but were not controlled. The rpm was set at 700, and the temperature was maintained at 30° C. with a circulating water bath. The reactors were sparged with 1.5 liters air min. To prevent excess evaporation, the sparge gas was bubbled through distilled water before entering the reactor. The bioreactors were inoculated with 50 ml of the appropriate cultures that had been grown over night on enriched SD media (5% (wt/v) glucose and 1% (wt/v) galactose).

During operation, 40 ml culture samples were collected in sterile tubes from the reactor's sampling port. Sampling intervals ranged from three hours during the early stages of growth to twelve hours toward the end of the run. Collected samples were stored on ice prior to being processed.

Strain Preservation

Bacterial and yeast strains were cryopreserved at −80° C. in a 15% glycerol solution.

Plasmid Isolation

The “boiling mini-prep” method was used to recover plasmid DNA from mid to late exponential growth phase E. coli cells. 1.5 ml of overnight cell culture grown under selective conditions was placed in a microfuge tube and centrifuged at 14,000 rpm of 20 seconds. The supernatant was discarded and the cell pellet was resuspended in the residual liquid. 300 μl of STET (8% (wt/v) sucrose, 50 mM Tris pH 8.0, 50 mM EDTA, 5% (wt/v) Triton X-100) was added followed by 20 μl of a 50 μg/ml lysozyme solution. The tubes were gently but thoroughly mixed and allowed to incubate at room temperature with periodic agitation for ten minutes. The tubes were then placed in a boiling water bath for two minutes. To permit pressure equalization during heating, a single perforation of the microfuge tubs' lids was made with a razor blade. After boiling, the samples were allowed to cool to room temperature and then centrifuged at 14,000 rpm for 7 minutes. The gelatinous pellet of denatured protein and chromosomal DNA was removed with a sterile toothpick and discarded. An equal volume of precipitation solution (75% isopropanol and 2.5 M ammonium sulfate) was added and the mixture allowed to incubate at room temperature for ten minutes. The tubes were then placed in a microfuge and spun for 7 minutes at 14,000 rpm. The pelleted DNA was washed twice with 70% (v/v) ethanol and allowed to dry. The DNA was resuspended in 30-50 μl of TE buffer (10 mM Tris.Cl (pH 7.4), 1 mM EDTA (pH 8.0)) supplemented with 50 μg/ml RNaseA (Engenbrecht et al., Boiling Miniprep. In Short Protocols in Molecular Biology. Ausubel et al., Eds.: 1-17. John Wiley & Sons, Inc., New York, Third Edition, 1995). The isolated DNA may contain a fair amount of residual protein and chromosomal DNA. For applications that required pure DNA, the mini-prep DNA isolation was followed by a phenol-chloroform extraction.

Phenol-chloroforn Extraction

The DNA sample was placed in a microfuge tube and diluted to a final volume of 70-100 μl with distilled water. An equal volume of phenol-chloroform (Amresco, Solon, Ohio) was added and the solution was vortexed vigorously for one minute. The two phases were then allowed to separate for four minutes at room temperature. The solution was then spun in a microfuge at 14,000 rpm for eight minutes. The upper aqueous layer containing the DNA was removed with a pipette. The extracted DNA was then precipitated by adding an equal volume of precipitation solution (75% isopropanol and 2.5 M ammonium sulfate). The solution was allowed to incubate for ten minutes at room temperature. The solution was then placed in a microfuge and spun at 14,000 rpm for 8 minutes. The recovered pellet was washed twice with 70% (v/v) ethanol and resuspended in either distilled water or TE buffer (10 mM Tris.Cl (pH 7.4), 1 mM EDTA (pH 8.0)).

DNA Construct Screening

DNA constructs were screened using restriction endonucleases. The resulting DNA fragments were then compared to appropriate controls to check plasmid construction. The composition of the digest reaction was based on guidelines provided by the manufacture (Life Technologies or New England Biotechnologies). A typical digest was carried out in a microfuge tube with a final volume of 10 μl (1-4.0 μl DNA preparation, 1.0 μl 10×buffer, 0.5-1.0 μl of each restriction enzyme, and ddH2O to bring to 10 μl). Digests were incubated under appropriate conditions (usually 25° C. or 37° C.) for 1 to 15 hours. Resulting fragments were separated based on size using electrophoresis and compared to commercial size ladders and appropriate control plasmids.

Vectors which were to be used in DNA constructs and which were susceptible to self-ligation had 0.5 μl of calf intestinal phosphatase (Life Technologies) added to the digestion reaction mixture.

DNA Electrophoresis

Electrophoresis was used to separate DNA fragments based on size. Typically 0.7% (wt/v) agarose gels were used for medium sized DNA fragments (approximately 700 to 7000 base pairs) although higher agarose concentrations (1.5 to 2% (wt/v)) were used for smaller DNA fragments. An appropriate amount of Sea Kem LE Agarose (FMC) was added to 50 ml of tris-acetate electrophoresis buffer (TAE) (0.04 M tris acetate and 0.001 M EDTA)(Sambrook et al., Molecular Cloning: A Laboratory Manual, Cold Spring Harbor Laboratory Press, New York, 1989) and the mixture was placed in a microwave set on high for one minute. After allowing the solution to cool to ˜55° C., 30 μg of ethidium bromide was mixed into the solution and then it was poured into an electrophoresis casting tray. A comb was placed into the molten agar to create loading wells. Upon solidification, the gel was placed in a Hoeffer Scientific Instruments model HE33 electrophoresis chamber (San Francisco, Calif.). The chamber was filled with refrigerated TAE buffer. The DNA samples were mixed with 1/5 volume of running buffer (30% glycerol, 0.25% bromophenol blue, and 0.25% xylene cyanol FF) and were then added to the wells. For estimating fragment size, a well was loaded with 1 Kb DNA ladder (Life Technologies, Rockville, Md.) and run with the other samples. The gels were normally run at 95 to 120 volts for 30 to 40 minutes. The resulting DNA bands were visualized with an ultraviolet trans-illuminator.

DNA Fragment Isolation

When the isolation of a DNA fragment was desired, the appropriate band would be excised from the agarose gel using a razor blade. The DNA fragment was freed from the agarose matrix using a Geneclean II kit (Bio 101, Inc., Vista, Calif.). The procedure was performed in accordance with the included manufacturer's guidelines. The recovered DNA was resuspended in a minimal volume of TE buffer (10 mM Tris.HCl (pH 7.4), 1 mM EDTA (pH 8.0)).

Blunt Ending with Klenow DNA Polymerase

5′ sticky ends created from a restriction digest can be made blunt with the Klenow Large Fragment of DNA Polymerase I (Life Technologies, Rockville, Md.). The procedure used was in accordance with the guidelines provided by the manufacturer.

DNA Ligation

The ligation of two DNA fragments was performed in a 10 μl reaction volume incubated for 4 to 16 hours in a 16° C. water bath. A typical reaction mixture was as follows: 6 μl of isolated, “Genecleaned” insert, 1 μl of isolated “Genecleaned” vector, 2 μl 5×T4 DNA ligase buffer, and 1 μl of T4 DNA ligase enzyme (Life Technologies, Rockville, Md.). Gene insert to vector ratios were designed to be at least 3:1. Negative controls included the previously mentioned reaction mixture with only insert DNA or with only vector DNA. Such controls examined the DNA's ability to self-ligate.

Preparation of Competent E. coli

A 50 ml culture of wild-type E. coli DH5α or GM34 were grown in LB media to an OD₆₀₀ of approximately 1 or 2. The mid-log phase cells were transferred to sterile 50 ml centrifuge tube and incubated on ice for 40 minutes. The cells were then centrifuged at 750-1000 G for 15 minutes at 4° C. The supernatant was decanted and residual liquid was removed with a pipette. The cell pellet was resuspended in 16.7 ml of FB solution (see below) and the cells were then incubated on ice for 40 minutes. The solution was again centrifuged at 750-1000 G for 15 minutes at 4° C. The supernatant was discarded and the residual liquid was removed with a pipette. The cell pellet was then resuspended in 4 ml of FB solution. 100 μl aliquots of resuspended cells were placed in sterile 1.5 ml microcentrifuge tubes and stored at −80° C. FB Solution: 0.1 M KCl, 0.05 M CaCl₂, 1 M glycerol, 0.01 M potassium acetate, adjust pH to 6.2 using HCl and filter sterilize solution. Adapted from DNA Cloning, Volume 1, D. M. Glover ed., IRL Press, Washington D.C., p.119, 1985.

E. coli Transformation

100 μl aliquots of competent E. coli cells stored at −80° C. were thawed on ice. 2-4 μl of the DNA ligation mixture or 1-4 μl of the mini-prep solution was added to the microfuge tube containing the competent cells. The cells and DNA were then incubated with gentle mixing for one hour on ice. The cells were then heat shocked for 90 seconds at 42° C. 300 μl of TB (12 g/L Bacto tryptone (Difco, Detroit, Mich.), 24 g/L Bacto yeast extract (Difco), 4 ml/L glycerol, 0.017 M KH₂PO₄, 0.072 M K₂HPO₄) media was added to the cell solution and the cells were placed in a 30° C. shaker for 30 to 60 minutes. 200 μl of the cell solution was then spread on agar plates containing the appropriate antibiotic. The plates were then incubated at 37° C. over night.

Transformation of S. cerevisiae

1.5 ml of overnight S cerevisiae culture was placed in a microfuge tube and spun at 14,000 rpm for 20 seconds. The supernatant was discarded and the cell pellet was resuspended in the residual liquid. 100 μg of carrier DNA (Salmon sperm DNA) and the transforming DNA were added to the cell solution and vortexed briefly. 0.5 ml of yeast transformation solution [40% PEG 3350, 0.1 M LiAc, 10 mM TrisCl pH 7.5, 1 mM EDTA] was added along with DMSO to a final concentration of 10%. The suspension was thoroughly mixed and incubated with intermittent agitation at room temperature for 15 minutes. The cells were then heat shocked in a water bath at 42° C. for fifteen minutes. The cells were pelleted in a microfuge for 20 seconds at 14,000 rpm and washed once in TE buffer. The cells were once again pelleted in a microfuge resuspended in approximately 200 μl of TE buffer. The cell solution was then spread on selective yeast plates and incubated at 30° C. for 2-3 days (Soni et al., Curr. Genet. 24: 455-459, 1993).

Plasmid Recovery from S. cerevisiae

An overnight culture of yeast (1.5 ml) grown under appropriate conditions was spun in a microfuge for 20 seconds at 14,000 rpm. The cell pellet was resuspended in 100 μl of STET (8% sucrose, 50 mM Tris pH 8.0, 50 mM EDTA, 5% Triton X-100). 0.2 g of 0.45 mm glass beads were then added to the microfuge tube. The tube containing the cells and glass beads was vortexed vigorously for 5 minutes. Another 100 μl of STET was added and the tube was again vortexed for 1 minute. The cell solution was then incubated for 3 minutes in a boiling water bath. The solution was cooled on ice and spun in a microfuge at 14,000 rpm for 10 minutes. 100 μl of the supernatant was transferred to a fresh microfuge tube containing 50 μl of 7.5 M ammonium acetate and incubated at −20° C. for one hour. The solution was then centrifuged for 10 minutes at 14,000 rpm. 100 tl of the supernatant was added to 200 μl of ice-cold ethanol and allowed to incubate on ice for five minutes. The precipitated DNA was recovered by spinning the solution at 14,000 rpm for 8 minutes. The pellet was washed with 70% ethanol and re-suspended in 20 μl of water or TE buffer. 10 μl of this solution was then used to transform competent E. coli (Robzyk et al., N.A.R. 20(14): 3790, 1992). Because of the presence of inhibitory contaminating proteins, the transformation of E. coli with recovered yeast plasmids doesn't always work. This procedure was found to work with S. cerevisiae strain D603 and E. coli strain DH5α.

Curing of “URA3 Blaster” Cassette

S. cerevisiae cultures containing the “URA3 blaster” cassette (Alani et al., Genetics 116: 541-545, 1987) were cultured in nonselective YPD media for three days. A 100 μl aliquot was then spread on SD plates containing 1 g/L 5-fluro-orotic acid along with 40 mg/L uracil, 20 mg/L histidine, 20 mg/L adenine, 20 mg/L methionine, and 30 mg/L lysine (5-FOA SD_{UHAMLY}). Resulting colonies were transferred to fresh 5-FOA SD_{UHAMLY} plates. The subsequent growth was transferred to uracil deficient SD_{HAMLY} plates to double check the absence of the URA3 marker. After determining the URA3 marker was no longer present, the cultures were maintained on YPD media.

Polymerase Chain Reaction

All PCR reactions were performed with cloned Pfu DNA polymerase (Stratagene, La Jolla, Calif.) and with the manufacture's 10×reaction buffer. Typical final reaction conditions were: 0.025 U μl⁻¹ Pfu DNA polymerase, 0.2 mM each dNTP, 0.4 μM each primer, 20 mM Tris.HCl (pH 8.8), 2 mM MgSO₄, 10 mM KCl, 10 mM (NH₄)₂SO₄, 0.1% Triton X-100, and 100 μg ml⁻¹ nuclease-free BSA. A Perkin Elmer Thermocycler was used for caring out the polymerase reactions with a typical program as follows: 95° C. for 50 seconds, 95° C. for 45 seconds, 55-60° C. for 50 seconds, 72° C. for 2 minutes kb⁻¹ of PCR target (25-30 cycles), 72° C. for 10 minutes.

Ammonium Assay-Berthelot Reaction

Culture supernatant was diluted so the ammonium concentrations would be less than 0.1 g/L. 0.05 ml of the diluted culture sample was added to disposable 1 cm Acryl-Cuvettes (no. 67.740, Sarsedt, Newton, N.C.) along with 1 ml of solution A (10 g/L phenol, 10 mg/L sodium nitroprusside). Then 1 ml of solution B (67.4 g/L Na₂HPO4.7H₂O, 6 g/L NaOH, 10 ml/L NaOCl(5% aq.)) was added to the cuvette and the solution incubated at 37° C. for 30 minutes. After allowing the samples to cool, the absorbencies were read at 630 nm (HP 8452A Diode Array Spectrophotometer). A calibration curve was created from known concentrations of ammonium and was used to correlate culture absorbencies to ammonium concentration (Srienc et al., Biotech. Bioeng. 26, 982-987, 1984).

Enzymatic D-glucose Assay

Culture glucose levels were assayed using Boehringer-Mannheim D-Glucose assay kits. Culture samples were diluted so that glucose concentrations would be in the range of 0.08-1.0 g/L. Reaction volumes were modified so the reactions could be prepared in 2 ml disposable Acryl cuvettes. The reaction set up was as follows: 300 μl Solution 1, 30 μl diluted culture sample, 570 μl ddH₂O, and 6 μl Solution 2 for a total volume of 906 μl. Absorbance was read as described in manufacture's guidelines at 340 nm. Sample D-glucose concentrations were determined from a calibration curve created from known D-glucose concentrations. Water was used in place of the diluted culture sample for the blank.

Enzymatic D-galactose Assay

Culture galactose levels were assayed using Boehringer-Mannheim D-Galactose assay kits. Culture samples were diluted so that sample galactose concentrations were in the range of 0.2-1.0 g/L. Reaction volumes were modified from manufacture's guidelines so that the reactions could be prepared in a 2 ml disposable Acryl cuvette. The reaction set up was as follows: 40 μl Solution 1, 20 μl diluted culture sample, 200 μl Solution 3, 390 μl ddH2O, and 10 μl Suspension 4 for a total volume of 660 μl. Suspension 2, which contains β-galactosidase used to convert lactose to glucose and galactose, was not relevant to described experiments and was excluded. Absorbencies were read as described in manufacture's guidelines at 340 nm. Culture sample D-galactose concentrations were determined from a calibration curve created from known D-galactose concentrations. Water was used in place of diluted culture sample when preparing the blank.

PHB Analysis (propanolysis/GC)

A known volume of cell culture was placed in screw top, glass test tube, pelleted by centrifugation at 800 G for 15 minutes and then washed in deionized water. The cells were pelleted again and the recovered pellet dried over night at 98° C. Dry cell material (approximately 60 mg) was incubated with periodic agitation for 3.5 hours in a boiling water bath in a mixture of 0.5 ml 1,2-dichloroethane (DCE) and 0.5 ml of acidified propanol (20 ml HCl, 80 ml 1-propanol). 50 μl of a benzoic acid internal standard solution (0.2 g benzoic acid, 50 ml 1-propanol) was added to the mixture prior to boiling. The threads of the screw top test tube were wrapped with Teflon tape before the cap was placed on the tube. The seal created by the tape helped prevent the DCE vapor from escaping while the sample was incubated in the boiling water bath. After incubation, the solutions were cooled to room temperature. The organic phase was extracted once with 1 ml of de-ionized water (Riis et al., J. Chromatography. 445, 285-289, 1988). The organic phase was then transferred to GC vials (C4000.1W, National Scientific Company) and analyzed using a Hewlett-Packard 5890A gas chromatograph (Palo Alto, Calif.). Samples were run on a DB-WAX 30W capillary column and detected by a flame ionization detector, with a constant rate of temperature increase of 10° C./min (60-200° C.). PHB content was calculated by dividing the area of the PHB peak by the area of the benzoic acid peak. This ratio was then converted to a PHB mass by creating a standardization plot. The standardization plot was created from samples of known PHB mass (MW 30,000, Polysciences Inc., Warrington, Pa.).

Ethanol Assay

0.5 ml of culture supernatant was added to a GC vial (C4000.1W, National Scientific Company) along with 0.1 ml of internal standard solution (3 g/L 1-propanol). Samples were run on a Hewlett-Packard 5890A gas chromatograph (Palo Alto, Calif.) with a DB-WAX 30W capillary column and detected by a flame ionization detector. A standardization plot was created from samples of known concentration.

Optical Density and Cell Dry Mass

Cell culture optical densities were read at 600 nm in 1 cm Acryl-Cuvettes (No. 67.740, Sarstedt, Newton, N.C.) on a Hewlett Packard (Palo Alto, Calif.) 8452A Diode Array Spectrophotometer. Samples were diluted so that OD₆₀₀ were in the range of 0.1 to 0.333. Culture biomass was determined by vacuum-filtering a known volume of culture through a pre-weighed Supor-200 filter disc, pore size 0.2 μm (Gelman Sciences, Ann Arbor, Mich.). The samples were rinsed with 10 ml of distilled water and the discs were allowed to dry for 24-36 hours at 98° C. The dried samples were allowed to cool to room temperature before being weighed.

Reductase Assay

Between 15 rml and 50 ml of cell culture were used for the reductase idenzyme assay. The cells were pelleted and resuspended in 5 ml of lysis buffer (0.01 M potassium phosphate, 2 mM EDTA, 0.5 mM Benzamidine, 0.5 mnM DTT, 0.1 mM PMSF) (Leaf, Ph.D. Dissertation. University of Minnesota. St. Paul, Minn., 1998). Cell extract was prepared by passing the resuspended cells through a French Press three times.

The cuvette holder and the reaction buffer (50 mM potassium phosphate buffer (pH 6.0)) were kept at 30° C. with a circulating water bath. The two cofactor/substrate solutions (1.0 mM □-NADPH and 320 μM acetoacetyl-CoA, both prepared in reaction buffer) were kept on ice along with the cell extracts (Jackson, Recombinant Modulation of the phbCAB Operon Copy Number in Ralstonia eutropha and Modification of the Precursor Selectivity of the Pseudomonas oleovorans Polymerase I. Masters Dissertation. University of Minnesota. St. Paul, Minn., 1998).

Reduction of acetoacetyl-CoA was used to assay NADPH-dependent acetoacetyl-CoA reductase activity (Haywood et al., FEMS Microbiol. Lett. 52: 259-264, 1988). The 1.0 ml assay volume had a final concentration 50 mM potassium phosphate buffer (pH 6.0), 32 FM acetoacetyl-CoA, and 100 μM β-NADPH. The assay was started by adding the cell extract to the reaction solution. Decrease in β-NADPH concentration was monitored by changes in absorbance at 340 nm and enzyme activities were calculated using a β-NADPH absorption coefficient of 6.2×10³ liter mol⁻¹ cm⁻¹ (Kuchel et al., Theory and Problems of Biochemistry, McGraw-Hill, Inc., New York 1988). Cell extract protein concentrations were determined using the Bio-Rad Protein Assay (Bio-Rad Laboratories, Hercules, Calif.). One unit (U) of enzyme is defined as the quantity required to catalyze 1 μmol of substrate per minute.

Quantitative Analysis

To better characterize a biological process, it is useful to describe certain experimental parameters with numerical values. These values help predict results and facilitate comparisons between different experiments.

Specific rates. Specific rates can typically be represented by the following differential equation:

r_{spc,A}=(1/x)dA/dt (2.1)

where A is the compound of interest's mass, r_{spc,A} is the specific rate of compound A, x is the instantaneous biomass concentration, and t is time.

Common specific rates associated with biological systems include the specific growth rate where A would represent the biomass, the specific product formation rate where A would represent the product's mass, and the specific substrate consumption rate where A would represent the substrate's mass. The specific consumption rate would also include a negative sign.

The specific growth rates were calculated using the integrated form of Eqn (2.1):

x=xₒe^{μ(t-to)} (2.2)

which was rearranged to give:

μ=(t-t₀)⁻¹ ln (x/xₒ) (2.3)

where xₒ is the biomass concentration at time t₀ and μ is the specific growth rate.

The specific glucose consumption rate was determined by fitting the experimental data for glucose and biomass with a third order polynomial expression. The first derivative was taken of the polynomial to yield d[glucose or biomass]/dt. The specific rate was determined by dividing the preceding equation by the expression for biomass concentration. For instance, the specific glucose consumption rate would be

r_{glucose}=−(1/x(t)) d[glucose]/dt

The specific ethanol production rate was calculated in a similar fashion with the only exception being that it was a formation expression so the concentration derivative with respect to time was positive.

The specific PHB production rate was determined by taking the slope of modified specific PHB content with respect to time. In order to get a more accurate picture of PHB kinetics, this calculation used the residual biomass and not the total biomass that is defined as follows:

biomassₜₒₜₐₗ=biomass_{residual}+mass_{PHB} (2.4)

the following variation was then used to define the specific production rate:

r_{spc,PHB}=d[mass PHB/mass residual biomass]/dt. (2.5)

Volumetric rates. Volumetric rates are commonly used because the total mass of a product or substrate is dependent on the system size. The volumetric production rate of compound A is defined as:

r_{V,A}=(1/V)*(dA/dt) (2.6)

with V being the system volume, A being the mass of compound A, and t representing time. The term on the right would have a negative sign if compound A were a substrate.

Yields. Yields were calculated to estimate how efficiency a substrate was converted into a product. Three different methods were used to calculate yield. The first two are observed yields defined by mass of product per mass of utilized substrate:

Yₚₛ=−(Δₘₐₛₛ of products produced)*(Δₘₐₛₛ of consumed substrate)⁻¹ (2.7)

or in some cases by the ratio of rates

Yₚₛ=−(dp/dt)*(ds/dt)⁻¹ (2.8)

where p is the mass of product, s is the mass of substrate, and t is time.

A yield can also be defined in terms of atoms like for instance carbon. In such cases the yield is defined as:

$${Y}_{ps} = ( \# C atoms / product ) * \\ ( \# of product molecules produced ) ) * \\ {[ {\sum }_{1}^{i} ( \# of C atoms / {substrate}_{i} ) * \\ ( \# of substrate {molecules}_{I} consumed ) ]}^{- 1} . \qquad ( 2.9 )$$

Yields

Yields were calculated to estimate how efficiency a substrate was converted into a product. Three different yields were examined: (1) biomass/substrate, (2) ethanol/substrate, and (3) PHB/substrate and were defined by:

mass (g) of product produced/mass (g) of consumed substrate.

The shake flask studies described above used the following methods to arrive at yield coefficients. It is understood that these methods are rough approximations due to the limited data points. The yields are given as estimations of actual values and to facilitate comparison of the experiments.

The biomass yield was calculated from time zero to the first sampling. With the shake flask studies, this interval was dominated by cell growth with little production of PHB or ethanol. The actual sampling times varied between experiments due to the different growth rates on the different substrates. The total consumed sugar for the glucose/galactose experiment took into account both carbon sources.

The ethanol yields were calculated between the first and the second samplings using the relevant culture sugar concentrations. During this interval, little cell growth took place and the ethanol concentrations reached a maximum. After the second sampling, the ethanol concentrations decreased due to oxidation and evaporation making the interval inappropriate for yield calculations.

PHB yields were calculated between the first and last samplings. The PHB content (per liter) at the first sampling was subtracted from the PHB content (per liter) at the last sampling and this value was divided by the sugar consumed during the same interval.

Plasmid stability. Plasmid stability plays an important role in the overall performance of a recombinant culture. This parameter can be determined using a combination of selective and nonselective plates. The plasmid stabilities were determined by plating equal volumes of a diluted cell culture on selective plates like SD_{HAMLY} and on nonselective plates like YPD. The plasmid stability can be defined as:

F=# of on colonies on selective plate/# of colonies on nonselective plates. (2.10)

Plasmid instability during batch cultivation can be represented by a simple model. The population is divided into two categories: plasmid containing cells x⁺ and plasmid free cells x⁻. The rate of each population's growth is modeled by the following expressions:

rₓ₊=(1-p)μ⁺x⁺ (2.11)

and

rₓ₋=pμ⁺x⁺+μ⁻x⁻ (2.12)

where r is the growth rate, p is the probability of plasmid loss per cell division (p≦1), μ⁺ is the specific growth rate for plasmid containing cells and μ⁻ is the specific growth rate for plasmid free cells. The model assumes all cells within each subpopulation (x⁺ or x⁻) have the same specific growth rate (μ⁺ or μ⁻ respectively) and that all plasmid-containing cells have the same probability of losing all their plasmids. The fraction of cells containing plasmid at some time t would then be:

F(t)=x⁺(t)/[x⁺(t)+x⁻(t)]. (2.13)

Integrating Eqs (2.11) and (2.12) simultaneously using the initial conditions x⁺=x⁺ₒ and x⁻=x⁻ₒ at t=0 results in the following time dependent expression:

F=[1-α-p]*[1-α-2^{n(α+p-1)}p]⁻¹ (2.14)

where

α=μ⁻/μ⁺

and

n=μ⁺t/ln2.

n represents the generation number of plasmid containing cells (Doran, Bioprocess Engineering Principles. Academic Press, New York, pp. 257-297, 1997).

### Example 3

### Divergent Promoter Constructs

GAL 1-10 Promoter

Because of its ability to co-regulate two genes, the GAL1-10 promoter was selected as the basis of a yeast expression system. A modified copy of the GAL1-10 promoter was obtained from plasmid pRS169 (Sikorski et al., Genetics 122: 19-27, 1989) using PCR. The PCR primers were designed with a number of considerations in mind. First, the promoter had to be compatible with the S. cerevisiae vectors used. To allow maximum flexibility, the RS300 series yeast shuttle vectors created by Sikorski and Hieter (Sikorski et al., Genetics 122: 19-27, 1989) were picked to serve as the backbone for the autonomous plasmid system. The four shuttle vectors were originally constructed from pBLUESCRIPT (Stratagene, La Jolla, Calif.) and contained one of following yeast selection markers: HIS3 (pRS303), TRP1 (pRS304), LEU2 (pRS305), and URA3 (pRS306).

In addition to constructing an autonomous plasmid system, the promoter was also designed to be used with an integrative plasmid system (see Example 5, below). The plasmid pNAD-FL13 (Lee et al., Appl. Microbiol. Biotechnol. 48: 339-345, 1997) contains two very useful features. The first feature is the δ element that serves as a non-unique targeting sequence. This targeting sequence permits the integration of up to five stable gene copies with a single transformation (Lee et al., Appl. Microbiol. Biotechnol. 48: 339-345, 1997). The second convenient feature is the “URA3 blaster cassette” selection marker (Alani et al., Genetics 116: 541-545, 1987). This cassette consists of a yeast URA3 gene flanked by 1.1 kb of Salmonella hisOGD DNA. Recombination between the two repeats results in the looping out of the URA3 selection marker.

The promoter design took into account the restriction sites found on both the integrative and autonomous plasmid systems. The outside restriction site was chosen to be EcoRI for the GAL10 promoter and chosen to be SalI for the GAL1 promoter. These restriction sites allowed the promoter to be cloned into unique restriction sites found in both the autonomous and the integrative plasmid systems. In addition to the outside cloning sites, ClaI was picked as an inside restriction site for the GAL10 promoter. This permits the easy cloning of numerous lab genes that are constructed on ClaI/EcoRI cassettes. To permit maximum flexibility, the blunt cutting, HpaI, restriction sequence was used as the inside cloning site for the GAL1 promoter.

GAL10 Promoter Sequence Modification

The GAL10 promoter contains a ClaI site for the 5′ end of the cloned gene. Originally, Kurt Jackson had used the last two bases of the ClaI sequence to provide the first two nucleotides of the ATG start codon (Jackson, Recombinant Modulation of the phbCAB Operon Copy Number in Ralstonia eutropha and Modification of the Precursor Selectivity of the Pseudomonas oleovorans Polymerase I. Masters Dissertation. University of Minnesota. St. Paul, Minn., 1998). This system of ClaI/EcoRI cassettes worked well with bacterial systems, but the flanking sequence was not considered optimal for yeast expression systems. Using a consensus sequence derived from the study of highly expressed, native, yeast genes, the ClaI restriction site was shifted down stream of a new start codon (Baim et al., Molec. Cell. Biol. 8(4): 1591-601, 1988; Cigan et al., Gene 59: 1-18, 1987; Hamilton et al., Nucl. Acids Res. 15(8): 3581-3593, 1987). The new start codon was created so the 5′ sequence conformed to the consensus sequence reported by Cigan and Hamilton, id. This configuration provides the modified GAL10 promoter with its own built in start codon and results in the addition of three amino acids (Met-Arg-Ser) to the N-terminus of the expressed protein. Studies have been performed which examined how altered sequences effected the expression of the gene iso-1-cytochrome in yeast. One such modification was very similar to the alterations made in this construct (Sherman et al., The Molecular Biology of the Yeast Saccharomyces, Metabolism and Gene Expression. Strathern et al., Eds.:301-333. Cold Spring Harbor Laboratory, Cold Spring Harbor, N.Y., 1982).

The ClaI restriction site found in the GAL10 promoter is subject to methylation. It is necessary to isolate the plasmid from a methylase negative strain of E. coli when working with this site.

The GAL1 promoter design contains an mRNA start site but does not contain a start codon. Genes inserted into the HpaI blunt restriction site must contain their own ATG sequence. S. cerevisiae gene expression is very flexible to varying distance between the mRNA start site and the start codon. Genes have been described which have anywhere from 11 to 591 nucleotides separating the two sites (Cigan et al., Gene 59: 1-18, 1987; Hamilton et al., N.A.R. 15(8): 3581-3593, 1987). Therefore the 5′ region of the GAL1 cloned gene does not need to conform to restrictive length requirements.

Construction of a GAL1-10 Cloning Vector

The divergent GAL1-10 promoter used in this system was obtained using PCR from plasmid pRS169 (Sikorski et al., Genetics 122: 19-27, 1989). The primers were based on the sequence given by Johnston and Davis (Molec. Cell. Biol., 4(8): 1440-1448, 1984). Primer sequences were as follows: 5′-GAAGTGAATTCACTTTGTAACATCGATCTCATTTTT ATTGAATT-3′ (SEQ ID NO:1) and 5′-CCGGTACAATTCGGGTCGAC GTTAACTCTC CTT-3′ (SEQ ID NO:2). The first primer introduces the EcoRI and the ClaI restriction sites and the second primer introduces the SalI and the HpaI restriction sites respectively. The ˜700 bp PCR product was digested with SalI and EcoRI and ligated into a similarly cut pRS306 (Sikorski et al., Genetics 122: 19-27, 1989) yielding the plasmid pDP306, which contains the divergent GAL1-10 promoter in the multi-cloning site. The “DP” designation refers to the presence of the “divergent promoter.” This ligation placed the GAL1-10 promoter in the pBLUESCRIPT (Stratagene, La Jolla, Calif.) multicloning site of vector pRS306.

Next a high copy number yeast vector was constructed. The yeast 2 μm origin of replication was isolated as a 2.2 kb EcoRI fragment from pLGSD5 (Guarente et al, Proc. Natl. Acad. Sci. USA 79: 7410-7414, 1982) and the fragment's ends were rendered blunt with Klenow DNA polymerase. The insert was ligated into pBLUESCRIPT (Stratagene, La Jolla, Calif.) which had been digested with XhoI and rendered blunt with Klenow DNA polymerase. The blunt end ligation destroyed the EcoRI sites flanking the 2 μm origin sequence. The 2 μm origin was then cut out of the pBLUESCRIPT multicloning site using KpnI and EcoRI. This fragment was ligated into pRS306 which was prepared by digestion with KpnI and EcoRI. The resulting plasmid was named p2RS306. The URA3 transcription termination sequence was cut out of pRS169 (Sikorski et al., Genetics 122: 19-27, 1989) using SstI and EcoRI and introduced into the p2RS306 multicloning site creating p2RS306T. Plasmid p2RS306T contains the 2 μm high copy number origin of replication and the URA3 transcription termination sequence. The “2” and “T” designation refers to the presence of the “2 μm origin of replication” and the “URA3 transcription termination sequence,” respectively.

In addition to providing an origin of replication, the 2 μm sequence also provides a termination sequence for the gene in the GAL1 cloning slot (Hitzeman et al., Science 219: 620-625, 1983).

There is a unique AgeI restriction site within the GAL1-10 UAS which permits the convenient cloning of gene fragments. For example, an EcoRI/AgeI digest can be used to transfer a gene fragment from the GAL10 slot of one plasmid to another vector. Such a strategy avoids the use of the methylation-sensitive ClaI site.

Plasmids pDP306 and p2RS306T allow a great deal of flexibility when cloning genes into the two GAL1-10 promoter slots. For instance, the 2 μm origin sequence contains numerous restrictions sites like HpaI which complicates the cloning of genes from the GAL1 promoter. By using the HpaI site in pDP306 to first clone the gene, it is possible to transfer the gene cassette on a SalI/AgeI fragment to p2RS306T thus avoiding the complications of nonunique restriction sites.

High Copy Number GFP Reporter Plasmids

A series of GFP reporter plasmids were created to help follow gene expression from the modified GAL1-10. The first construct was designed to confirm divergent nature of the modified promoter.

Because the ClaI restriction site is susceptible to methylation, pDP306 was used to transform methylase negative E. coli strain GM34. The plasmid isolated from these cells was digested with ClaI and EcoRI. Green fluorescence protein (GFP) FM2 mutant (Cormack et al., Gene 173: 33-38, 1996) was cut out of plasmid pGSF100 (Leaf, Engineering Yeast for PHB Production. Ph.D. Dissertation. University of Minnesota. St. Paul, Minn., 1998) using a ClaI/EcoRI digest. The isolated ˜700 bp fragment was ligated into the GAL10 gene slot of a similarly cut pDP306 vector creating pDP306 GFP.

The ˜700 bp Ralstonia eutropha PHB reductase gene was cut from pPT520 (Jackson, Recombinant Modulation of the phbCAB Operon Copy Number in Ralstonia eutropha and Modification of the Precursor Selectivity of the Pseudomonas oleovorans Polymerase I. Masters Dissertation. University of Minnesota. St. Paul, Minn., 1998) with a ClaI/EcoRI digest and its sticky ends were rendered blunt with Klenow DNA polymerase. The blunt insert was ligated into pDP306 which had been digested with the blunt cutting enzyme HpaI in the presence of calf intestinal phosphatase (CIP). Proper insert orientation was checked by digesting the resulting vectors with HincII and running the resulting fragments on a 0.7% agarose gel. The construct was named pDP306 RED.

The SalI/EcoRI cassette from pDP306 GFP which contained the GAL1-10 promoter and the GFP gene was then ligated into the vector p2RS306T which had been prepared with a SalI/EcoRI digest. The resulting plasmid was named p2DPT GFP. Plasmid p2DPT GFP is a high copy number S. cerevisiae vector containing the GFP gene regulated by the GAL 10 promoter.

The reductase gene was cloned into p2DPT GFP using an AgeI/SalI digest. By using the unique AgeI site found in the GAL1-10 promoter, it was possible to avoid working with the ClaI restriction site. The construct containing the PHB reductase gene and the GFP gene was named p2DPT RG with “R” representing the reductase gene and “G” representing the GFP gene. The reductase gene was under regulation of the GAL1 promoter and was therefore listed first, while the GFP gene was under control of the GAL10 promoter and was listed second.

A number of other reporter plasmids were created which had different GFP configurations. The plasmid p2DPT GFP could be used to assay the GAL10 promoter. A new plasmid was created which expressed GFP from the GAL1 promoter. This was done by cutting the GFP gene cassette out of GSF100 (Leaf, Engineering Yeast for PHB Production. Ph.D. Dissertation. University of Minnesota. St. Paul, Minn., 1998) with ClaI and EcoRI. The isolated ˜700 bp fragment was rendered blunt with Klenow DNA polymerase and ligated into pDP306 which was prepared with an HpaI digestion in the presence of CIP. The E. coli colonies resulting from the transformation were examined with UV microscopy. Since the GAL1-10 promoter allows low level expression in E. coli, it was possible to visually determine proper gene orientation. The plasmid DNA extracted from a green E. coli culture was used in subsequent steps. This plasmid was named pDP GFP(1). pDP GFP(1) was digested with SalI and EcoRI and the ˜1400 bp fragment isolated. The insert was ligated into p2RS306T which was prepared with a SalI/EcoRI digest. The resulting construct was named p2DPT GFP(1). The numerical designation found in the parenthesis represents the side of the promoter on which the gene is located (GAL1). Such labeling is necessary because constructs exist which have GFP located on either side of the promoter.

A plasmid containing two copies of the GFP gene was created by digesting p2DPT GFP(1) with SalI and AgeI. The isolated fragment containing the GFP gene was ligated into a similarly digested p2DPT GFP which contained the GFP gene under the GAL10 promoter. The resulting plasmid contained two copies of the GFP gene. One copy was regulated by the GAL1 promoter and the other copy was regulated by the GAL10 promoter. The plasmid was named p2DPT GG.

High Copy Number Plasmids Expressing PHB Pathway Genes

A series of plasmids were created which co-regulated bacterial genes from the R. eutropha PHB pathway. The first plasmid was created by using a ClaI/EcoRI digest to isolate the R. eutropha PHB synthase gene from pPT500 (Jackson, Recombinant Modulation of the phbCAB Operon Copy Number in Ralstonia eutropha and Modification of the Precursor Selectivity of the Pseudomonas oleovorans Polymerase I. Masters Dissertation. University of Minnesota. St. Paul, Minn., 1998). The ˜1700 bp gene fragment was ligated into a ClaI/EcoRI digested pDP306 (plasmid was isolated from methylase negative E. coli strain GM34) creating pDP306 SYN. Because of problems associated with the ClaI site, the synthase gene was isolated from pDP306 SYN with a partial digest using AgeI and EcoRI. The appropriate ˜2000 bp AgeI/EcoRi fragment was ligated into the GAL10 gene slot of p2DPT RG which was prepared with an AgeI/EcoRI restriction digest. Confirmation of the proper partial digest fragment was made using a NotI digest. Constructs containing the incorrect synthase fragment would not have a NotI restriction site. This constructed was named p2DPT RS (“R” for reductase and “S” for synthase).

A control plasmid was constructed which contained only the PHB synthase gene. pDP SYN was partially digested with AgeI and EcoRI and the ˜2000 bp fragment harboring the synthase gene was isolated and ligated into p2RS306T which was prepared with an AgeI/EcoRI digest. Proper partial digest fragment was determined as described in the construction of p2DPT RS using a NotI digestion. With this construct, the GAL1 gene slot was left empty. The plasmid was named p2DPT S (“S” for synthase).

The GAL10 promoter adds three additional amino acids (Met-Arg-Ser) to the amino terminus of the synthase gene. These additions are not believed to effect the activity of the PHB synthase enzyme. Slight modifications of the amino terminus of the synthase enzyme appears to be little effect on the protein. In fact, a truncated version of the synthase genes was used to initially produce PHB in S. cerevisiae (Leaf et al., Microbiol. 142, 1169-1180, 1996). In addition, a GFP-PHB synthase fusion protein was also created which retained some synthase activity even though the 250 amino acid GFP protein was attached to its amino terminus (Leaf, Engineering Yeast for PHB Production. Ph.D. Dissertation. University of Minnesota. St. Paul, Minn., 1998).

Confirmation of Proper Promoter Functionality

After designing the modified GAL1-10 promoter and constructing the high copy number expression system, it was necessary to assay the constructs for proper activity. The plasmids p2DPT RG and p2DPT GFP were used to test the expression system.

Cultures of Saccharomyces cerevisiae strain D603 that had been transformed with one of the experimental plasmids were grown in shake flasks on enriched SD media. The specificity of promoter induction was determined by growing the cultures on either 2% (wt/v) glucose or 2% (wt/v) galactose. E. coli strain MC1061 expressing the PHB operon from pPT500 (Jackson, Recombinant Modulation of the phbCAB Operon Copy Number in Ralstonia eutropha and Modification of the Precursor Selectivity of the Pseudomonas oleovorans Polymerase I. Masters Dissertation. University of Minnesota. St. Paul, Minn., 1998) was used as a positive control for the reductase enzyme.

Expression of GFP was determined using ultraviolet microscopy. Reductase enzyme activity was assayed as described in Example 2.

Results

In the presence of galactose, the yeast cells were green, suggesting the expression of GFP. The cells grown on glucose showed only background levels of fluorescence under UV illumination. Typical background fluorescence was yellowish while the presence of GFP made the cells appear a “day-glow” green.

Strain p2DPT RG grown in the presence of galactose showed elevated reductase levels while the same strain grown on only glucose did not show more than background levels. Strain p2DPT GFP which expressed only GFP did not show elevated reductase levels when grown on galactose however, strain p2DPT GFP was green under UV light. The positive control bacterial strain was positive for reductase activity and was not green under UV light.

In addition to showing proper gene regulation, the results also show suggest the basic plasmid backbone was working as designed. The 2 μm origin of replication appeared to function properly. When GFP expressing cultures were examined under the UV microscope, at least 80% of the cells were green. Such an observation suggested the presence of the plasmid in at least 80% of the culture.

The experimental yeast strains were grown in a media that lacked the nucleotide uracil. Since strain D603 is unable to synthesize uracil, the plasmid selection marker appeared to function properly.

DNA cloning work was performed in E. coli strain DH5α is normally sensitive to the antibiotic ampicillin. Cells transformed with the described shuttle vectors were able to grow on media containing ampicillin. In addition to being able to grow in the presence of ampicillin, the fact that daughter cells possessed the recombinant plasmid suggests that the E. coli origin of replication was operating normally.

### Example 4

### Expression of PHB Pathway in Yeast

It has been previously shown that S. cerevisiae accumulates small amounts of PHB when the PHB synthase gene is expressed (Leaf et al., Microbiol. 142, 1169-1180, 1996; Leaf, “Engineering Yeast for PHB Production”, Ph.D. Dissertation, University of Minnesota, 1998. Transformation of S. cerevisiae with a bacterial polyhydroxybutyrate (PHB) polymerase caused accumulation of PHB of up to 0.5% of cell dry weight, indicating that S. cerevisiae is natively capable of synthesizing the correct stereochemical precursor molecule.

To improve biopolymer production, a series of plasmids was constructed to express combinations of the reductase, β-ketothiolase, and polymerase enzymes. The co-expression of PHB reductase and PHB synthase genes significantly increased PHB accumulation. When the polymerase and reductase enzymes were co-expressed, the PHB levels increased to approximately 2.5% of the cell dry weight. When polymerase, reductase, and β-ketothiolase were all expressed, the average PHB levels increased to 10% of the cell dry weight. Significant heterogeneity was observed, with some cells accumulating PHB in excess of 50% of their cell dry weight while others cells accumulated no polymer.

Plasmid Construction

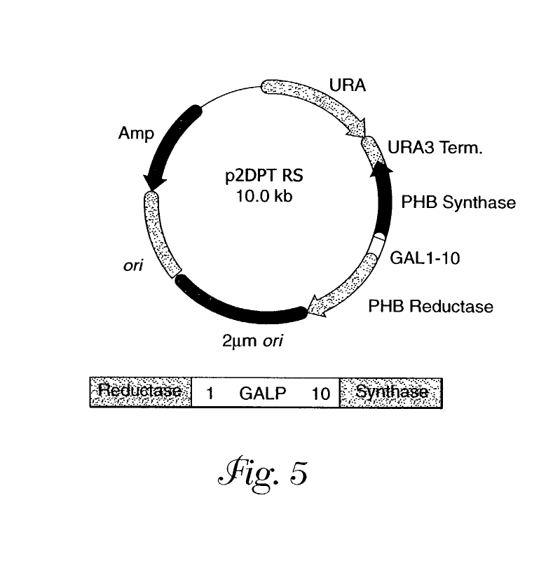

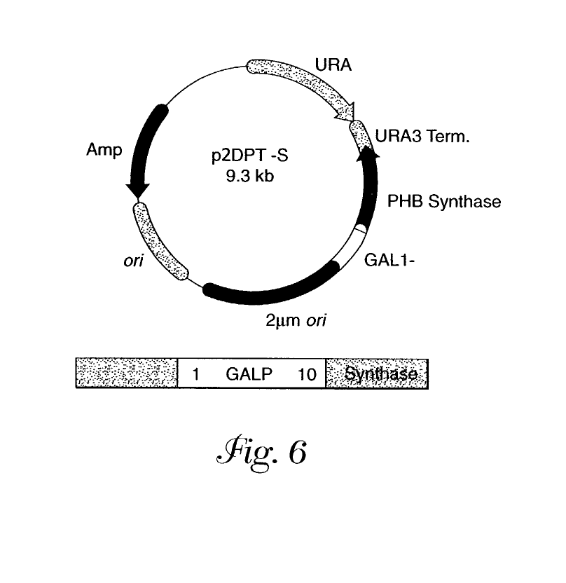

The construction of plasmids p2DPT RS (“R” for reductase, “S” for synthase) and p2DPT-S (“S” for synthase) is described in Example 4 (FIGS. 5 and 6). Both plasmids possess the high copy number 2 μm origin of replication and both plasmids use a modified version of the divergent GAL1-10 promoter to regulate gene expression.

The R. eutropha β-ketothiolase gene was isolated from the R. eutropha PHB operon using PCR. Plasmid pAet41 that contains the native PHB operon was used as the template (Peoples et al., J. Biol. Chem. 264(26):15293-15297, 1989, and J. Biol. Chem. 264(26): 15298-15303, 1989). The PCR primers ATTATCGATGACTGACGTTGTCATCGTATC (SEQ ID NO:3) and TAAGAATTCTTATTTGCGCTCGACTGCCAG (SEQ ID NO:4) contained a 5′ ClaI restriction site and a 3′ EcoRI restriction site respectively to simplify cloning with existing expression systems. PCR was performed using pfu DNA polymerase (Stratagene) and a Perkin-Elmer PCR thermocycler (27 cycles; melt 95° C. for 45 seconds, anneal 63° C. for 45 seconds, extension 72° C. for 160 seconds). The PCR mixture contained two drops of mineral oil even though the Perkin-Elmer thermocycler had a heated lid. The temperature profile did not work without the mineral oil.

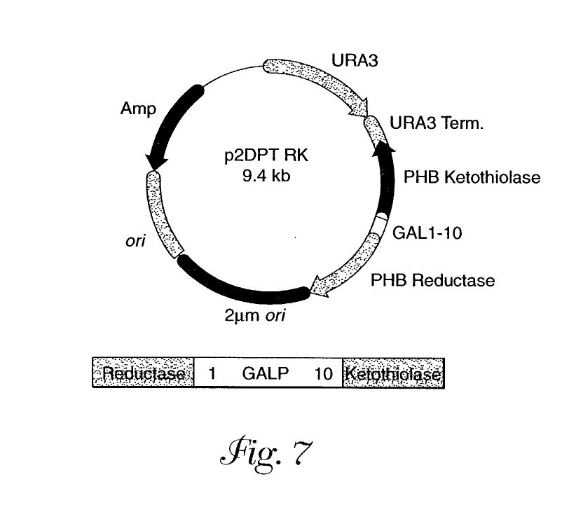

The isolated gene fragment was ligated into plasmid pDP306 using the ClaI and EcoRI restriction sites. The plasmid was named pDP K (“K” for ketothiolase). The ketothiolase gene was isolated from pDP K using an AgeI/EcoRI digest and was ligated into a similarly digested p2DPT RS. The resulting plasmid was named p2DPT RK. It contained the 2 μm origin of replication, the GAL1-10 divergent promoter, the URA3 termination sequence, the PHB reductase gene (regulated by GAL1) and the PHB β-ketothiolase gene (regulated by GAL1)). Plasmid p2DPT RK utilizes the URA3 selection marker (FIG. 7).

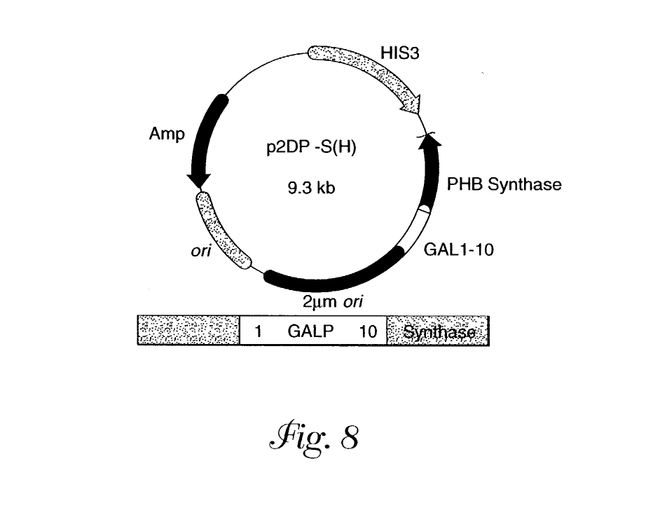

In order to express all three PHB genes in a single host, a new PHB synthase containing plasmid was constructed. Plasmid p2DPT-S was digested with ApaI and EcoRI. The cassette containing the 2 μm ori, the GAL1-10 promoter, and the PHB synthase gene, was ligated into a similarly digested pRS303 (Sikorski et al., Genetics 122: 19-27, 1989). The resulting plasmid which uses a HIS3 selection marker was named p2DP-S(H). Because of cloning restraints, the GAL10 cloning slot in p2DP-S(H) is not flanked by the URA3 termination sequence (FIG. 8).

Co-expression of the PHB Synthase and the PHB Reductase Genes

Being able to co-regulate two genes from a multi-step pathway is one useful application of the divergent promoter system. The constructed GAL1-10 system's ability to facilitate pathway engineering was tested by expressing two genes from the three step R. eutropha PHB pathway. As noted above, previous reports have shown that S. cerevisiae cultures expressing only the PHB synthase gene were capable of producing small amounts of PHB when grown on galactose (Leaf et al., Microbiol. 142, 1169-1180, 1996). In such cases, the polymer precursors were supplied by native yeast genes. It was believed that the production of PHB in this system was limited by the availability of precursors like 3-hydroxybutryal-CoA. To increase levels of 3-hydroxybutyryl-CoA, the PHB reductase enzyme was expressed along with the PHB synthase gene on a high copy number yeast vector which utilized the divergent GAL1-10 promoter. Shake flask studies and a bioreactor experiment were used to evaluate the effect of co-expression of these two genes.

Shake Flask Study: p2DPTRS (Strain RS) and p2DPTS (Strain S)

A shake flask study was used to determine whether co-expressing both the synthase and the reductase genes resulted in higher levels of PHB accumulation. The enriched SD media used to culture the cells initially contained 2% (wt/v) glucose and 2% (wt/v) galactose. Culture samples were taken after 21.5, 46.75, and 68.5 hours.

The following experimental strains were used in this study:

p2DPT RS: high copy number plasmid containing both the PHB reductase and the PHB synthase genes regulated by the GAL1-10 promoter

p2DPT S: high copy number plasmid containing only the PHB synthase gene regulated by the GAL10 promoter

pTL85: high copy number plasmid containing the truncated PHB synthase gene regulated by the hybrid GAL10/CYC1 promoter (Leaf et al., Microbiol. 142, 1169-1180, 1996)

Wild-Type (WT): S. cerevisiae strain D603, grown on enriched SD media supplemented with 40 mg/L uracil

The PHB content and biomass concentration were assayed as described in Example 2.

Results of the Shake Flask Study

Co-expression of both the PHB synthase and the PHB reductase genes resulted in a significant increase in PHB accumulation. After 68.5 hours, strain p2DPT RS produced roughly 15 mg PHB/g cell dry weight (CDW). The yeast strains containing only the synthase gene (p2DPT S and pTL85) had levels of PHB that were comparable to background levels found in wild-type cultures (ca. 0.3 mg PHB/g CDW).

The samples taken at 21.5 hours were from late exponential growth phase cells. Polymer accumulation for strain p2DPT RS appears to have begun during exponential growth phase. At 21.5 hours, the cells show a PHB content of about 1.6 mg PHB/g CDW while the other strains had approximately 0.3 mg PHB/g CDW. By 46.75 hours, the PHB levels in strain p2DPT RS increased to approximately 7 mg PHB/g CDW and by 68.5 hours, the cells contained about 15 mg PHB/g CDW. The most significant increase in PHB occurred between the last two samplings. During this 21.75 hour interval, the specific PHB production rate was 0.3492 mg PHB/g CDW/hr. The PHB signal from the other experimental strains remained fairly constant during the course of the experiment. The specific PHB content and the specific PHB production rates suggest when grown on glucose and galactose, the synthase only strains did not produce a significant amount of PHB, Table 2.

TABLE 2
Specific PHB synthesis rates for S. cerevisiae D603 cultures grown on
enriched SD media which initially contained 2% glucose and
2% galactose. The first column is the average rate between
21.5 hours and 46.75 hours and the second column is the average rate
between 46.75 hours and 68.5 hours.

| Strain | Specific PHB Synthesis Rate (mg PHB/hr/g CDW) | |
|---|---|---|
| p2DPT RS | 0.214 | 0.349 |
| p2DPT S | 0.000 | −0.001 |
| pTL85 | 0.001 | 0.002 |
| Wild-Type | 0.000 | −0.003 |

The presented results were from the second of two shake flask experiments. The second experiment was designed to verify the results of the first. The overall trends in growth and PHB accumulation were very similar between the two studies, although the absolute PHB content was a higher for the first experiment (˜24 mg PHB/g CDW). This could be due to a poor PHB calibration curve. During the first experiment, only two samples were taken instead of three like the second experiment. The additional data point gives a better picture of the rate of PHB accumulation, so the second experiment was presented.

Typical final OD₆₀₀ values for the transgenic strains grown on enriched SD media with 2% (wt/v) glucose and galactose were 18 to 21. The wild-type cells reached an OD600 of approximately 24. Culture biomass concentrations were around 2.1 g/L for transgenic strains and 2.5 g/L for the wild-type cultures.

Discussion

When grown on glucose and galactose, accumulation of PHB in S. cerevisiae expressing only the synthase gene is likely limited by the availability of precursor. A marked increase in polymer accumulation was observed when the reductase gene was co-expressed with the synthase gene. Expression of the reductase gene probably increased the levels of precursor permitting additional carbon to be shifted to polymer formation. Previously published data (Leaf et al., Microbiol. 142, 1169-1180, 1996) demonstrated that only the synthase gene was necessary for the production of PHB in S. cerevisiae grown on galactose. However, when grown on a combination of glucose and galactose, these same cultures produced only wild type levels of polymer. It appears glucose can negatively affect the formation of PHB precursors. The addition of glucose may have repressed the native genes involved in the production of PHB when the cells were grown solely on galactose. Leaf et al. (Microbiol. 142, 1169-1180, 1996) propose that PHB precursors could be produced by the β-oxidation pathway. However, glucose often represses genes involved in the metabolism of non-glucose carbon sources like fatty acids so, the genes from the yeast β-oxidation pathway, like the FOX2 gene, may have been repressed by glucose.

Due to a contamination problem, the second experiment did not have data from strain p2DPT RG. p2DPT RG is a high copy number plasmid which uses the GAL 1-10 promoter to regulate both the PHB reductase and the GFP genes. This control plasmid helps distinguish the difference between increased monomer levels and increased polymer levels. The assay used to quantify PHB esterifies the polymer so it is not capable of distinguishing between monomer and polymer. Under the reaction conditions, both intact polymer and free monomer would form the same ester. Results from the p2DPT RG cultures support the claim that the increased PHB levels are due to increased polymer and not increased monomer. The first shake flask study showed that strain p2DPT RG had levels of PHB that were very similar to the wild type cells. The presence of the reductase enzyme did not significantly change the levels of monomer detected by the PHB assay. It is therefore believed that the PHB detected in strain p2DPT RS was from intact polymer.

PHB Gene Dosage Effect

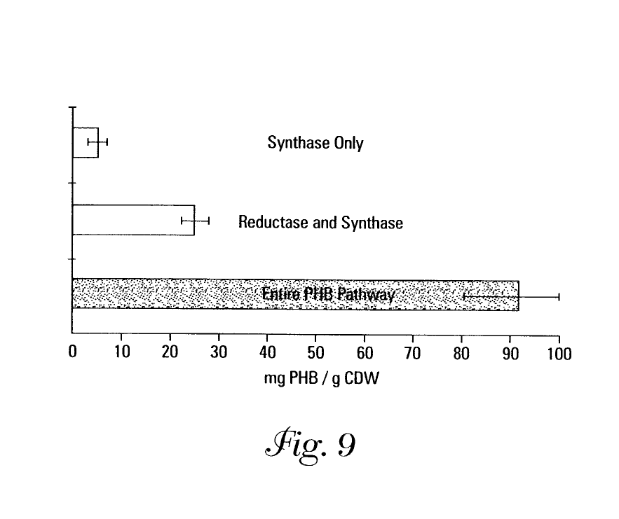

Recombinant S. cerevisiae accumulates low levels of PHB when the PHB synthase gene is expressed indicating the organism natively expresses genes involved in the production of the PHB precursor D-3-hydroxybutyryl-CoA (Leaf et al., Microbiol. 142, 1169-1180, 1996). To address the effect of gene dosage on PHB accumulation, different combinations of the three PHB genes were expressed. When PHB reductase and PHB synthase were co-expressed (plasmid p2DPT RS), PHB accumulation increased seven fold over synthase only levels (plasmid p2DPT-S). When all three PHB genes were expressed (plasmids p2DPT RK and p2DP-S(H)), PHB accumulation increased eighteen fold over the synthase only strain (plasmid p2DPT-S) (FIG. 9).

The increase in PHB is believed due to the nature of the precursor pools. Cells typically have a variety of regulatory mechanisms that attempt to maintain homeostasis. The precursor for the synthase-only system is β-3-hydroxybutyric acid which is not part of S. cerevisiae's central metabolism. The mechanisms available to regulate the intracellular concentration of this metabolite are probably not capable of handling large perturbations that may explain the low levels of PHB. When all three PHB genes are expressed, the precursor for biopolymer production is the primary metabolite acetyl-CoA. Because of its central metabolic role, the regulatory mechanisms that buffer the cytosolic acetyl-CoA concentration are probably better able to handle perturbations. Cytosolic acetyl-CoA can be produced from a number of sources including acetate and ethanol. As acetyl-CoA is drawn off for PHB production, flux through these pathways could increase in order to maintain a desirable intracellular concentration.

Bioreactor Experiments: Strain RS and RKS

Bioreactor experiments were performed to better characterize the kinetics involved in PHB production. Strain RS containing p2DPT RS and strain RKS containing p2DPT RK and p2DP-S(H) were cultured in a 5 liter B. Braun reactor to study batch growth kinetics. The culture media used 1% glucose and 1% galactose as the carbon and energy sources. The mixture of the two fermentable sugars permitted rapid growth and high levels of expression from the divergent GAL1-10 promoter. Strain RS was grown under uracil selection while strain RKS was grown under both uracil and histidine selection (see above for media composition and reactor operating conditions).

The ethanol concentrations shown below were not corrected for evaporation. Published accounts suggest significant ethanol loss occurs due to sparging (Nissen et al., Microbiol. 143: 203-218, 1997).

Results: Strain RS

Strain RS grew exponentially with a maximum specific growth rate of 0.243 hr⁻¹ for approximately 20 hours before entering a slow growth phase. The end of the exponential growth phase closely coincided with the depletion of glucose. During the three days of slow growth, the cell dry weight doubled once with the final cell density reaching 3.58 g/L. Glucose was preferentially consumed. Galactose was not metabolized until the glucose was exhausted. The cells did not enter a second exponential growth phase while metabolizing galactose that suggests a required media component was depleted. The ethanol levels increased until both sugars were depleted. At this point, the ethanol levels decreased likely due to diauxic growth and evaporation. PHB production corresponds with the culture entering the slow growth phase, which also coincides with glucose exhaustion. The specific PHB levels increased linearly for about twenty hours with a maximum specific production rate of 1.184 mg PHB/g residual biomass/hr and a maximum volumetric rate of 2.785 mg PHB/L. During this time, galactose was exhausted but the linear accumulation of PHB continued unperturbed for another ten hours. The specific PHB content reached approximately 38 mg PHB/g biomass. The plasmid stability was approximately 82% at the beginning of the PHB accumulation phase and fell to approximately 57% at the end of four days.

The dissolved oxygen (DO) profile displayed features that coincide with culturing events. First the DO dropped sharply as glucose was consumed. Upon depletion of glucose, the DO rose before once again decreasing as the cultures shifts to galactose. When the galactose was exhausted, the DO dropped again likely due to oxidation of ethanol. The DO continues to decrease until about hour 45 when it slowly starts increasing. The linear phase of PHB accumulation ended at about the same time.

The product yields and a summary of the rates are shown in Table 3. The product yields were based the three culture phases described below.

TABLE 3
Summary of bioreactor yields and rates. The various parameters
were calculated from two different recombinant S. cerevisiae cultures
containing either the PHB reductase and synthase genes (RS) or the PHB
β-ketothiolase, reductase, and synthase genes (RKS). Strain RKS was
grown with a controlled pH of 4.5 and without pH control. glc = glucose;
EtOH = ethanol; gal = galactose; N.D. = not determined.

| | Yields | | | |
|---|---|---|---|---|
| | g biomass/ | g EtOH/ | g PHB/ | Final Biomass |
| Strain | g glc | g gal | g EtOH | (g/L) |
| RKS | 0.151 | 0.296 | 0.051 | 3.59 |
| (pH control) | | | | |
| RKS | 0.146 | N.D. | 0.041 | 2.67 |
| (no pH control) | | | | |
| RS | 0.161 | 0.259 | 0.033 | 3.58 |

| | Rates | | |
|---|---|---|---|
| | Specific | Specific | |
| | Growth | PHB RATE | Volumetric |
| | Rate | (mg/PHB/g residual | PHB Rate |
| Strain | (hr⁻¹) | biomass/hr) | (mg PHB/L/hr) |
| RKS | 0.186 | 2.446 | 4.270 |
| (pH control) | | | |
| RKS | 0.165 | 1.829 | 3.011 |
| (no pH control) | | | |
| RS | 0.243 | 1.184 | 2.785 |

During first bioreactor experiment with strain RKS, the pH was not controlled. This was done to replicate as closely as possible the conditions of earlier strain RKS shake flask studies. Strain RKS was grown under uracil and histidine selection to maintain the two plasmids.

The exponential growth phase with a maximum specific growth rate of 0.1655 hr⁻¹ lasted approximately twenty hours. As with the previous examples, this coincided with the depletion of glucose. Due to low pH, the culture biomass only reached 2.67 g/L with one doubling occurring during the slow growth phase. Again, glucose was preferentially metabolized, however the low pH seemed to inhibit the total utilization of galactose. The galactose levels were fairly stable at 2 g/L from hour 60 until the end of the experiment. The ethanol concentration peaked at about hour thirty which was after glucose exhaustion but before galactose reached its minimum. PHB production began around hour twenty and the specific content increased linearly with a maximum specific rate of 1.829 mg PHB/g residual biomass/hr and a maximum volumetric rate of 3.011 mg PHB/L for around forty hours. The specific PHB content reached approximately 70 mg PHB/g biomass. The pH quickly dropped as the glucose was metabolized and slowly leveled off after it was exhausted. Metabolism of galactose did not cause a significant drop in the culture pH probably due to some media buffering capacity at the lower pH. The final pH was about 2.6. The plasmid stability was approximately 66% at the beginning of the PHB accumulation phase and fell to 45% after four days.

The DO rapidly dropped as glucose was metabolized. Upon exhaustion of glucose, the DO increased briefly before once again decreasing as the galactose was consumed. The distinction between metabolism of galactose and ethanol was not clear in the DO profile. DO probe drifting obscured the final portions of the profile.

Product yields and a summary of the rates are shown in Table 3, above.

Results: Strain RKS, pH Control

The second bioreactor experiment with strain RKS was identical to the previous experiment except the pH was controlled at 4.5.

The observed growth trends were similar to the two previous examples. The culture grew exponentially for approximately twenty hours with a maximum specific growth rate of 0.186 hr⁻¹ that is slightly higher than the uncontrolled pH experiment. The final cell density was 3.59 g/L with the final doubling occurring during the slow growth phase. The glucose and galactose concentration profiles were very similar to the pH controlled experiment performed with strain RS. Glucose was preferentially metabolized and depleted after twenty hours of growth. Galactose was exhausted by hour thirty. Ethanol concentration increased until the galactose was exhausted and then decreased likely due to diauxic growth and evaporation. PHB accumulation began as the culture switched to a slow growth phase that coincided with glucose depletion. The specific PHB content increased linearly for approximately twenty five hours with a maximum specific rate of 2.446 mg PHB/g residual biomass/hr and a maximum volumetric rate of 4.27 mg PHB1/hr. During this time interval, galactose was exhausted but the linear accumulation of PHB continued unperturbed for another ten hours. The specific PHB content reached approximately 75 mg PHB/g biomass. The plasmid stability was approximately 70% at the beginning of PHB accumulation phase and fell to 45% at the end of four days.

The product yields and a summary of the yields are given in Table 3, above.

Cells from the bioreactor experiment were stained with nile red and visualized using fluorescent microscopy. The staining showed a significant heterogeneity in the population's PHB content. Some cell's appeared to contain about 60% PHB by mass while a significant fraction had no PHB. The heterogeneity is likely due to plasmid instability and varying plasmid copy number.

Discussion

The cultures seem to go through four distinct phases. During the first phase, the cultures grow exponentially on glucose. When glucose is exhausted, the cultures enter second phase characterized by utilization of galactose, slowed growth, the start of PHB production, and increasing ethanol levels. The third stage starts after galactose is exhausted. This phase involves decreasing levels of ethanol, little growth, and continued PHB accumulation. The fourth phase begins with the slowing of PHB accumulation and lasts until the end of the experiment. Events during these phases like the depletion of glucose seem to correspond to certain trends in the DO profiles. The yields from Table 3 were calculated from different phases. Biomass yield from glucose was determined during phase one. Ethanol yield from galactose was determined during phase two and PHB yield from ethanol was determined from phase three. The ethanol yield from strain RKS with no pH control was not clear due coinciding decreases in galactose and ethanol. pH had a significant effect on final biomass levels. When grown without pH control, the RKS cultures reached a density of 2.67 g/L. When grown on the same media with a controlled pH, the RKS cultures reached a cell density of 3.59 g/L. The low pH also seems to have inhibited the total utilization of galactose. About 2 g/L of galactose remained in the uncontrolled pH experiment while it was totally consumed in the controlled pH experiments. The low pH may also have played a role in the lowered biomass yields by requiring more maintenance energy. The low pH likely had a negative effect on cell viability. The final specific PHB content was not significantly affected by the pH differences, both RKS cultures produced about 70 mg PHB/g biomass. The specific rates did show a difference with the controlled pH cultures having a 40% higher rate. The difference in rates was off set by a longer pH accumulation phase in the uncontrolled pH cultures.

The initial specific PHB content in a couple of the plots started at an elevated level, dropped, and then increased again. The initially high specific PHB content was from the day old cultures used to inoculate reactors. As the cells divided, the initial PHB was diluted among the new daughter cells causing the population averaged, specific content to decrease. When the cultures started producing PHB again, the specific content increased.

The specific PHB production rates for S. cerevisiae expressing all three R. eutropha genes from two autonomous plasmids is about 2.446 mg PHB/g residual biomass/hr. A typical PHB production rate for R. eutropha metabolizing fructose is 33 mg PHB/g residual biomass/hr (Kelley et al., International Journal of Biological Macromolecules 25(1-3): 61-67, 1999). When the S. cerevisiae rate is adjusted for a plasmid stability of 70%, the rate increases to 3.494 mg PHB/g residual biomass/hr which is roughly ten percent of R. eutropha's rate.

When plasmid stability is factored into the specific PHB production rates, the difference between strain RS and RKS is magnified. As mentioned previously, when the specific rate for strain RKS is adjusted for the 70% plasmid stability the rate increases to 3.494 mg PHB/g residual biomass/hr. Adjusting strain RS's specific rate for an 82% plasmid stability, its rate increases to 1.44 mg PHB/g residual biomass/hr. Strain RKS was a specific rate that is approximately 2.1 times faster than strain RS.

The observed decrease in ethanol concentrations is likely due to both metabolism and evaporation. Since there is little growth after hour twenty, the majority of the decrease is likely due to evaporation. All three experiments show nearly identical rates of ethanol decrease: 0.083, 0.082,and 0.086 g ethanol/L/hr for RS, RKS (no pH control) and RKS (pH control) respectively. During steady state cultivation of S. cerevisiae with a sparge rate of 1 vessel volume per minute (VVM), Nissen et al. (Microbiol. 143: 203-218, 1997) lost up to 10% of the available ethanol to evaporation.

The biomass yields from glucose are highest with strain RS followed by strain RKS with pH control. The maintenance of a single plasmid and expression of only two foreign genes likely resulted in a less burdened cell with higher growth efficiency. As mentioned earlier, strain RKS with no pH control probably had a lowered biomass yield because of an increased maintenance energy requirement. With little cell growth taking place during the metabolism of galactose, both RS and RKS (pH control) had very similar ethanol yields. Since the decrease in ethanol is likely due primarily to evaporation, RKS had the highest yield because it produced the most PHB. This yield is likely unrealistic due to evaporation.

### Example 5

### Integrative Plasmid System with Inducible Promoter

To increase gene stability and improve population homogeneity, an integrative system was designed and created. The integration system also frees a selection marker that was previously used to express PHB synthase. The open selection marker can now be used to express other recombinant genes.

Use of the Divergent GAL1-10 Promoter in an Integrative Plasmid System

The divergent promoter (Example 3) was designed for use in an integrative plasmid system as well as an autonomous plasmid system. Integrative plasmids like autonomous plasmids are frequently used to deliver recombinant DNA. However in a recombinant population, an integrated plasmid is represented by a defined copy number while an autonomous plasmid's copy number is represented by a distribution. Having a cell population with a defined gene copy number facilitates the optimization of an expression system. For instance while engineering a multistep pathway, a metabolic flux analysis could determine what gene dosages would give maximal product kinetics. The use of an integrated system would result in the entire cell population operating at an ideal condition unlike an autonomous system where a significant fraction of population would operate at less than ideal conditions.

Integrative plasmids can be targeted for either unique or nonunique sites. Depending on the targeting sequence, one to many copies of the plasmid can be integrated into the host chromosome. A drawback to systems targeted for non-unique sites is the need for characterizing new transformants. Each transformation can result in multiple copies of the gene being integrated so each colony's copy number would need to be determined from a Southern blot. This screening process can be time consuming when a large number of colonies need to be screened. An application of the divergent promoter system offers to simplify this screening process. By introducing a gene of interest along with a reporter gene on a divergent promoter construct, it is possible to assay for the reporter gene in order to determine the integrated gene copy number. In addition to determining gene copy number, it is possible to follow gene expression by following the reporter gene. The system described in this example uses the reporter gene GFP although other reporter genes like β-galactosidase would also work.

Construction of Plasmids

The backbone of the expression system was the integrative plasmid pNAD-FL13 that is targeted for the non-unique δ-sequence (Lee et al., Appl. Microbiol. Biotechnol. 48: 339-345, 1997). In addition to using a nonunique targeting sequence, pNAD-FL13 contains the “URA3 blaster cassette” that permits convenient removal of the URA3 selection marker (Alani et al., Genetics 116: 541-5451987).

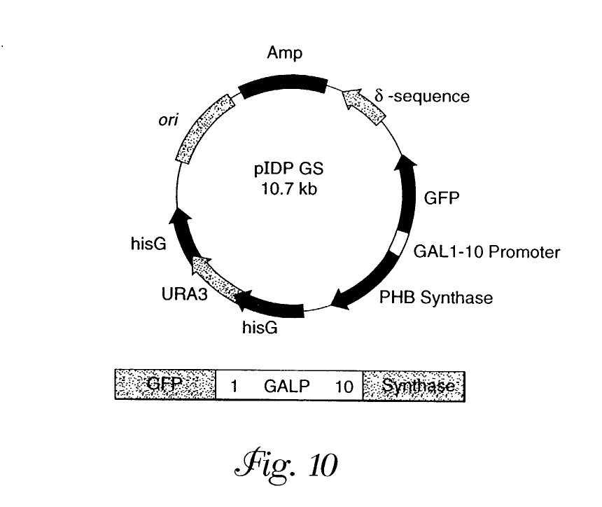

Plasmid p2DPT-S was partially digested with AgeI followed by a full EcoRI digest. The ˜2100 bp fragment containing the synthase gene and a portion of the GAL1-10 promoter was ligated into a AgeI/EcoRI digested p2DPT G(1) (also referred to herein as p2DPT GFP(1)) creating plasmid p2DPT GS. Plasmid p2DPT GS was linearized with a partial SalI digest. The resulting linear plasmid was then digested with EcoRI. The 3100 bp fragment corresponding to the synthase/GAL1-10 promoter/GFP cassette was isolated and ligated into a SalI/EcoRI digested pNAD-FL13. The resulting plasmid was named pIDP GS (integrative divergent promoter GFP synthase) (FIG. 10).

The integrative plasmid pIDT GS expresses green fluorescence protein (GFP) from the GAL1 side of the divergent GAL1-10 promoter and the PHB synthase gene from the GAL 10 side.

Results of PHB Synthase/reporter Gene Cassette

Because the construction entailed partial digests, the GFP/GAL1-10/synthase cassette was first tested in the high copy number plasmid p2DPT GS. The cells were grown on 2% (wt/V) galactose instead of the standard 1% glucose/1% galactose mixture. Cultures expressing only the synthase gene show clearer differentiation from wild-type background then when grown solely on galactose.

The specific PHB levels were found to be significantly higher than the wild-type background levels indicating the synthase gene was functioning properly. The recombinant cultures were also bright green when analyzed with UV microscopy suggesting the GFP gene was expressed.

After determining that the gene cassette was functional, the integrative expression system was tested. The specific PHB content of the three first round transformants, which are believed to contain only a single copy of the integrated plasmid, was slightly higher than the wild-type background signal.

Integration Plasmids

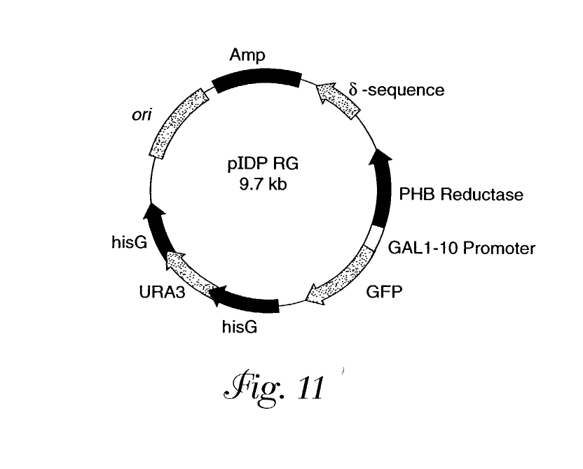

An integrative expression vector was constructed which utilized the divergent GAL1-10 promoter. The PHB reductase/GAL1-10/GFP cassette was cut out of p2DPT RG with a SalI/EcoRI digest. This cassette was then ligated into a similarly digested pNAD-FL13 (Lee et al., Appl. Microbiol. Biotechnol. 48: 339-345, 1997). The resulting plasmid was named pIDP RG (FIG. 11). The “I” designation stands for “integrative” plasmid. Plasmid pIDP RG contains the divergent GAL1-10 promoter, a URA3 blaster cassette and the repeated δ-sequence targeting sequence. The GAL 1-10 promoter regulates the expression of PHB reductase and GFP. Unlike the previous autonomous plasmids (e.g., p2DPT RS and p2DPT S in Example 4) only the GAL1 promoter has a flanking termination sequence. This termination sequence originates from the pNAD-FL13 plasmid.

Approximately 0.5 μg of plasmid DNA was linearized with XhoI, separated from uncut DNA on an agarose gel, and isolated using a Geneclean II kit. The linearized DNA was then used to transform S. cerevisiae D603 as described above. Six recombinant colonies were obtained on uracil deficient SD agar plates.

The δ-sequence targeted plasmids were cured of the URA3 blaster cassette using the protocol described above. Cured cells were capable of growing on plates containing 5-FOA but were unable to grow in the absence of uracil. Uncured cells were unable to grow in the presence of 5-FOA but were able to grow in the absence of uracil.

Gene expression was tested by growing the cells on SD media containing 2% glucose and 2% galactose. When examined with an UV microscope, the cured and uncured cells appeared faintly green suggesting the presence of GFP. There was no significant difference in fluorescence levels between the cured and uncured cells which suggested there were no tandem repeats.

The low levels of fluorescence made it difficult to quantify the GFP levels using a flow cytometer. It is assumed the low fluorescence is the result of only single copy of the gene being integrated into each cell. At this time, the recombinant cultures have not been analyzed for reductase activity.

In the plasmid pIDP RG, GFP is regulated by the GAL10 promoter. Published accounts suggest the S. cerevisiae GAL1 promoter is approximately five stronger than the GAL10 promoter (West et al., Molec. Cell. Biol. 4(11): 2467-2478, 1984). By switching GFP from the GAL10 side of the promoter to the GAL1 side, it should be easier to detect GFP from cells with a low integrated copy number. Although this arrangement could facilitate copy number quantification, it is important to realize the expression of the desired gene would likely be lowered when switched to the other promoter.

Currently, it is believed only a single gene was integrated during transformation. This demonstrates the proper functioning of the constructs but the multiple stable integrations might be possible. At such a time, a correlation will be sought between fluorescence levels and integrated gene copy number.

### Example 6

### Glutamate Dehydrogenase Transhydrogenase System

The recombinant expression of the PHB pathway in S. cerevisiae likely perturbs both the carbon fluxes and the redox balance. Although S. cerevisiae does not natively contain a transhydrogenase system, the organism does express dehydrogenases such as glutamate dehydrogenase and malic enzyme. Overexpression of either of these enzymes is expected to create a transhydrogenase system. A transhydrogenase system based on the glutamate dehydrogenase genes was investigated.

Construction of Plasmid

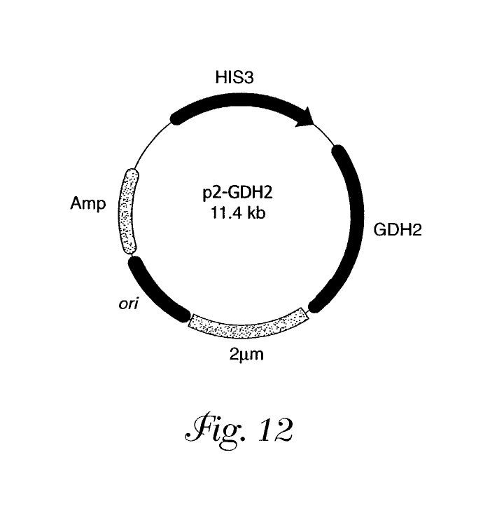

Plasmid pTL92-8 was constructed by ligating the blunt ended EcoRI 2 μm plasmid fragment into plasmid pRS303 (Sikorski et al., Genetics 122: 19-27, 1989) that had been digested with XhoI and was also rendered blunt. The 2 μm ori is oriented with the XbaI site closest to the amp selection marker. The GDH2 gene was excised from the original plasmid (Boles et al., Eur. J. Biochem. 217: 469-477, 1993) with an XbaI/SacI digest. pTL92-8 was linearized with a partial XbaI digest and the recovered DNA was then digested with SacI. The 6.6 kb DNA band corresponding to the correct DNA fragment was then ligated with the GDH2 gene fragment. The resulting plasmid that contains a HIS3 yeast selection marker was named p2-GDH2 (FIG. 12) The GDH2 gene is still regulated by its native promoter and termination sequence (Boles et al., Eur. J. Biochem. 217: 469-477, 1993).

Results of GDH2 Transhydrogenase System

When GDH2 is present on a high copy number plasmid, the native regulation system is over whelmed and the gene is constitutively expressed (Boles et al., Eur. J. Biochem. 217: 469-477, 1993). The other gene involved in the transhydrogenase system, GDH1, is a central enzyme in the utilization of ammonia as a nitrogen source. Under culturing conditions that utilize ammonium sulfate as the nitrogen source, the GDH1 gene would be expressed.

The GDH transhydrogenase system was tested with plasmid p2DPT RS. This particular strain (RS/G) expressed PHB synthase and PHB reductase from a plasmid with a URA3 selection marker (p2DPT RS) and expressed the GDH2 gene from a HIS3 plasmid (p2-GDH2). The control strain maintained plasmids p2DPT RS and pTL92-8 (no GDH2 gene).

The expression of GDH2 along with PHB reductase and synthase resulted in a 50% increase in the final specific PHB content.

Depending on which direction the transhydrogenase system works, NADPH could either be made from NADH or vice versa. Based on the preference of cytosolic aldehyde dehydrogenase for NADP⁺ (Wang et al., J. Bacteriol. 180 (4): 822-830, 1998), the production of acetyl-CoA from ethanol could actually produce an excess of NADPH. In such cases, the increased levels of PHB could be due to the system passing the excess electrons to NADH. Under aerobic, no growth conditions, NADH would be better suited for disposing excess reducing equivalents through oxidative phosphorylation.

### Example 7

### The Effects of Initial Sugar Composition and Concentration on PHB Accumulation

Unlike the shake flask studies described above, strain p2DPT RS did not produce elevated levels of PHB in the bioreactor experiment. A number of parameters like the ammonium sulfate concentration were different between the two experiments so it was difficult to single out a clear explanation for the results. Although each of the differences could have effected PHB accumulation, the different initial glucose concentration was believed to have been a major contributing factor. As discussed above, some carbon sources like glucose are capable of regulating metabolic shifts which may have affected the production of PHB. A couple of experiments were designed to investigate this question. Since the conditions found in the shake flasks were favorable to the production of PHB, the next round of experiments once again focused on shake flask cultures.

Two experiments using strains p2DPT RS and p2DPT S and wild type cells were performed to determine the effect of the initial sugar composition and concentration on PHB accumulation. The first experiment examined three different mixtures of glucose and galactose. The first set, designated the “high glucose” set, initially contained 5% glucose and 1% galactose. This set was designed to have the same initial sugar composition as the bioreactor experiment. The second set or the “medium glucose” set initially contained 2% glucose and 1% galactose and was similar to the shake flask experiments described in Section 4.2. The final set, designated the “Low glucose” set, initially contained 1% glucose and 1% galactose, Table 4.

TABLE 4
Experimental S. cerevisiae D603 strains grown on enriched
SD media with the following initial sugar concentrations.

| | Low | Medium | High |
|---|---|---|---|
| | 1% Glc | 2% Glc | 5% Glc |
| Strain: | 1% Gal | 1% Gal | 1% Gal |
| p2DPT RS | X | X | X |
| p2DPT S | X | X | X |
| Wild Type | | | X |

A second shake flask study was conducted with galactose serving as the inducer and sole carbon source. This experiment was designed to examine the difference between glucose repression and repression due to high concentrations of fermentable sugars (i.e. the Crabtree effect). The initial galactose concentration was varied from 2% to 4% to 6%. All other variables like the initial ammonium sulfate concentration of 5 g/liter were kept constant between the two shake flask studies.

The production of PHB, ethanol, and biomass as well as consumption of glucose and galactose were monitored as described above.

Results from Varying Initial Glucose Concentration

The PHB levels from strain p2DPT RS were inversely related to the initial glucose concentration. After three days of culturing, the low glucose set contained the highest levels of PHB, approximately 35 mg of PHB per gram of cell dry weight (CDW). The medium glucose flasks produced approximately 16 mg PHB/g CDW while the high glucose cultures produced about 4 mg PHB/g CDW. The PHB production rates were significantly higher for the low glucose flasks and interestingly, the highest rates occurred during the last 23.5 hours of culturing. This rate was nearly twice as high as the rate during the preceding interval, Table 5. The highest specific PHB rates were also observed during the last day of culturing for the other two p2DPT RS cultures.

The PHB levels from the p2DPT S cultures were all very similar regardless of initial glucose concentration (0.42-0.69 mg PHB/g CDW). These levels were quite similar to the background signal of 0.41 mg PHB/g CDW seen in the wild type cultures. An examination of the specific PHB production rates shows that none of these cultures showed any significant PHB accumulation at any time during the experiment, Table 5.

TABLE 5
Specific PHB synthesis rates for S. cerevisiae D603 cultures grown
on enriched SD media that contains varying initial sugar concentrations.
The first column is the average rate between 20 hours and 48 hours and
the second column is the average rate between 48 hours and 71.5 hours.

| | Specific PHB Synthesis Rate (mg PHB/hr/g CDW) | |
|---|---|---|
| p2DPT RS | | |
| 1% Glc/1% Gal | 0.451 | 0.877 |
| 2% Glc/1% Gal | 0.185 | 0.442 |
| 5% Glc/1% Gal | 0.017 | 0.113 |
| p2DPT S | | |
| 1% Glc/1% Gal | 0.005 | 0.002 |
| 2% Glc/1% Gal | −0.005 | 0.004 |
| 5% Glc/1% Gal | −0.001 | −0.003 |
| Wild-Type | | |
| 5% Glc/1% Gal | −0.008 | 0.000 |

The glucose had been consumed by 48 hours for all three experimental sets. Thus during the period of highest PHB accumulation, the media contained no glucose. The galactose concentration in the low glucose flasks decreased substantially between 20 and 48 hours however only a slight decrease was seen after the glucose was exhausted. The medium glucose cultures metabolized a small amount of the galactose in the first half of the experiment but the galactose levels were quite stable for the second half. The high glucose flasks did not show any significant consumption of galactose.

The culture supernatants were also analyzed for ethanol. The high sugar flasks had an ethanol concentration of about 4.4 g/L after 20 hours and a concentration of approximately 20 g/L after 48 hours. 20 g/L is probably not the highest attained ethanol concentration. By 48 hours the glucose was gone and the cells were likely oxidizing the ethanol. Prior to exhaustion of glucose, the ethanol concentration was probably higher. By 71.5 hours, the ethanol levels had decreased to 15.5 g/L. The medium glucose flasks had an ethanol concentration of approximately 3 g/L after 20 hours, 8 g/L after 48 hours and by 71.5 hours the levels had fallen to 6 g/L. The low glucose flasks had 2 g/L at 20 hours, 7 g/L at 48 hours and 3 g/L after 71.5 hours.

Table 6 summarizes the dry weight data as well as the PHB data. It is interesting to note the low glucose flasks produced significantly more PHB per liter even though the lower sugar resulted in a lower final cell mass. The yield data from this experiment is given in Table 7. The yields were calculated as described above. The biomass yields are seen to decrease as the initial sugar concentration increases. The strains with elevated PHB levels have a correspondingly high PHB/sugar yields and the ethanol/sugar yields are very similar for all the cultures.

TABLE 6
Biomass concentration, specific PHB content and PHB concentration
per liter for shake flask cultures grown on enriched SD media with
both glucose and galactose for 71.5 hours. Low Glc: 1% glucose,
1% galactose, Medium Glc: 2% glucose, 1% galactose,
High Glc: 5% glucose, 1% galactose.

| | | Specific PHB | |
|---|---|---|---|
| | Biomass | content | PHB |
| | g/L | (mg/g CDW) | (mg)/L |
| Low Glc: 2DPT S | 1.747 | 0.695 | 1.214 |
| Low Glc: 2DPT RS | 1.687 | 34.488 | 58.169 |
| Medium Glc: 2DPT S | 1.830 | 0.548 | 1.003 |
| Medium Glc: 2DPT RS | 1.780 | 16.284 | 29.094 |
| High Glc: 2DPT S | 2.387 | 0.427 | 1.019 |
| High Glc: 2DPT RS | 2.340 | 3.712 | 8.686 |
| Wild-Type | 2.467 | 0.405 | 0.999 |

TABLE 7
Product yields from glucose/galactose shake flask study. Low Glc:
1% glucose, 1% galactose, Medium Glc: 2% glucose, 1% galactose,
High Glc: 5% glucose, 1% galactose.

| | g biomass/ | g PHB/ | g EtOH/ |
|---|---|---|---|
| | g sugar | g sugar | g sugar |
| Low Glc: 2DPT S | 0.098 | 0.00009 | 0.693 |
| Low Glc: 2DPT RS | 0.134 | 0.00461 | 0.571 |
| Medium Glc: 2DPT S | 0.071 | 0.00005 | 0.432 |
| Medium Glc: 2DPT RS | 0.092 | 0.00186 | 0.427 |
| High Glc: 2DPT S | 0.035 | 0.00002 | 0.647 |
| High Glc: 2DPT RS | 0.038 | 0.00027 | 0.551 |
| Wild-Type | 0.052 | 0.00000 | 0.690 |

Results from Varying Initial Galactose Concentration

The PHB levels did not show a strong relationship to the initial galactose levels. All p2DPT RS cultures produced roughly 4 mg PHB/g CDW. The PHB production rates were also very similar for all three galactose concentrations. Unlike the glucose/gal actose experiment, the specific PHB synthesis rates remained fairly constant during the experiment. All three p2DPT S strains produced approximately 0.55 mg PHB/g CDW which was slightly higher than the wild type cells which had a background level of 0.27 mg PHB/g CDW. Like the p2DPT RS cultures, all three synthase only cultures had very similar specific PHB time profiles regardless of initial sugar concentration. A summary of the specific PHB synthesis rates is given in Table 8.

Even after 86.6 hours, none of the cultures consumed all of the available sugar which may have been a result of the low culture pH's. At 86.8 hours, the media had a pH of 2.53, 2.44, and 2.40 for the 2%, 4%, and 6% galactose flasks respectively. Fresh SD media has a pH of 4.0. The culture pH's from the glucose/galactose experiments were not recorded.

TABLE 8
Specific PHB synthesis rates for S. cerevisiae D603 cultures
grown on enriched SD media with varying initial galactose concentrations.
The first column is the average rate between 36 hours and 63 hours while
the second column is the average rate between 63 hours and 86.8 hours.

| | Specific PHB Synthesis Rate (mg PHB/hr/g CDW) | |
|---|---|---|
| p2DPT RS | | |
| 2% Gal | 0.0683 | 0.0265 |
| 4% Gal | 0.0614 | 0.0260 |
| 6% Gal | 0.0732 | 0.0395 |
| p2DPT S | | |
| 2% Gal | 0.0107 | −0.0029 |
| 4% Gal | 0.0085 | −0.0072 |
| 6% Gal | 0.0068 | −0.0038 |
| Wild-Type | | |
| 6% Gal | 0.0015 | −0.0002 |

The culture samples were analyzed for ethanol as described above. The low galactose cultures had ethanol concentrations that went from approximately 1.5 to 5.5 to 4.8 g/liter for samples taken at 36.5, 63, and 86.6 hours respectively. The medium flask had ethanol concentrations go from 3.2 to 7.9 to 6.4 g/liter and the high sugar flasks had concentrations that varied from about 3.7 to 9.1 to 7.7 g/liter for samples taken at 36.5, 63, and 86.6 hours respectively.

Table 9 summarizes the dry weight data as well as the PHB data from this experiment. An increase is seen in the PHB/L values for strain p2DPT RS as the sugar levels increase due to higher cell concentrations. The yield data from this experiment is given in Table 10. The yields were calculated as described above. A general decreasing trend is seen in the biomass yields as the initial sugar concentration increases. As with the previous experiment, strain p2DPT RS has an elevated high PHB/sugar yield due to the accumulated PHB. The ethanol/sugar yields also seem to demonstrate a decreasing trend as the galactose levels increase.

TABLE 9
Biomass concentration, specific PHB content and PHB concentration
per liter for shake flask cultures grown on enriched SD media with
galactose for 86.6 hours. Low Gal: 2% galactose, Medium Gal:
4% galactose, High Gal: 6% galactose.

| | | Specific PHB | |
|---|---|---|---|
| | Biomass | content | PHB |
| | g/L | (mg/g CDW) | (mg)/L |
| Low Gal: 2DPT S | 1.480 | 0.562 | 0.831 |
| Low Gal: 2DPT RS | 1.317 | 3.716 | 4.893 |
| Medium Gal: 2DPT S | 1.787 | 0.519 | 0.929 |
| Medium Gal: 2DPT RS | 1.660 | 3.981 | 6.608 |
| High Gal: 2DPT S | 1.860 | 0.551 | 1.025 |
| High Gal: 2DPT RS | 1.713 | 4.317 | 7.396 |
| Wild-Type | 2.037 | 0.270 | 0.549 |

TABLE 10
Product yields from galactose only shake flask study. Low Gal:
2% galactose, Medium Gal: 4% galactose, High Gal: 6% galactose.

| | g biomass/ | g PHB/ | g EtOH/ |
|---|---|---|---|
| | g sugar | g sugar | g sugar |
| Low Gal: 2DPT S | 0.238 | 0.00004 | 0.500 |
| Low Gal: 2DPT RS | 0.200 | 0.00039 | 0.530 |
| Medium Gal: 2DPT S | 0.154 | 0.00002 | 0.364 |
| Medium Gal: 2DPT RS | 0.056 | ˜ | ˜ |
| High Gal: 2DPT S | 0.081 | 0.00001 | 0.249 |
| High Gal: 2DPT RS | 0.066 | 0.00034 | 0.316 |
| Wild-Type | 0.066 | 0.00001 | 0.208 |

The results from these studies were compared with some earlier experiments. The medium glucose cultures and the shake flask study described above, which both initially contained 2% glucose produced very comparable levels of PHB (approximately 15 to 16 mg PHB/g CDW) even though the initial galactose concentrations were different. The high glucose cultures produced 3.7 mg PHB/g CDW which was a bit higher than the 0.8 mg PHB/g CDW produced in the bioreactor experiment. The high glucose shake flasks also resulted in a substantial difference in PHB levels between strain p2DPT RS and strain p2DPT S while, the bioreactor experiment showed no real difference. This is likely a due to the bioreactors being fed additional glucose after 42 hours of culturing.

The low accumulation of PHB in the presence of high levels of glucose was most likely not a result of the Crabtree effect. Both glucose and galactose are fermentable sugars that activate the Crabtree effect at concentrations above 100 mg/L (Sierkstra et al., Yeast 9: 787-795, 1993). During the course of both shake flask studies, the galactose concentrations remained high enough to continually mediate the Crabtree effect. Since the PHB levels in the galactose only cultures were all essentially the same, the Crabtree effect is not believed to have played a major role in the inverse relationship between glucose levels and PHB levels.

In the glucose/galactose shake flask study, the glucose was consumed by 48 hours. This should have released the culture from the effects of glucose repression. Although after consuming the glucose, the cells seemed to prefer ethanol to galactose. This preference for a non-fermentable carbon source suggests there may have been a residual glucose effect. Also, the highest increase in PHB occurred after the glucose was consumed. During this phase, the media contained only ethanol and galactose. Similarly high specific PHB production levels were not seen in the galactose only shake flask study which after 48 hours, also contained a mixture of only galactose and ethanol.

The levels of accumulated PHB in strain p2DPT S seemed to depend on whether or not glucose was present. When grown solely on galactose, strain p2DPT S showed elevated levels of PHB as compared to the wild-type cells. This can be seen in both the total accumulation and in the production kinetics of PHB, Table 8. These results from galactose grown cultures are consistent with the findings of previously published material (Leaf et al., Microbiol. 142, 1169-1180, 1996). However, when strain p2DPT S was grown on a combination of glucose and galactose, the PHB levels and production rates were about the same as the wild-type cells. As discussed above, it is possible that glucose inhibits the expression of the native yeast genes involved in the production of PHB precursors like 3-hydroxybutyryl-CoA. The cells grown on galactose show higher levels of background reductase activity than the cells grown on just glucose. This could suggest the native reductase expression which likely is responsible for precursor production in strain p2DPT S is negatively affected by glucose. Strain p2DPT RS which expresses a recombinant reductase did not show this trait when grown in the presence of glucose.

### Example 8

### Simplification of the Experimental System in Yeast

It is expected that the experimental system can be simplified using the following procedures.

Integrated Gene System

Population heterogeneity associated with maintaining two autonomous plasmids complicates the analysis of recombinant strains. For instance, at the end of the bioreactor experiments described in Example 4, only half the cells still possessed both plasmids. Examination of the PHB levels with fluorescent microscopy revealed additional heterogeneity. The cells with PHB contained a wide distribution of polymer levels likely due to varying plasmid copy number. Accurate product kinetics and yields are difficult to obtain in such systems.

The integrative plasmid system described in Example 3 addresses heterogeneity problems associated with both plasmid stability and gene copy number. Integrated genes are considerably more stable than an autonomous plasmids and the entire cell population maintains the same copy number. The system's nonunique targeting sequence is an additional benefit. The plasmid can be integrated at numerous locations throughout the chromosome. Plasmid pIDP GS also expresses the marker gene GFP from the GAL1-10 promoter. GFP fluorescence levels should facilitate copy number determination.

Since the integrative plasmid system contains the URA3 blaster cassette (Alani et al., Genetics 116: 541-545, 1987), integrating the synthase gene frees a selection marker that can be used to express additional genes like glutamate dehydrogenase (GDH2) or ATP citrate-lyase (ACL).

Engineering an Artificial Divergent Promoter

Introducing multiple genes in eukaryotes can be challenging because unlike prokaryotes, eukaryotes do not typically express polycistronic messages. Each gene usually requires a separate promoter and termination sequence. Viral sequences have permitted the expression of polycistronic messages in some eukaryotes but these viral sequences do not work in S. cerevisiae (Das et al., Frontiers in Bioscience 3: 1241-52, 1998).

The divergent GAL 1-10 promoter has been used successfully to introduce multiple genes with a single promoter sequence. However the GAL1-10 promoter also introduces a number of difficulties. First, the cultures require galactose to induce expression. Since S. cerevisiae strain D603 grows slowly and produces low levels of PHB when grown solely on galactose, the cultures are grown on a combination of glucose and galactose. Using two sugars increases the complexity of the system. Even with reg1-501 mutation, high concentrations of glucose leads to catabolite repression of the galactose promoter and lowers PHB levels (Da Silva et al, J. Biotech. 10: 253-266, 1989). In addition to catabolite repression, two carbon sources complicate analysis. For instance, it is not clear if glucose, galactose, or some combination of the two sugars provide the carbon used to produce PHB. Lastly, the concentration of the activator protein GAL4 is a concern with the GAL1-10 promoter. Native levels of GAL4 usually limit expression from recombinant GAL promoters while over expression of GAL4 can be toxic (Schultz et al., Gene 61: 123-133, 1987; Choi et al., Biotechnol 42: 587-594, 1994).

To address the problems associated with the GAL1-10 promoter, alternative divergent promoters have been investigated. Divergent promoters are considered a general form of genetic organization (Beck et al., Microbiol. Rev. 52: 318-326, 1988). It has even been suggested that many highly expressed, constitutive promoters that natively regulate a single gene are capable of bidirectional regulation (Santangelo et al., Mol. Cell. Biol. 8(10): 4217-4224, 1988; Bell et al., Curr. Genet 28: 441-446, 1995). Analysis of promoter organization from a couple of highly expressed genes seems to support the suggestion.

Highly expressed genes like phosphoglycerate kinase (PGK) (Rathjen et al., Nucleic Acids Research. 18(11): 3219-25, 1990) and ribosomal protein genes (RPG) like translational elongation factor 2 (TEF2) share a similar upstream activation sequence (UAS)(Planta et al., TIG 4: 64-68, 1988). The UAS is comprised of a RAP1 protein binding site, the RPG-box (ribosomal protein genes), and a CTTCC motif referred to as a CT box (Tornow et al., EMBO Journal. 12(6): 2431-7, 1993; Uemura et al., Genetics 147: 521-532, 1997; Bi et al., Genes and Development 13: 1089-1101, 1999). The binding of the DNA bending, multifunctional protein, RAP1 (repressor activator protein), positively regulates the RPG-box (Shore, Trends in Genetics. 10(11): 408-12, 1994). The regulatory protein GCR1 (glycolysis regulator) is then guided to the CT-box by the bound RAP1 protein (Uemura et al., Genetics 147: 521-532, 1997). When both RAP1 and GCR1 proteins are bound to the UAS, gene expression is induced. The linear organization of many UAS elements is flexible. The S. cerevisiae phosphoglycerate kinase (PGK) promoter has an RPG-box which is located hundreds of base pairs 5′ of the CT-box (Rathjen et al., Nucleic Acids Research. 18(11): 3219-25, 1990). A similar pattern has been found with the Ashbya gossypii TEF gene. However, the organization of the S cerevisiae TEF2 UAS is reversed. The CT-box is about one hundred base pairs 5′ of the RPG-box (Bi et al., Genes and Development 13: 1089-1101, 1999). Apparently the 5′ to 3′ sequential order of the regulatory sequences permits expression in either arrangement.

The complicating issues associated with the GAL1-10 divergent promoter are being addressed with the construction of an artificial, constitutive divergent promoter. The promoter is a PCR modified hybrid constructed from the translational elongation factor 2 (TEF2) upstream activation sequence (UAS), TATA box, mRNA start site, and ribosome binding site and the GAL1 promoter TATA box, mRNA start site, and ribosome binding site. The TEF2 promoter natively regulates the expression of a single gene however the flexibility of the UAS is thought to permit divergent expression when the proper DNA elements are present namely a TATA box, an mRNA start site, and a ribosome binding site. The GAL1 sequence was chosen because its high expression levels are thought due to efficient mRNA initiation and efficient ribosome binding (Johnston, Microbiol. Rev. 51(4): 458-476, 1987). Because the regulatory regions of the GAL1 promoter are well studied, it is possible to isolate a sequence that does not contain any galactose mediated regulatory elements.

The artificial promoter, TEG1 (translational elongation factor GAL1), will be regulated by the TEF2 UAS and should permit bidirectional gene expression. One gene will be expressed from the native TEF2 ribosome binding sequence while the other gene will be expressed from the GAL1 binding sequence. Low levels of regulatory proteins should not inhibit TEG1 expression from a high copy number vector. A haploid S. cerevisiae nucleus is believed to contain approximately 10⁴ RAP1 proteins (Shore, Trends in Genetics 10(11): 408-12, 1994).

A preliminary examination of the TEF2 promoter was done. Using a truncated TEF2 promoter sequence, low level bidirectional expression was observed using GFP and an E. coli protein. The modified promoter should improve expression levels.

### Example 9

### Enhancement of PHA Production in Yeast

Expression of ATP Citrate-lyase

The expression of foreign genes can significantly change a host's reaction topography. By adding additional reactions, it is possible to alter metabolic flux patterns. Yeast that accumulate high levels of fatty acids generate robust cytosolic acetyl-CoA pools primarily through the action of ATP-citrate lyase (ACL). To examine investigate the merits of introducing ACL into the recombinant S. cerevisiae strain (Leaf, Engineering Yeast for PHB Production. Ph.D. Dissertation. University of Minnesota. St. Paul, Minn., 1998), elementary modal analysis was used. According to an elementary mode analysis that we performed, the ACL reaction significantly improved PHB's maximum theoretical carbon yield. In addition to possibly improving PHB yield, the ACL gene may also increase carbon flux toward acetyl-CoA by redirecting carbon from other pathways. A larger acetyl-CoA pool could in theory improve PHB accumulation and/or kinetics.

Expressing the ACL gene should be possible using existing cloning systems. The mammalian version of the ACL gene described in Elshourbagy et al., J. Biol. Chem. 265(3):1430-5, 1990; Elshourbagy et al., Euro. J. Biochem. 204(2):49 1-9,1992.

Transhydrogenase System

The host's redox balance is an important design consideration. Production of heterologous proteins can perturb a redox balance that can lead to altered carbon fluxes. This is especially true in organisms like S. cerevisiae where NADH and NADPH are not equivalent. This problem can be approached using a transhydrogenase system. A transhydrogenase system passes reducing equivalents from either NADH to NADP⁺ or from NADPH to NAD⁺. For instance, cell growth requires the cofactor NADPH which in S. cerevisiae is usually produced by the pentose phosphate cycle. While the pentose phosphate cycle produces the required NADPH, it has a lower ATP yield than glycolysis and it lowers carbon yield through CO₂ generation. In the presence of a transhydrogenase system, NADH produced during glycolysis could be used to generate NADPH. This would likely reduce the flux through the pentose phosphate cycle.

As described in Example 6, a glutamate transhydrogenase system was expressed to explore whether a redox imbalance was affecting PHB production. Because of cloning complications, the GDH2 transhydrogenase system was tested only with the PHB reductase and synthase genes. Expression of the GDH2 gene did improve specific PHB content. With the integration of the PHB synthase gene, the HIS3 selection marker will be available to maintain plasmid p2-GDH2 which will permit expression of GDH2 with the entire PHB pathway.

Production of Other PHAs

In an effort to understand the fundamentals of PHA production in S. cerevisiae, previous studies have focused primarily on the better characterized PHB. However PHB's physical properties are not suitable for many applications. For this reason, commercial applications have focused on other PHA's like P(HB-co-HV). P(HB-co-HV)'s material flexibility and its thermal processability make it a more attractive biopolymer.

P(HB-co-HV) production in S. cerevisiae would likely require both the introduction of an additional enzyme and the engineering of host flux patterns. P(HB-co-HV) requires both the PHB precursor acetoacetyl-CoA and the PHV precursor β-ketovaleryl-CoA. Acetoacetyl-CoA is produced by the condensation of two acetyl-CoA molecules. The currently expressed β-ketothiolase (phbA) enzyme catalyzes this reaction. β-ketovaleryl-CoA is produced by the condensation of acetyl-CoA with propionyl-CoA. Although phbA is capable of catalyzing this reaction, the enzyme has a very low specific activity. In R. eutropha, β-ketovaleryl-CoA is thought produced primarily by another β-ketothiolase, BktB (Slater et al., J. Bacteriol. 180:1979-1987, 1998). PHB reductase (phbB) is active with both acetoacetyl-CoA and β-ketovaleryl-CoA.

P(HB-co-HV) production will likely require the expression of the gene BktB. The enzyme could be introduced on one of the previously described expression systems or it could be introduced as a fusion protein. Creation of a fusion protein could simplify the introduction of all four enzymatic activities. For example, both P(HB-co-HV) copolymer precursors, D-β-hydroxybutyryl-CoA and D-β-hydroxyvaleryl-CoA, could be produced from two fusion proteins involving the PHB reductase enzyme (phbB). One fusion protein would combine phbB and phbA while the other would combine phbB and BktB. This combination of fusion proteins and the synthase enzyme could theoretically produce P(HB-co-HV) copolymer from only three gene products (two β-ketothiolase/reductase fusion proteins and synthase).

In order to produce copolymer, a substantial propionyl-CoA flux would need to be directed toward the PHA genes. Feeding propionate is one method of augmenting any natively occurring fluxes. The three carbon organic acid could be incorporated into PHA in the same manner as acetate. The protonated acid would diffuse across the membrane where cytosolic acetyl-CoA synthetase (ACS1), which has activity toward both acetate and propionate, could produce propionyl-CoA (van den Berg et al., J. Biol. Chem. 46: 28953-28959, 1996). Careful feeding schemes would be required because propionate, like acetate, is toxic at low pH's. The elementary mode examined above that uses ethanol and acetate is also valid for propionate, acetate and ethanol. One propionate molecule would be substituted for one acetate molecule.

1 Propionate+1 Acetate+1 Ethanol=2 CO₂+PHV

Because propionate is a three carbon metabolite, the carbon yield increases from 0.667 to 0.714.

In addition to PHB and P(HB-co-HV) many other types of PHA are possible. Some of these PHA's could have very unique properties based on the PHA precursors. Peroxisomal β-oxidation of fatty acids could serve as a possible source of these PHA precursors. β-oxidation in S. cerevisiae goes through a D-3-hydroxyacyl-CoA intermediate which is stereochemically compatible with PHA polymerases. However, the peroxisomal location of the intermediates would have to be addressed. Peroxisomal peptide targeting sequences have been identified and have been used successfully to target R. eutropha PHB genes to maize peroxisomes (Hahn, Introduction and Characterization of the Poly(3-Hydroxybutyrate) Biosynthetic Pathway in Plant Cell Cultures. Ph.D. Dissertation, University of Minnesota, St. Paul, Minn., 1998). These sequences could be used with a long chain PHA polymerase like the one found in P. oleovorans to target enzymatic activity to the peroxisome. The P. oleovorans polymerase is active with C₆ to C₁₂ D-3-hydroxyacly-CoA's so depending on which fatty acids are fed a wide variety of different monomers could be incorporated into PHA. Since β-oxidation provides the precursors, only a targeted polymerase gene should be needed to produce peroxisomal PHA.

Biopolymer production in the peroxisomes would require a careful feeding scheme to generate the appropriate fluxes. Like the previously mentioned acetate and propionate, fatty acids like oleic acid are toxic at high concentrations under acidic conditions.

Constructs containing the P. oleovorans polymerase currently exist in the laboratory's frozen stocks. The gene would need to be modified with the carboxy-terminal SKL peroxisomal targeting motif (serine, alanine, or cysteine at the carboxy-terminus; lysine, histidine, or arginine at the second position; and leucine in the third position) (Hahn, Introduction and Characterization of the Poly(3-Hydroxybutyrate) Biosynthetic Pathway in Plant Cell Cultures. Ph.D. Dissertation, University of Minnesota, St. Paul, Minn., 1998 using PCR.

Isolation of Mutants Using Flow Cytometry

The hydrophobic fluorescent stain nile red is commonly used to stain PHB granules. While the stain is helpful in visualizing the biopolymer in vivo, it can also be used with such techniques as flow cytometry (FCM) (Srienc et al., Biotech. Bioeng. 26, 982-987, 1984). Nile red stained cells containing PHB are easily distinguishable from cells without PHB. Using an appropriate combination of staining procedures and filters, it should be possible to analyze and sort recombinant S. cerevisiae using flow cytometry. The current PHB producing strains of S. cerevisiae show a great deal of heterogeneity in PHB levels. By using FCM's sorting capacity to isolate high PHB producers, it may be possible to isolate cells with random mutations that favor PHB production. These mutations could be anything from an increased plasmid retention rate to mutations in central metabolic pathways. Metabolic flux analysis could facilitate the identification of pathway mutations that increase flux.

FCM will also be useful in quantifying the effects of integrating the PHB genes. Population homogeneity will likely improve with gene integration and FCM is an ideal tool to study such changes.

PHB Fusion Proteins

Construction of the entire PHB pathway in S. cerevisiae involves the expression of three separate foreign genes. In Example 4, two plasmids were used to express these three genes. Other strategies for introducing multiple genes were discussed in Section in Example 1. One of these techniques that could facilitate the expression of the PHB pathway is the creation of fusion proteins. Fusion proteins are the result of an in-frame fusing of two or more genes that usually includes a short linker between the different genes. Although more complicated, multimeric enzymes have been successfully expressed as fusion proteins. Published accounts include fusion proteins created from two and even three different multimeric enzymes (Bulow, Eur. J. Biochem. 163: 443-448, 1986, Lindbladh et al., Biochem. 33: 11692-11698, 1994, Ljungcrantz et al., FEBS Letters. 275(1-2): 91-4, 1990). The fusing of the genes would reduce the number of plasmids needed to introduce the activities of the entire PHB pathway.

The genes involved in PHB production are multimers. β-ketothiolase and reductase are both tetramers while synthase is believed to form dimers. The creation of a PHB fusion protein could take a number of different forms. If a two-gene fusion were created, the gene pairs should be coupled either as ketothiolase/reductase or reductase/synthase. This would localize intermediates near the next sequential pathway enzyme. Since the synthase enzyme associates with PHB granules (Lafferty et al., Microbial production of poly-b-hydroxybutyric acid. In: Rehm, H.-J. & Reed, G. (Eds.) Biotechnology, pp.135-176. VCH, Weinheim, Germany,1988), the construction of a synthase fusion protein would localize the other protein(s) to the surface of the PHB granule.

The creation of a functional fusion protein is based on factors that are difficult to predict. The different proteins' active sites have to be accessible to substrates and the native protein folding cannot disrupted by the linker or the neighboring proteins. The amino terminus of synthase protein has been shown to be resilient to some modifications. A truncated synthase protein and a GFP/synthase fusion protein were both able to catalyze PHB production (Leaf et al., Microbiol. 142, 1169-1180, 1996; Leaf, Engineering Yeast for PHB Production. Ph.D. Dissertation. University of Minnesota. St. Paul, Minn., 1998). The sensitivity of the other PHB genes to modification is unknown.

### Example 10

### Anaerobic Production of PHB in S. Cerevisiae

For economic reasons like equipment design and operational costs, it is of interest to produce PHB anaerobically. Under anaerobic conditions, a fermentable carbon source is necessary so the glucose uptake reaction was included. Our experiments confirmed that PHB can be produced under anaerobic conditions. Cells expressing all three PHB genes had a population averaged specific PHB content of 1.5% of their cell dry however there was heterogeneity and some cells produced PHB in excess of 25% of the cell weight.

Strain

This experiment used a recombinant S. cerevisiae strain D603 expressing the Ralstonia eutropha PHB pathway (β-ketothiolase (phbA), reductase (phbB), and synthase (phbC)) from two high copy number plasmids (p2DPT RK, p2DP-S(H)).

Experimental Procedure

S. cerevisiae expressing the three gene R. eutropha pathway was cultivated in a 5 L B. Braun bioreactor. The reactor was batched with 3 liters of ESD_{AMLY} media (6.7 g/L yeast nitrogen base, 100 mg/L adenine, 100 mg/L methionine, 150 mg/L lysine) containing 1 wt % glucose and 1 wt % galactose and inoculated with 60 ml of an overnight culture grown aerobically in the same media. Prior to inoculation, the contents of the reactor were sparged with nitrogen gas until the dissolved oxygen probe indicated an oxygen concentration of zero. The strain was cultured anaerobically at 30° C. in defined media (glucose 10 g/L, galactose 10 g/L, yeast nitrogen base with ammonium sulfate 6.7 g/L, adenine 100 mg/L, methionine 100 mg/L, and lysine 150 mg/L). The pH was maintained at 4.5 with acid (2% H₃PO₄) and base (1 M NaOH) additions. The reactor was sparged with nitrogen and agitated at 300 RPM.

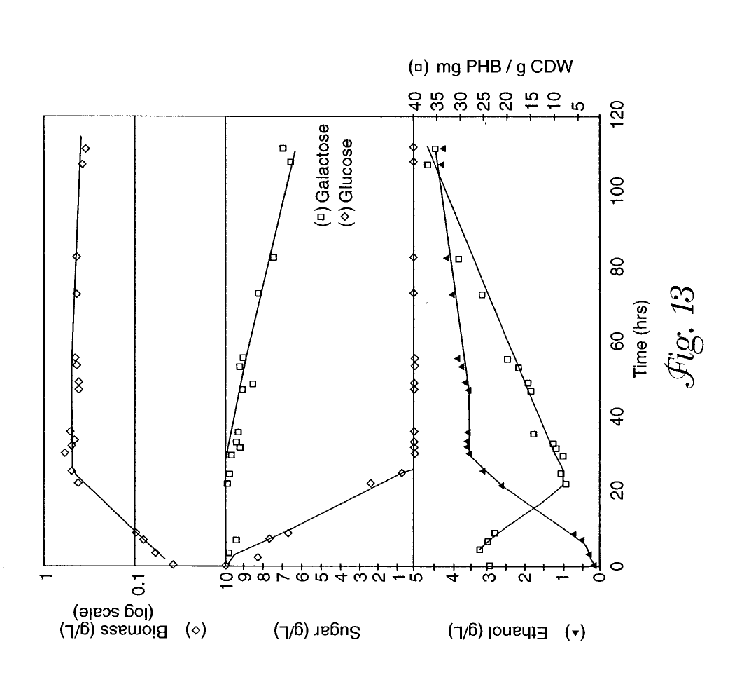

The cells grew exponentially with a maximum growth rate of 0.106 hr⁻¹ for approximately 25 hours before reaching stationary state. Bioreactor time profiles are shown in FIG. 13. The biomass yield on glucose was 0.088 g biomass/g glucose. The depletion of glucose corresponded closely with the culture entering stationary phase. Galactose was consumed after the depletion of glucose however the rate decreases after hour thirty. At the end of the cultivation, approximately half of the initial galactose was still present. The consumption of sugar is reflected by the addition of NaOH used to control pH.

Biopolymer accumulation began after the cells entered a slow growth phase and continued linearly for the remainder of the experiment. PHB production began around hour twenty and the biopolymer accumulated for approximately forty hours. The maximum population averaged specific PHB production rate was 0.324 mg PHB/g CDW/hr while the average specific content reached roughly 1.5% of the cell dry weight. The PHB yield on galactose was approximately 0.01 g PHB/g galactose.

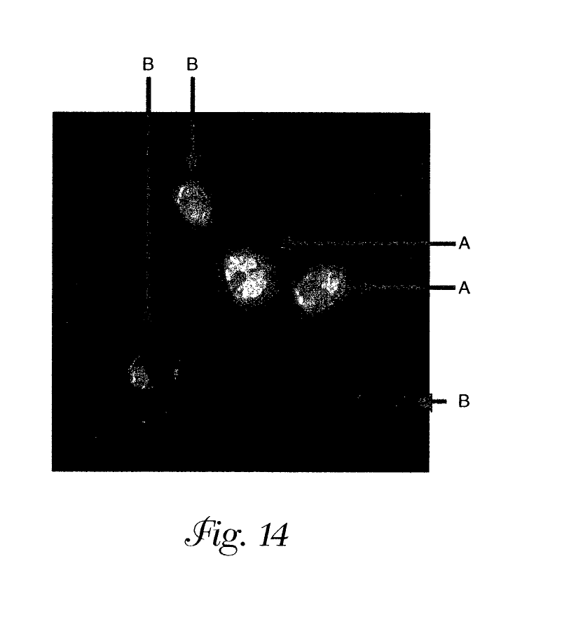

Nile red staining and fluorescent microscopy revealed significant heterogeneity in polymer content among the population (FIG. 14). While the population average specific PHB content for the cells was usually between 60-100 mg PHB/g cell dry weight (6-10% of cell dry weight), a great deal of population heterogeneity was observed. Some cells accumulate PHB to levels significantly higher that 10%. FIG. 14 shows cells with varying amounts of accumulated PHB. Some cells accumulated PHB in excess of 50% of the cell volume, while others contained no PHB. The yeast system is thus capable of very high levels of accumulation. Because autonomous plasmids possess a degree of instability, is expected that the use of integrative plasmids to transform the yeast cells will decrease the heterogeneity and increase the average PHB content for the population.

The ethanol concentration is seen to increase during PHB accumulation indicating the conditions are conducive to both biopolymer and ethanol production. Ethanol production was seen during cell growth with levels reaching about 4 g/L and having a yield on glucose of 0.486 g ethanol/g glucose.

The yeast culture stopped growing after approximately twenty five hours which corresponds closely with the depletion of glucose and the cessation of ethanol production. The exhaustion of a critical metabolite found in the media's yeast nitrogen base it thought to limit continued growth because at this time, galactose is still present at a concentration greater than 6 g/L. More than 90% of the culture's PHB is accumulated during this non-growth phase. These findings suggest it is appropriate to exclude a biomass term from the elementary mode model. The mode analysis indicates it is necessary to have both sugar and acetate available in order to produce PHB anaerobically. Acetate is a common byproduct of S. cerevisiae's fermentative sugar metabolism and has been shown to account for as much as 1% of the utilized glucose under growth conditions (Gancedo et al., Energy-yielding Metabolism. In The Yeasts, 2^{nd} edn, vol 3. (eds A. H. Rose & J. S. Harrison) pp 205-251. Academic Press. New York, 1989). While sugar is available during the entire cultivation, the initial lag in PHB formation could be due to an absence of acetate. As glucose is metabolized during growth, acetate would be produced and become available for such products as lipids and PHB. Biopolymer production continues until approximately hour sixty. It is likely the availability of acetate limits further polymer production.

The production of PHB during non-growth conditions suggests it is possible to continue polymer production by feeding organic acids like acetate or propionate. Elementary mode analysis suggests that under anaerobic conditions glucose is used to produce the energy and reducing equivalents required to convert acetate into PHB with a by-product being ethanol. The S. cerevisiae acetyl-CoA synthetase is a not fastidious enzyme and has shown activity with propionate as well as acetate (van den Berg et al., J. Biol. Chem. 46: 28953-28959, 1996). The use of these organic acids in a fed batch operation would likely permit further polymer accumulation and the synthesis of a poly(hydroxybutyrate-co-hydroxyvalerate) copolymer.

### Example 12

### Anaerobic Production of PHB in Recombinant Escherichia coli

Escherichia coli does not natively possess the biochemical machinery required to produce polyhydroxyalkanoates (PHAs). However, the recombinant expression of foreign PHA pathways does permit production of some PHAs in E. coli.

E. coli strain DH5α was used to express three genes from the Ralstonia eutropha polyhydroxybutyrate (PHB) operon namely the β-ketothiolase, acetoacetyl-CoA reductase, and PHB synthase genes. These three genes were expressed from plasmid pPT500 (Jackson, Recombinant Modulation of the phbCAB Operon Copy Number in Ralstonia eutropha and Modification of the Precursor Selectivity of the Pseudomonas oleovorans Polymerase 1. Masters Dissertation. University of Minnesota. St. Paul, Minn., 1998). The strain was cultured anaerobically in 3 liters of 2×YT media (16 g/L tryptone, 10 g/L yeast extract, 5 g/L NaCl) supplemented with 10 g/L glucose. 100 μg/ml of kanamycin was used to maintain selective conditions. The culture was grown at 30° C. and the pH was maintained at 7.0 with 2.0 M NaOH and 2% H₃PO₄. The vessel was agitated at a rate of 300 RPM and sparged with N₂ gas to maintain an anaerobic environment and to maintain positive pressure.

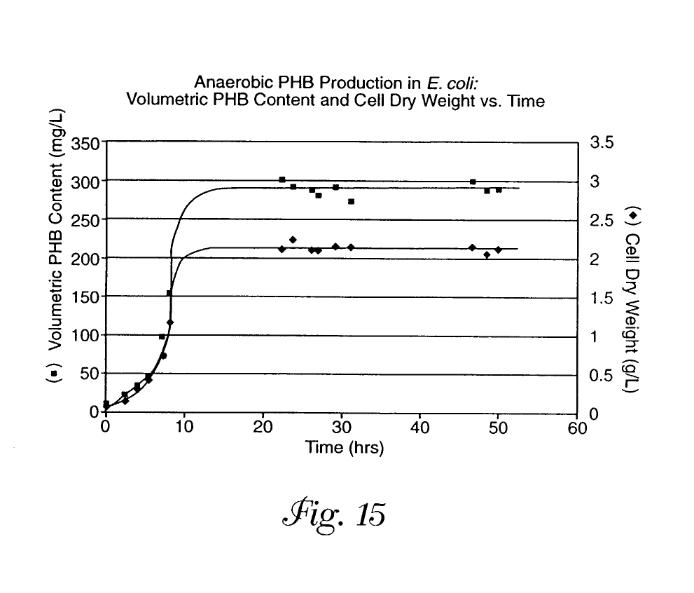

The recombinant E. coli strain accumulated PHB under anaerobic conditions (FIG. 15). The PHB is believed to accumulate anaerobically in E. coli by means similar to PHB accumulation in recombinant Saccharomyces cerevisiae. Acetate produced as a metabolic by-product is likely channeled into acetyl-CoA production while glucose serves as a fermentable energy source and supplies the required reducing equivalents for PHB production.

### Example 13

### Anaerobic PHA_{MCL} Production in Recombinant Escherichia coli

Anaerobic PHB production was demonstrated in E. coli strain DH5α expressing the three R. eutropha genes PHB synthase, reductase, and ketothiolase from plasmid pPT500 (Example 12). To demonstrate that a wide range of PHA can be produced anaerobically, a medium chain length polymerase was expressed in an anaerobically grown E. coli culture.

E. coli strain DH5α expressing the Pseudomonas oleovorans medium chain length polymerase I (Huisman et al., J. Biol. Chem. 266: 2191-2198, 1991) from plasmid pPT700 (Jackson, Recombinant Modulation of the phbCAB Operon Copy Number in Ralstonia eutropha and Modification of the Precursor Selectivity of the Pseudomnonas oleovorans Polymerase I. Masters Dissertation. University of Minnesota. St. Paul, Minn., 1998) was cultured anaerobically in 2×YT media (16 g/L tryptone, 10 g/L yeast extract, 5 g/L NaCl) supplemented with 1% (wt/v) glucose, 0.2% (v/v) oleic acid, 0.2 mg/ml acrylic acid (Qi et al., FEMS Microbiol. Let. 167: 98-94, 1998), and 100 μg/ml kanamnycin. The 5 liter reactor was operated at 400 RPM, pH 7.0, and 37° C.

Results

The recombinant E. coli culture reached a final cell density of about 1 g/L and accumulated low levels of PHA anaerobically. The total PHA content was approximately 8 mg of PHA/g cell dry weight with approximately 91% of the PHA being comprised of C14 monomer and the remaining 9% being C10 monomer. Anaerobic production of PHA likely requires a fermentable carbon source like glucose to provide a favorable redox environment. PHA production could probably be improved by adding additional fermentable carbon sources. These compounds would likely improve the anaerobic metabolism of fatty acids like oleic acid which could provide more potential PHA precursors.

### Example 14

### Constitutive Promoter for Production of PHA in Yeast

The previously described galactose inducible system (Example 3) has complications that can be addressed by the development of an alternative expression system. First, galactose is a relatively expensive substrate that would raise PHA production costs. In addition, the presence of two major carbon sources complicates the carbon balance analysis and calculations like product yield. The galactose requirement for induction could also complicate the utilization of some feed substrates like fatty acids. Galactose would repress the induction of the enzymes required to process the fatty acids into possible PHA intermediates. Finally, if a stronger promoter was used, the same levels of gene expression could be achieved with a lower recombinant gene copy number. A constitutive promoter system is being analyzed which uses the translational elongation factor promoters TEF1 and TEF2 (Schirmaier et al., EMBO J. 3:3, 3311-3315, 1984). This system would not require an inducer molecule like galactose and should provide high levels of expression.

The existence of integrative and high copy number versions of the PHB genes and the use of both the TEF1 and TEF2 promoter allows the creation of a wide variety of possible PHB gene combinations. For instance, a high copy number ketothiolase plasmid (p2TG1T K(U)) could be used with an integrated reductase gene regulated by TEF1 (pIT1T R(Le) and an integrated synthase gene regulated by TEF2 (pIT2T S(T) or any number of other combinations.

Plasmid Construction

The TEF1 promoter was isolated from plasmid pTEF1/Zeo (Invitrogen, Carlsbad, Calif.) using pfu polymerase (Invitrogen, Carlsbad, Calif.) and the following PCR primers TTCAGAATTCTATCGATTTTAGATTGCTATGC (SEQ ID NO:5) and TCTTAAAGCTTCTAGCTCGAGCC (SEQ ID NO:6). The first primer introduces an EcoRI and a ClaI site while the second primer introduces a HindIII site. The PCR product was ligated into pRS306 (Sikorski et al., Genetics 122: 19-27, 1989) using a HindIII and an EcoRI digest creating plasmid pT1-306.

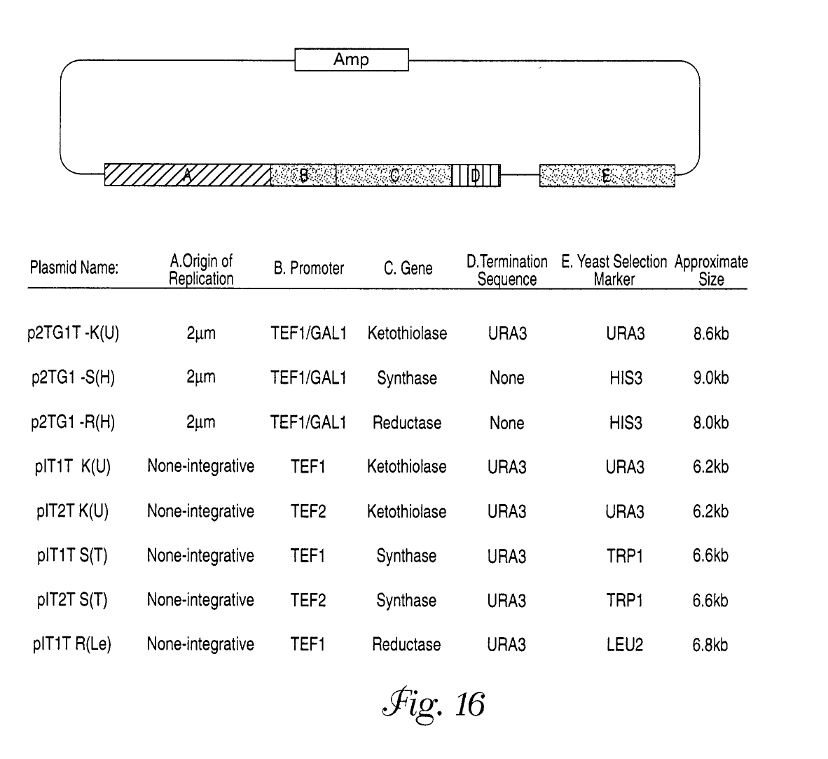

The GAL1 promoter fragment was isolated using PCR from plasmid pDP306 with primers TTACTTGAAGCTTAACAACCATAGG (SEQ ID NO:7) and AATTCGGGTCGACG ATATCTCTCCTTGACG (SEQ ID NO:8). The first primer introduces a HindIII site and the second primer introduces an EcoRV and SalI site. The fragment was ligated into pT1-306 using a SalI/HindIII digest creating plasmid pTG1-306. The TEF1/Gal1 promoter was isolated using a SalI/EcoRI digest and ligated into a similarly digested p2 RS306 T to create p2TG1T 306. This plasmid was digested with ClaI and EcoRI while the R. eutropha ketothiolase gene was isolated from p2DPT RK with a ClaI/EcoRI digest. The ketothiolase gene was ligated into the TEF1/Gal1 backbone plasmid to create p2TG1T -K(U) (FIG. 16).

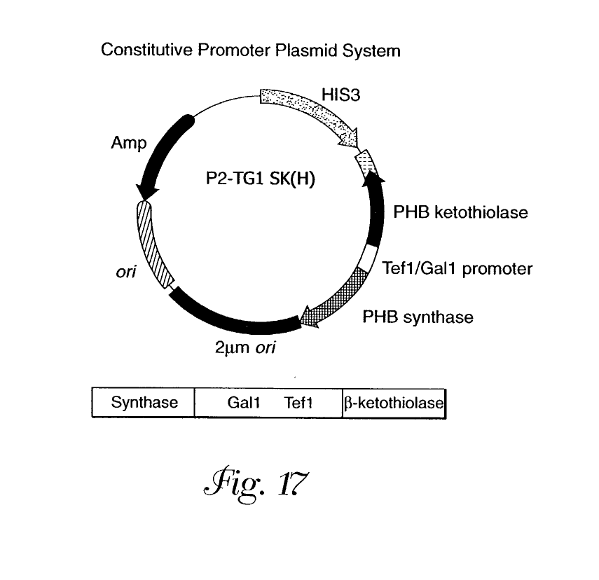

In order to create high copy number plasmids with the synthase and reductase genes, the TEF1/Gal1 promoter was isolated from pTG1-306 with a SalI/EcoRI digest and ligated into a similarly cut p2DP-S(H) to create p2TG1-(H). The R. eutropha synthase gene was isolated from p2DPT RS with a ClaI/EcoRI digest and ligated into a similarly digested p2TG1-(H) to create p2TG1-S(H) (FIG. 16) which expresses the synthase gene. A plasmid capable of expressing both the synthase and the ketothiolase is currently under construction using this same shell; the ketothiolase gene has not yet been inserted. Integration of the ketothiolase gene requires a blunt end ligation. Plasmid p2TG1-SK(H) is a high copy number vector that will contain the PHB synthase gene regulated by the GAL1 side of the hybrid divergent promoter while the β-ketothiolase gene is regulated by the Tef1 promoter (FIG. 17). This plasmid utilizes the HIS3 selection marker.

The R. eutropha reductase gene was isolated from pAeT41 (Peoples et al., J. Biol. Chem. 264(26):15293-15297, 1989, and J. Biol. Chem. 264(26): 15298-15303, 1989) using pfu polymerase and the following primers ATTATCGATGACTCAGCGCATTGCGTATGTG (SEQ ID NO:9) and ATTGAATTCAGCCCATATGCAGG CCGCCG (SEQ ID NO:10) which introduced a ClaI and an EcoRI restriction site respectively (Jackson, Recombinant Modulation of the phbCAB Operon Copy Number in Ralstonia eutropha and Modification of the Precursor Selectivity of the Pseudomonas oleovorans Polymerase I. Masters Dissertation. University of Minnesota. St. Paul, Minn., 1998). The PCR product was digested with ClaI and EcoRI and ligated into a similarly cut p2TG1 -S(H) to create p2TG1 -R(H) (FIG. 16).

A series of integrative plasmids were constructed to increase the stability of the introduced PHB genes in the yeast host. The integrative plasmid containing the ketothiolase gene was constructed by digesting p2TG1T K(U) with HindIII and SstI and isolating the cassette which contained the TEF1 promoter, the ketothiolase gene and the URA3 termination sequence. This cassette was ligated into a similarly digested pRS306 (Sikorski et al., Genetics 122: 19-27, 1989) to create pIT1T K(U) (FIG. 16). Plasmid pIT1T K(U) is linearized with an EcoRV digest prior to yeast cell transformation.

The integrative reductase plasmid was created by digesting p2TG1-R(H) with HindIII and XbaI and by ligating the promoter-gene cassette into a similarly cut pRS305 (Sikorski et al., Genetics 122: 19-27, 1989) to create pIT1 R(Le) (FIG. 16). The URA3 termination sequence was cut out of pIT1T K(U) with a SstI/EcoRI digest and ligated into a similarly cut pIT1 R(Le) to create pIT1T R(Le). Plasmid pIT1T R(Le) is linearized with an EcoRV digest prior to yeast cell transformation.

To create an integrative synthase plasmid, the URA3 termination sequence from pIT1T K(U) was first ligated into pRS304 (Sikorski et al., Genetics 122: 19-27, 1989) using the EcoRI and SstI restriction sites creating plasmid pRS304T. Next, the TEF1-synthase cassette was cut out of p2TG1-S(H) with a XhoI/EcoRI digest and ligated into a similarly cut pRS304T to create IT1T S(T) (FIG. 16). The XhoI digest was used to avoid a partial HindIII digest of pRS304T. The XhoI site is just inside of the HindIII site on the TEF1 promoter. The URA3 termination sequence removes the XbaI site in the multi-cloning site permitting this restriction enzyme to be used to linearize the plasmid prior to yeast cell transformation.

The TEF1 promoter can be replaced by the TEF2 promoter in any of the previously described plasmids by using the ClaI and XhoI restriction sites. TEF2 promoter was isolated from pMH59 (Dr. D. Cameron, University of Wisconsin, Madison) using PCR and the following primers ACCCATCGATTAATTATAGTTCGTTGACCG (SEQ ID NO:11) and ACCGCTCGAGTTGCACCCACACATTTATAC (SEQ ID NO:12). The first primer introduces a ClaI restriction site while the second primer creates a XhoI site. The TEF1 promoter contains a unique XhoI site next to the HindIII restriction site. An integrative TEF2 based ketothiolase (pIT2T K(U) (FIG. 16)) and synthase (pIT2T S(T) (FIG. 16)) plasmid has been created using the XhoI and ClaI restriction sites. A TEF2 based reductase plasmid (pIT2T R(Le)) is currently in progress.

In addition to the high copy number, 2 μm origin of replication, based system and the integrative system, the plasmids described above can be modified to contain the centromeric/autonomous replication sequence (CEN/ARS) origin of replication. This origin of replication would provide a plasmid copy number in between the 7-10 copies common to the 2 μm origin of replication and the single copy associated with integrated genes. The CEN/ARS sequence has been PCR'ed out of plasmid pRS314 (Sikorski et al., Genetics 122: 19-27, 1989) using primers ATTGTCGACGTCTTTACTCTGTGTTTATTT (SEQ ID NO:13) and ACCGGTACCGACGTCCTTTTCATCACGTGCTA (SEQ ID NO:14). The PCR product was then directly ligated into plasmid pCR-Blunt (Invitrogen; Carlsbad, Calif.) creating plasmid pCR-CEN/ARS. The EcoRI sites in the pCRBlunt backbone could be used to isolate the origin of replication and this sequence could then be ligated into the unique EcoRi sites found in the pRS303, pRS304, and pRS306 (Sikorski et al., Genetics 122: 19-27, 1989) based integrative plasmids. Use of the CEN/ARS sequence in the pRS305 based plasmids would require a partial EcoRI digest or a different restriction enzyme strategy.

Strains

In addition to S. cerevisiae strain D603, current studies involve S. cerevisiae strain YPH399 (MATa, ade2-101, leu2Δ1, lys2-80, his3D200, trpID63, ura3-52) was obtained from Dr. James Bodley (Department of Biochemistry, University of Minnesota Medical School).

Transformation of S. cerevisiae and Production of PHB

The R. eutropha PHB pathway was constructed in the haploid S. cerevisiae strain YPH399 with the integrative plasmids pIT1T K(U) and pIT1T R(Le) and the autonomous plasmid p2TG1-S(H).

The strain was tested at 30° C. in a shake flask study using defined media (6.7 g/L Yeast Nitrogen Base, 20 g/L glucose, adenine 100 mg/L, lysine 150 mg/L, tryptophan 100 mg/L, 50 mM citrate buffer (pH 4.5)). Anaerobic shake flasks were sparged with nitrogen gas prior to being sealed with a brewer's gas vent. The shake flasks were cultured for four days before being analyzed.

Results

Initial shake flask experiments shows the strain produces low levels of PHB (1.5 mg PHB/g CDW) both aerobically and anaerobically. The results indicate the R. eutropha PHA pathway produces biopolymer in both haploid and diploid strains of S. cerevisiae. The results also demonstrate that the constitutive promoter and integrative plasmids are capable of producing PHB. S. cerevisiae strain YPH399 maintaining only plasmid p2TG1-S(H) did not accumulate measurable amounts of PHB. The use of a constitutive promoter system negates the need for galactose and illustrates that galactose is not required for biopolymer production.

### Example 15

### Metabolic Pathway Analysis of a Recombinant Yeast for Rational Strain Development

Elementary mode analysis uses concepts from convex analysis to identify all possible, unique, nondecomposable biochemical pathways for a steady state system (Schuster et al., Modern Trends in BioThermoKinetics. 3: 103-105, 1994; Schuster et al., Computation in Cellular and Molecular Biological Systems. Cuthbertson, R., Holcombe, M., Paton, R., Eds. World Scientific, Singapore, pp. 151-165, 1996). In Schuster et al. (1994), elementary modes are described as “those flux patterns that remain after inhibition of a number of enzymes, such that inhibition of a further still active enzyme leads to cessation of any non-zero flux.”

Elementary mode analysis was used to study a metabolic pathway model of a recombinant Saccharomyces cerevisiae system that was genetically engineered to produce the bacterial storage compound poly-β-hydroxybutyrate (PHB). A recombinant Saccharomyces cerevisiae strain that expresses the three gene poly-beta-hydroxybutyrate (PHB) pathway from Ralstonia eutropha (β-ketothiolase (phbA), reductase (phbB), and synthase (phbC) (Example 4) was examined.

The model includes biochemical reactions from the intermediary metabolism and takes into account cellular compartmentalization as well as the reversibility/irreversibility of the reactions. The reaction network connects the production and/or consumption of eight external metabolites glucose, acetate, glycerol, ethanol, PHB, CO₂, succinate and ATP. Elementary mode analysis of the wild type S. cerevisiae system reveals 241 unique reaction combinations that balance the eight external metabolites.

The elementary mode analysis technique, as with most pathway analysis techniques, is based on a steady state system. While a batch cultivated system does not produce steady states, a culturing period was identified where a pseudo-steady state could be applied for theoretical purposes. The culturing period between approximately hours 33 and 50 served as the basis for the elementary mode model. During this period, the sugars are exhausted yet PHB production continues to accumulate linearly for close to twenty hours with very little cell growth.

Construction of the Metabolic Reaction Network

A S. cerevisiae biochemical reaction model has been constructed that includes reactions of the central metabolism and of PHB synthesis. The model is based on current literature and incorporates what is presently known about yeast intermediary metabolism. 64 different reactions are included in the model. Of these reactions, 26 are classified as reversible while 38 reactions are classified as irreversible. For simplicity, the reactions are not necessarily the product of a single enzyme. In some cases, the reaction is the overall stoichiometry of a linear series of enzymes. The reactions are written with 67 metabolites. These metabolites are classified as either external or internal (Shuster et al., Computation in Cellular and Molecular Biological Systems. Cuthbertson, R., Holcombe, M., Paton, R., Eds. World Scientific, Singapore, pp. 151-165, 1996).

The model includes 59 internal metabolites that are defined as metabolites constrained by the steady state assumption of no accumulation (dc/dt=0). The model also uses eight external metabolites: glucose, acetate, ethanol, glycerol, PHB, ATP, CO₂, and succinate. By the elementary mode definition of an external metabolite, these metabolites are not constrained by the steady state assumption and serve as sources or sinks. The physical location of “external” metabolites is not necessarily external to the cell. For instance, PHB is accumulated as insoluble granules within the cytosol.

Based on experimental data that suggests PHB accumulation occurs during a slow growth phase, the model assumes no growth and does not contain a biomass term. The special ATP term is included as a dummy variable that permits the dissipation of excess energy. While this variable permits excess ATP to be consumed by implicit maintenance processes, all elementary modes must produce at least enough ATP to meet the individual mode's requirements. Oxygen consumption is implicitly included in the oxidative phosphorylation reactions where NADH and FADH₂ are used to generate ATP. The ATP yield per mole of NADH/FADH₂ is set to 1.0. Water and proton balances are not enforced due to the aqueous nature of biological systems and because under standard bioreactor operating conditions the pH is controlled by acid and base additions. Since the metabolism of galactose proceeds through glucose-6-phosphate, glucose and galactose are considered interchangeable for purposes of the model.

Due to physical constraints imposed by the selective permeability of cell membranes, the metabolites and the reactions are partitioned between the extracellular, intracellular, and mitochondrial compartments. The partitioning between the various cellular compartments and the incorporation of various transporters are based on current literature. Due to the lack of data, the energy requirements associated with the transporters are neglected.

All elementary mode analysis was done with the publicly available METATOOL3.1 program found at http:/Hmudshark.brookes.ac.uk/sware.html or ftp://ftp.bioinf.mdc-berlin.de/Pub/metabolic/metatool/ (Schuster et al., Modern Trends in BioThermoKinetics. 3: 103-105, 1994; Pfeiffer et al., Bioinformatics, 15(3): 251-257, 1999).

The METATOOL output file includes a concise listing of all elementary modes in a matrix format. An MS Excel template has been developed to facilitate analysis of this matrix. Carbon yields are determined for each product based on the utilized substrates. Logical statements determine whether a metabolite is used as reactant or a product. For instance, glycerol, acetate, and ethanol can be either substrates or products and the calculated yields need to account for the direction of the flux in order to calculate the proper yield. In addition to calculating yields, the Excel template permits easy sorting and plotting of results based on such properties as products formed, substrates utilized, reactions (enzymes) utilized, or economic characteristics such as mode profit.

“Metabolic Richness” of Wild Type System

The ‘metabolic richness’ of the wild-type biochemical network was analyzed by determining the total number of elementary modes possible (Schuster et al., TIBTECH. 17: 53-60, 1999). The wild type system utilizing seven external metabolites: glucose, acetate, ethanol, glycerol, ATP, CO₂, and succinate has 241 unique, balanced elementary modes. The high number of modes illustrates the complexity of the branched system and the difficulty in determining all possible reaction combinations manually. When the modes were sorted for the involvement of ethanol, 111 modes were found to produce ethanol while 43 consumed ethanol. Of the 111 modes forming ethanol, 107 were found to co-produce glycerol. 93 of the 111 ethanol forming modes utilized both acetate and glucose as substrates while the remaining 18 modes used only glucose. The ethanol carbon yield, which is defined as the ratio of the number of carbon atoms found in the produced ethanol to the total number of carbon atoms found in all utilized substrates (C_{EtOH}/C_{SUBSTRATE(S)}), was found to range from 0.04 to 0.67 for the ethanol producing modes. The highest yielding ethanol mode converted 1 mole of glucose into 2 moles of ethanol and 2 moles of CO₂ with a net production of 2 ATP.

Pathway Analysis: PHB Production

To study the production of PHB in the recombinant S. cerevisiae system, the wild-type model was modified to include the PHB pathway and was modified to simulate the experimental conditions when PHB accumulates. Based on experimental data, S. cerevisiae appears to produce PHB from a metabolic by-product and not directly from glucose or galactose. For this reason, the reaction for the uptake of extracellular glucose was removed from the model. It should be noted that ethanol, acetate, glycerol, and succinate are all common by-products of S. cerevisiae cultures grown on high concentrations of glucose and galactose and would be found in the extracellular environment (Oura, Process Biochem. 12: 19-21,35, 1977; Gancedo et al., The Yeasts, 2nd edn, vol 3. (eds A. H. Rose & J. S. Harrison) Academic Press. New York. pp 205-251, 1989).

The experimental system has a total of 20 modes, 7 of which produce PHB. The large reduction in the total number of modes from the wild-type system is due in part to the elimination of glucose as an external metabolite. The 7 PHB producing modes were sorted according to PHB carbon yield, which is defined as the ratio of the number of carbon atoms in produced PHB to the total number of carbon atoms found in all utilized substrates (C_{PHB}/C_{SUBSTRATE(S)}). The modes had carbon yields ranging from 0.32 to 0.67. The highest yielding mode used mitochondrial oxidation of ethanol to supply the ATP required to convert externally supplied acetate into acetyl-CoA and used cytosolic isocitrate dehydrogenase to supply NADPH required by the PHB reductase enzyme. The second highest yielding mode, which had a PHB carbon yield of 0.63, also used ethanol and acetate as substrates but used the pentose phosphate pathway to produce cytosolic NADPH.

Network Modification: ATP Citrate-lyase (ACL)

Elementary mode analysis was also used to investigate other topological modifications like the expression of additional recombinant genes. The study's focus was on genes that could supply metabolites used in PHB production, namely acetyl-CoA and NADPH.

Yeasts that accumulate high levels of fatty acids produce the precursor, cytosolic acetyl-CoA, primarily by the ATP citrate-lyase (ACL) enzyme which cleaves cytosolic citrate into acetyl-CoA and oxaloacetate (Boulton et al., J. Gen. Microbiol. 127:169-176, 1981). S. cerevisiae does not natively possess this gene (Evans et al., Eur. J. Biochem. 130: 195-204, 1983; sequence analysis of S. cerevisiae genome). Since cytosolic acetyl-CoA is a precursor of PHB, expression of the ACL reaction is investigated as a theoretical means of improving PHB production.

Addition of the ACL catalyzed reaction to the S. cerevisiae reaction network significantly increases both the total number of possible modes and PHB's maximum theoretical carbon yield. The number of modes increases from 20 to 496 with 314 modes producing PHB. Introduction of the ACL reaction also improves the maximum theoretical yield of PHB from 0.67 to 0.83. The mode uses mitochondrial oxidation of ethanol to supply ATP, cytosolic aldehyde dehydrogenase to produce NADPH and both the pyruvate dehyrogenase bypass and the ACL mediated cleavage of citrate to produce acetyl-CoA. The mode with the second highest PHB carbon yield uses ethanol and glycerol as substrates and utilizes the pentose phosphate pathway for NADPH production.

Network Modification: Transhydrogenase Reaction

NADH is typically formed during catabolic reactions while NADPH is consumed in anabolic reactions. While many bacterial and animal cells possess a transhydrogenase activity that permits the conversion of NADH and NADP⁺ to NAD⁺ and NADPH and vice versa, S. cerevisiae does not. S. cerevisiae must carefully regulate a balance between the production and consumption of NADPH and NADH in order to maintain a favorable redox balance. The lack of a transhydrogenase system has implications on the expression of foreign proteins and on the yields of such products as ethanol or PHB. For instance, glycerol is produced during anaerobic growth in order to reoxidize the NADH formed during biomass production. Glycerol formation can significantly affect the economics of processes like ethanol production by lowering yields (Oura, Biochem. 12: 19-21,35, 1977; Anderlund et al., Appl. Environ. Microbiol. 65(6): 2333-2340, 1999). A theoretical analysis of the stoichiometric implications of a transhydrogenase system was investigated using the S. cerevisiae model. The transhydrogenase reaction was implemented by assuming NADH and NADPH were equivalent and mutually exchangeable in the reactions involving these co-enzymes.

Introducing the transhydrogenase activity to the experimental reaction model increases the total number of modes from 20 to 88 with 38 of these modes producing PHB. The maximum theoretical carbon yield for PHB increases from 0.67 to 0.71. The highest yielding mode utilizes mitochondrial oxidation of ethanol for ATP production while alcohol dehydrogenase and aldehyde dehydrogenase supply the reducing equivalents required for biopolymer formation. Acetate and ethanol both serve as substrates for acetyl-CoA production. The transhydrogenase reaction removes the need for either isocitrate dehydrogenase or the pentose phosphate pathway. By avoiding these decarboxylating reactions, the loss of carbon through CO₂ was minimized improving the overall carbon yield.

When both the transhydrogenase reaction and the ACL reaction are added to the experimental model, the number of modes increases to 1010 with 447 producing PHB. The maximum theoretical yield also increases slightly to 0.84. In the highest yielding mode, both ethanol and glycerol serve as substrates for PHB production. The reducing equivalents are formed during the oxidation of glycerol to pyruvate and all the cytosolic acetyl-CoA is derived from the ACL mediated cleavage of citrate.

Altered Culturing Conditions: Anaerobic PHB Production

Culturing conditions can affect which substrates and which reactions are available to balance the internal workings of a cell. By limiting various sources and sinks, the overall character of the network can be changed. The stoichiometric constraints associated with aerobic and anaerobic conditions were investigated to determine the feasibility of alternative culturing conditions. For economic reasons like equipment design and operational costs, it is of interest to produce PHB anaerobically. Anaerobic conditions were simulated by removing the oxidative phosphorylation reactions from the model. Under anaerobic conditions, a fermentable carbon source is necessary so the glucose uptake reaction was included.

Elementary mode analysis reveals 8 anaerobic elementary modes with two modes capable of producing PHB. Interestingly, both of these anaerobic modes co-produce PHB and ethanol. The highest yielding mode catabolizes glucose into ATP and NADPH using glycolysis and the pentose phosphate cycle and produces ethanol and CO₂ as by-products. The ATP and NADPH derived from glucose permits 100% conversion of acetate carbon into PHB synthesis. The overall carbon yield for PHB is 0.24 and the carbon yield for ethanol is 0.48 for a combined carbon yield of 0.72. The analysis did not include the transhydrogenase reaction or the ACL reaction. Including these reactions did not have a major effect on PHB production.

Network Modification: Co-production of PHB and Lactic Acid

The lactic acid producing pathway was simulated by adding two metabolites LACTIC_cyt and LACTIC_ext and by adding two irreversible reactions to the model:

RLDH: PYR_cyt+NADH_cyt=LACTIC_cyt+NAD_cyt.

RLT: LACTIC_cyt=LACTIC_ext.

The elementary mode analysis was run on the modified model and two anaerobic modes were discovered that resulted in the co-production of lactic acid and PHB.

24 Acetate+25 Glucose =12 PHB+48 Lactic Acid+6 CO₂

1 Acetate+3 Glucose=1 PHB+4 Lactic Acid+1 Glycerol+1 CO₂

These modes are stoichiometrically the same as the modes that lead to the co-production of PHB and ethanol and demonstrate the similar metabolic function of ethanol and lactic acid.

24 Acetate+25 Glucose=12 PHB+48 Ethanol+54 CO₂

1 Acetate+3 Glucose=1 PHB+4 Ethanol+1 Glycerol+5 CO₂

Since ethanol is a two carbon metabolite and lactic acid a three carbon metabolite, the carbon atom difference is balanced by the production of CO₂.

Yield Trends

Elementary mode analysis was also used to examine trends in the yields of various compounds. Stoichiometric constraints related to the redox and carbon balances can influence which combinations of reactions are available for the synthesis of a desired product. The available combinations of reactions can then have an influence on what metabolites are produced as by-products.

The carbon yield of PHB versus the carbon yield of ethanol and the carbon yield of PHB versus the carbon yield of glycerol was analyzed with a model using glucose, acetate, ethanol, glycerol, PHB, ATP, CO₂, and succinate as external metabolites. The system did not include the ACL reaction or the transhydrogenase reaction. An overall mass conservation trend was observed. As the yield of one metabolite increases, the other metabolite's yield decreases. An interesting relationship between PHB production and glycerol production was also observed. A large number of modes producing PHB also produce glycerol. This trend is in part due to redox constraints. While PHB consumes electrons in the form of NADPH, additional cytosolic reducing equivalents are often formed during substrate catabolism. A number of the modes then use glycerol as an electron sink to dispose of the excess reducing equivalents.

Discussion

We have used elementary mode analysis to study a recombinant S. cerevisiae system engineered to produce the biodegradable plastic PHB. It was found that the presence or absence of oxygen has a strong effect on which modes are available. Switching culturing conditions could have an effect on which substrates are used and which products are formed. For instance by switching from aerobic to anaerobic conditions, the analysis suggests that ethanol could switch from a substrate used to form PHB to a product co-produced with PHB. We also discovered modes for the co-production of lactic acid and PHB that are stoichiometrically the same as modes that lead to the co-production of PHB and ethanol, demonstrate the similar metabolic function of ethanol and lactic acid.

Adding ATP citrate-lyase to the model significantly increased the number of possible pathways leading to PHB. Not only did this reaction permit the more efficient conversion of substrate into product but it also changed the distribution of non-PHB forming modes to PHB forming modes. With the addition of ACL 63% of all possible modes produce PHB, while only 35% of the original experimental systems modes led to PHB. The addition of the ACL also changes the requirement of ethanol and acetate for the production of PHB. The highest yielding mode with ACL only uses a single substrate, ethanol, to produce PHB while the second highest yielding mode used a combination ethanol and glycerol.

### Example 16

### Transformation of Yeast with Medium Chain Length PHA Polymerase

A medium chain length PHA system will be created by transferring the Pseudomonas oleovorans polymerase from plasmid pPT700 (Jackson, Recombinant Modulation of the phbCAB Operon Copy Number in Ralstonia eutropha and Modification of the Precursor Selectivity of the Pseudomonas oleovorans Polymerase I. Masters Dissertation. University of Minnesota. St. Paul, Minn., 1998) to a TEF1 and a TEF2 based yeast expression system (plasmids pIT1T K(U) and pIT2T K(U) (Example 14; FIG. 16)) using the ClaI and EcoRI restriction sites. The plasmids will be named pIT1T T(U) and pIT2T T(U) re spectively. A higher copy number system can be created by introducing either the CENS/ARS sequence from plasmid pRS314 (Sikorski et al., Genetics 122: 19-27, 1989) or by introducing the 2 μm origin of replication from plasmid p2TG1T K(U).

### Sequence Listing Free Text

SEQ ID NOs:1-14 oligonucleotide primers

The complete disclosures of all patents, patent applications including provisional patent applications, publications, and electronically available material (e.g., GenBank amino acid and nucleotide sequence submissions) cited herein are incorporated by reference. The detailed description of the invention and the examples are provided for clarity of understanding only. No unnecessary limitations are to be understood therefrom. The invention is not limited to the exact details shown and described; many variations will be apparent to one skilled in the art and are intended to be included within the invention defined by the claims.

What is claimed is:

1. A method for the production of a polyhydroxyalkanoate (PHA) comprising:
providing a transgenic yeast cell comprising a first nucleic acid fragment comprising a heterologous nucleotide sequence encoding a PHA polymerase and at least one second nucleic acid fragment comprising a heterologous nucleotide sequence selected from the group consisting of a heterologous nucleotide sequence encoding an acetoacetyl-CoA reductase and a heterologous nucleotide sequence encoding a β-ketothiolase;
culturing the transgenic yeast cell under anaerobic conditions to cause the production of PHA; and
isolating the PHA from the yeast cell.

2. The method of claim 1 wherein the first and second nucleic acid fragments constitute a single nucleic acid fragment.

3. The method of claim 2 wherein the single nucleic acid fragment comprises a divergent promoter operably linked to two of the heterologous nucleotide sequences.

4. The method of claim 1 wherein the yeast cell comprises a second nucleic acid fragment comprising a heterologous nucleotide sequence encoding an acetoacetyl-CoA reductase and a third nucleic acid fragment comprising a nucleotide sequence encoding a β-ketothiolase.

5. The method of claim 4 wherein at least two of the first, second and third nucleic acid fragments constitute a single nucleic acid fragment.

6. The method of claim 5 wherein the single nucleic acid fragment comprises a divergent promoter operably linked to two of the heterologous nucleotide sequences.

7. The method of claim 1 wherein at least one nucleic acid fragment is integrated into the genome of the yeast cell.

8. The method of claim 1 further comprising introducing at least one nucleic acid fragment into the yeast cell to yield the transgenic yeast cell.

9. The method of claim 1 wherein the yeast cell is a cell from the genus Saccharomyces.

10. The method of claim 1 wherein the yeast cell is an S. cerevisiae cell.

11. The method of claim 1 wherein the yeast cell is a cell from the genus Kluyveromyces.

12. The method of claim 1 wherein the PHA polymerase comprises a PHA_{SCL} polymerase.

13. The method of claim 1 wherein the PHA polymerase comprises a PHA_{MCL} polymerase.

14. A method for the production of a polyhydroxyalkanoate (PHA) comprising:
providing a transgenic yeast cell comprising a first nucleic acid fragment comprising heterologous nucleotide sequence encoding a PHA polymerase; at least one second nucleic acid fragment comprising a heterologous nucleotide sequence selected from the group consisting of a heterologous nucleotide sequence encoding an acetoacetyl-CoA reductase and a heterologous nucleotide sequence encoding a β-ketothiolase; and a third nucleic acid fragment comprising a heterologous nucleotide sequence encoding a citrate lyase;
culturing the transgenic yeast cell to cause the production of PHA; and
isolating the PHA from the yeast cell.

15. The method of claim 14 wherein the yeast cell comprises a heterologous nucleotide sequence encoding an acetoacetyl-CoA reductase and a heterologous nucleotide sequence encoding a β-ketothiolase.

16. The method of claim 14 wherein at least two of the first, second and third nucleic acid fragments constitute a single nucleic acid fragment.

17. The method of claim 16 wherein the single nucleic acid fragment comprises a divergent promoter operably linked to two of the heterologous nucleotide sequences.

18. The method of claim 14 wherein the yeast cell is a S. cerevisiae cell.

19. The method of claim 14 wherein the PHA polymerase comprises a PHA_{SCL} polymerase.

20. The method of claim 14 wherein the PHA polymerase comprises a PHA_{MCL} polymerase.

21. A method for the production of a polyhydroxyalkanoate (PHA) comprising:
providing a transgenic yeast cell having transhydrogenase activity, the transgenic yeast cell comprising a first nucleic acid fragment comprising heterologous nucleic acid encoding a PHA polymerase and at least one second nucleic acid fragment comprising a heterologous nucleotide sequence selected from the group consisting of a heterologous nucleotide sequence encoding an acetoacetyl-CoA reductase and a heterologous nucleotide sequence encoding a β-ketothiolase;
culturing the transgenic yeast cell under conditions to cause the production of PHA; and
isolating the PHA from the yeast cell.

22. The method of claim 21 wherein the yeast cell is a S. cerevisiae cell.

23. The method of claim 21 wherein overexpression of a glutamate dehydrogenase enzyme in the yeast cell produces the transhydrogenase activity.

24. The method of claim 21 wherein overexpression of a malic enzyme in the yeast cell produces the transhydrogenase activity.

25. The method of claim 21 wherein the PHA polymerase comprises a PHA_{SCL} polymerase.

26. The method of claim 21 wherein the PHA polymerase comprises a PHA_{MCL} polymerase.

27. A method for the production of a polyhydroxyalkanoate (PHA) comprising:
providing a transgenic yeast cell comprising a first nucleic acid fragment comprising heterologous nucleotide sequence encoding a PHA_{MCL} polymerase and at least one second nucleic acid fragment comprising a heterologous nucleotide sequence selected from the group consisting of a heterologous nucleotide sequence encoding an acetoacetyl-CoA reductase and a heterologous nucleotide sequence encoding a β-ketothiolase;
culturing the transgenic yeast cell under aerobic conditions to cause the production of PHA; and
isolating the PHA from the yeast cell.

28. The method of claim 27 wherein at least one nucleic acid fragment comprises a constitutive promoter linked to at least one heterologous nucleotide sequence.

29. The method of claim 27 wherein the yeast cell comprises a second nucleic acid fragment comprising a heterologous nucleotide sequence encoding an acetoacetyl-CoA reductase and a third nucleic acid fragment comprising a nucleotide sequence encoding a β-ketothiolase.

30. The method of claim 29 wherein at least two of the first, second and third nucleic acid fragments constitute a single nucleic acid fragment.

31. The method of claim 30 wherein the single nucleic acid fragment comprises a constitutive divergent promoter operably linked to each of the heterologous nucleic acid sequences.

32. The method of claim 27 wherein at least one nucleic acid fragment is integrated into the genome of the yeast cell.

33. The method of claim 27 wherein the yeast cell is an S. cerevisiae cell

34. A method for production of a polyhydroxyalkanoate (PHA) and ethanol comprising:
culturing a transgenic yeast cell comprising a first nucleic acid fragment comprising a heterologous nucleotide sequence encoding a PHA polymerase and at least one second nucleic acid fragment comprising a heterologous nucleotide sequence selected from the group consisting of a heterologous nucleotide sequence encoding an acetoacetyl-CoA reductase and a heterologous nucleotide sequence encoding a β-ketothiolase under conditions to cause the production of ethanol;
isolating the ethanol from the cell culture;
culturing the yeast cell under conditions to cause the production of PHA; and
isolating the PHA from the yeast cell.

35. The method of claim 34 wherein culturing the yeast cell under conditions to cause the production of PHA comprises supplying the yeast cell with a feed comprising at least one component selected from the group consisting of acetate, propionate and valerate.

36. The method of claim 34 wherein first and second nucleic acid fragments constitute a single nucleic acid fragment.

37. The method of claim 36 wherein the single nucleic acid fragment comprises a divergent promoter operably linked to two of the heterologous nucleotide sequences.

38. The method of claim 34 wherein the yeast cell comprises a second nucleic acid fragment comprising a heterologous nucleotide sequence encoding an acetoacetyl-CoA reductase and a third nucleic acid fragment comprising a nucleotide sequence encoding a β-ketothiolase.

39. The method of claim 38 wherein at least two of the first, second and third nucleic acid fragments constitute a single nucleic acid fragment.

40. The method of claim 39 wherein the single nucleic acid fragment comprises a divergent promoter operably linked to two of the heterologous nucleotide sequences.

41. The method of claim 34 wherein at least one nucleic acid fragment is integrated into the genome of the yeast cell.

42. The method of claim 34 further comprising introducing at least one nucleic acid fragment into the yeast cell to yield the transgenic yeast cell.

43. The method of claim 34 wherein the yeast cell is a cell from the genus Saccharomyces.

44. The method of claim 34 wherein the yeast cell is an S. cerevisiae cell

45. The method of claim 34 wherein the yeast cell is a cell from the genus Kluyveromyces.

46. The method of claim 34 wherein the PHA polymerase comprises a PHA_{SCL} polymerase.

47. The method of claim 34 wherein the PHA polymerase comprises a PHA_{MCL} polymerase.

48. The method of claim 34 wherein the yeast cell further comprises a heterologous nucleotide sequence encoding a citrate lyase.

49. The method of claim 34 wherein the yeast cell has transhydrogenase activity.

50. The method of claim 34 wherein the yeast cell is cultured in a first fermentation chamber under conditions to cause the production of ethanol; and
wherein the yeast cell is cultured in a second fermentation chamber under conditions to cause the production of PHA.

51. A method for production of a polyhydroxyalkanoate (PHA) and lactic acid comprising:
culturing a transgenic yeast cell comprising a first nucleic acid fragment comprising a heterologous nucleotide sequence encoding a PHA polymerase and at least one second nucleic acid fragment comprising a heterologous nucleotide sequence selected from the group consisting of a heterologous nucleotide sequence encoding an acetoacetyl-CoA reductase and a heterologous nucleotide sequence encoding a β-ketothiolase under conditions to cause the production of lactic acid;
isolating the lactic acid from the cell culture;
culturing the yeast cell under conditions to cause the production of PHA; and
isolating the PHA from the yeast cell.

52. The method of claim 51 wherein culturing the yeast cell under conditions to cause the production of PHA comprises supplying the yeast cell with a feed comprising at least one component selected from the group consisting of acetate, propionate and valerate.

53. The method of claim 51 wherein the yeast cell comprises a heterologous nucleotide sequence encoding an acetoacetyl-CoA reductase and a heterologous nucleotide sequence encoding a β-ketothiolase.

54. The method of claim 51 wherein first and second nucleic acid fragments constitute a single nucleic acid fragment.

55. The method of claim 54 wherein the single nucleic acid fragment comprises a divergent promoter operably linked to two of the heterologous nucleotide sequences.

56. The method of claim 51 wherein the yeast cell is a S. cerevisiae cell.

57. The method of claim 51 wherein the PHA polymerase comprises a PHA_{SCL} polymerase.

58. The method of claim 51 wherein the PHA polymerase comprises a PHA_{MCL} polymerase.

59. The method of claim 51 wherein the yeast cell further comprises a heterologous nucleotide sequence encoding a citrate lyase.

60. The method of claim 51 wherein the yeast cell has transhydrogenase activity.

61. The method of claim 51 wherein the yeast cell is cultured in a first fermentation chamber under conditions to cause the production of ethanol; and
wherein the yeast cell is cultured in a second fermentation chamber under conditions to cause the production of PHA.

62. A method for the production of a polyhydroxyalkanoate (PHA) comprising:
providing a transgenic bacterial cell comprising a first nucleic acid fragment comprising a heterologous nucleotide sequence encoding a PHA polymerase and at least one second nucleic acid fragment comprising a heterologous nucleotide sequence selected from the group consisting of a heterologous nucleotide sequence encoding an acetoacetyl-CoA reductase and a heterologous nucleotide sequence encoding a β-ketothiolase;
culturing the bacterial cell under anaerobic conditions to cause the production of PHA; and
isolating the PHA from the bacterial cell.

63. The method of claim 62 wherein the bacterial cell comprises a second nucleic acid fragment comprising a heterologous nucleotide sequence encoding an acetoacetyl-CoA reductase and a third nucleic acid fragment comprising a nucleotide sequence encoding a β-ketothiolase.

64. The method of claim 63 wherein at least two of the first, second and third nucleic acid fragments constitute a single nucleic acid fragment.

65. The method of claim 62 wherein the PHA polymerase comprises a PHA_{MCL} polymerase.

66. The method of claim 62 wherein the PHA polymerase comprises a PHA_{SCL} polymerase.

67. The method of claim 62 wherein the bacterial cell is from a genus selected from the group consisting of Escherichia, Zooglea and Lactobacillus.

68. A method for production of a polyhydroxyalkanoate (PHA) and ethanol in a transgenic bacterial cell comprising:
providing a transgenic bacterial cell comprising a first nucleic acid fragment comprising a heterologous nucleotide sequence encoding a PHA polymerase and at least one second nucleic acid fragment comprising a heterologous nucleotide sequence selected from the group consisting of a heterologous nucleotide sequence encoding an acetoacetyl-CoA reductase and a heterologous nucleotide sequence encoding a β-ketothiolase;
culturing the bacterial cell under conditions to cause the production of ethanol;
isolating the ethanol from the cell culture;
culturing the bacterial cell under conditions to cause the production of PHA; and
isolating the PHA from the bacterial cell.

69. The method of claim 68 wherein the bacterial cell comprises a second nucleic acid fragment comprising a heterologous nucleotide sequence encoding an acetoacetyl-CoA reductase and a third nucleic acid fragment comprising a nucleotide sequence encoding β-ketothiolase.

70. The method of claim 69 wherein at least two of the first, second and third nucleic acid fragments constitute a single nucleic acid fragment.

71. The method of claim 68 wherein culturing the transgenic bacterial cell under conditions to cause the production of PHA comprises supplying the bacterial cell with a feed comprising at least one component selected from the group consisting of acetate, propionate and valerate.

72. The method of claim 68 wherein the bacterial cell is from a genus selected from the group consisting of Escherichia, Zooglea and Lactobacillus.

73. A method for the production of a polyhydroxyalkanoate (PHA) comprising:
providing a transgenic E. coli cell comprising a first nucleic acid fragment comprising a heterologous nucleotide sequence encoding a PHA polymerase and at least one second nucleic acid fragment comprising a heterologous nucleotide sequence selected from the group consisting of a heterologous nucleotide sequence encoding an acetoacetyl-CoA reductase and a heterologous nucleotide sequence encoding a β-ketothiolase;
culturing the E. coli cell under anaerobic conditions to cause the production of PHA; and
isolating the PHA from the E. coli cell.

74. The method of claim 73 wherein the E. coli cell comprises a second nucleic acid fragment comprising a heterologous nucleotide sequence encoding an acetoacetyl-CoA reductase and a third nucleic acid fragment comprising a heterologous nucleotide sequence encoding a β-ketothiolase.

75. The method of claim 74 wherein at least two of the first, second and third nucleic acid fragments constitute a single nucleic acid fragment.

76. The method of claim 73 wherein the PHA polymerase comprises a PHA_{MCL} polymerase.

77. The method of claim 73 wherein the PHA polymerase comprises a PHA_{SCL} polymerase.

78. A method for the production of a polyhydroxyalkanoate (PHA) comprising:
providing a transgenic E. coli cell comprising a first nucleic acid fragment comprising a heterologous nucleotide sequence encoding a PHA polymerase; a second nucleic acid fragment comprising a heterologous nucleotide sequence encoding an acetoacetyl-CoA reductase; and a third nucleic acid fragment comprising a heterologous nucleotide sequence encoding a β-ketothiolase;
culturing the E. coli cell under anaerobic conditions to cause the production of PHA; and
isolating the PHA from the E. coli cell.

79. The method of claim 78 wherein at least two of the first, second and third nucleic acid fragments constitute a single nucleic acid fragment.

80. The method of claim 78 wherein the PHA polymerase comprises a PHA_{MCL} polymerase.

81. The method of claim 78 wherein the PHA polymerase comprises a PHA_{SCL} polymerase.

82. A method for production of a polyhydroxyalkanoate (PHA) and ethanol in a transgenic E. coli cell comprising:
providing a transgenic E. coli cell comprising a first nucleic acid fragment comprising a heterologous nucleotide sequence encoding a PHA polymerase and at least one second nucleic acid fragment comprising a heterologous nucleotide sequence selected from the group consisting of a heterologous nucleotide sequence encoding an acetoacetyl-CoA reductase and a heterologous nucleotide sequence encoding a β-ketothiolase;
culturing the E. coli cell under conditions to cause the production of ethanol;
isolating the ethanol from the cell culture;
culturing the E. coli cell under conditions to cause the production of PHA; and
isolating the PHA from the E. coli cell.

83. The method of claim 82 wherein culturing the transgenic bacterial cell under conditions to cause the production of PHA comprises supplying the bacterial cell with a feed comprising at least one component selected from the group consisting of acetate, propionate and valerate.

84. A method for production of a polyhydroxyalkanoate (PHA) and lactic acid comprising:
providing a transgenic bacterial cell comprising a first nucleic acid fragment comprising a heterologous nucleotide sequence encoding a PHA polymerase and at least one second nucleic acid fragment comprising a heterologous nucleotide sequence selected from the group consisting of a heterologous nucleotide sequence encoding an acetoacetyl-CoA reductase and a heterologous nucleotide sequence encoding a β-ketothiolase;
culturing the bacterial cell under conditions to cause the production of lactic acid;
isolating the lactic acid from the cell culture;
culturing the bacterial cell under conditions to cause the production of PHA; and
isolating the PHA from the bacterial cell.

85. The method of claim 84 wherein culturing the bacterial cell under conditions to cause the production of PHA comprises supplying the bacterial cell with a feed comprising at least one component selected from the group consisting of acetate, propionate and valerate.

86. The method of claim 84 wherein the transgenic bacterial cell is from a genus selected from the group consisting of Escherichia, Zooglea and Lactobacillus.

87. A transgenic yeast cell comprising a heterologous PHA_{MCL} polymerase and at least one enzyme selected from a heterologous acetoacetyl-CoA reductase and a heterologous β-ketothiolase.

88. The transgenic yeast cell of claim 87 which is a S. cerevisiae cell.

89. A transgenic yeast cell comprising a heterologous PHA polymerase, a heterologous acetoacetyl-CoA reductase, and a heterologous citrate lyase.

90. The transgenic yeast cell of claim 89 further comprising a heterologous β-ketothiolase.

91. The transgenic yeast cell of claim 89 wherein the PHA polymerase comprises a PHA_{SCL} polymerase.

92. The transgenic yeast cell of claim 89 wherein the PHA polymerase comprises a PHA_{MCL} polymerase.

93. The transgenic yeast cell of claim 89 which is a S. cerevisiae cell.
